(19) United States
(12) Patent Application Publication
(10) Pub. No.: US 2013/0314587 A1
(43) Pub. Date: Nov. 28, 2013

(54) Multi-State Electrostatic Actuator and Digital Camera Therewith

(71) Applicants: Moshe Kriman, Tel-Aviv (IL); Ephraim Goldenberg, Ashdod (IL); Uri Kinrot, Hod Hasharon (IL); Gal Shabtay, Tel-Aviv (IL); Jamil Nasser, Haifa (IL); Dalit Bahar, Tel-Aviv (IL); Giles Humpston, Buckinghamshire (GB)

(72) Inventors: Moshe Kriman, Tel-Aviv (IL); Ephraim Goldenberg, Ashdod (IL); Uri Kinrot, Hod Hasharon (IL); Gal Shabtay, Tel-Aviv (IL); Jamil Nasser, Haifa (IL); Dalit Bahar, Tel-Aviv (IL); Giles Humpston, Buckinghamshire (GB)

(73) Assignee: DIGITALOPTICS CORPORATION MEMS, San Jose, CA (US)

(21) Appl. No.: 13/984,275

(22) PCT Filed: Feb. 6, 2012
(86) PCT No.: PCT/US2012/024018

§ 371 Date: Aug. 7, 2013

Related U.S. Application Data
(60) Provisional application No. 61/440,328, filed on Feb. 7, 2011.
(60) Provisional application No. 61/466,787, filed on Mar. 23, 2011.
(60) Provisional application No. 61/476,984, filed on Apr. 19, 2011.

(51) Int. Cl. H02N 1/00; H04N 5/232

(52) U.S. Cl. CPC H02N 1/006; H04N 5/232
USPC 348/357; 310/300

(57) ABSTRACT

An actuator that operates by electrostatic attraction and repulsion and can have fixed and moving electrodes is disclosed for one or more embodiments. The fixed and moving electrodes can be inclined relative to each other at an acute angle. The actuator can be radially symmetric and mirrored about the moving electrode. The moving electrode can have a central aperture over which is placed an optical element such as a lens. The optical element can be part of an optical train that permits the focus of an electronic camera to be modified by changing the displacement of the lens along the optical axis of the camera.

### PRIORITY

This application claims the benefit of priority to U.S. provisional patent applications Nos. 61/440,328, filed Feb. 7, 2011; 61/466,787, filed Mar. 23, 2011; and 61/476,984, filed Apr. 19, 2011.

### BACKGROUND

The present application is related to a multi-state electrostatic actuator and to electronic cameras and more particularly, to electronic cameras where the focus can be adjusted by an electronic control system that physically moves the position of one or more lenses in the camera.

One or more embodiments of the present application are related to electronic components, and more particularly, to microelectromechanical (“MEMS”) and microelectro-optomechanical systems (“MEOMS”) having an element that moves in response to an electric charge.

A solid state camera is a device able to capture a scene in electronic format. In general terms, a solid state camera includes two components. These are an optical train through which the light that is reflected off objects in the scene passes and an image sensor (or “imager”), that converts the light into electrons and then a measure of the number of electrons into a computer-style file.

A wide variety of items now incorporate digital cameras, some of which are auto focus cameras. An incomplete list of examples includes lap top and net book computers, web cams, toys, industrial and automotive vehicles, televisions, and of course, digital cameras and camcorders.

At their inception, mobile telephones, also called cellular phones, were conceived as communication devices that operated without wires and hence could be carried and used everywhere. The original form of communication was by voice, but this was soon augmented by data services such as the Short Messaging Service (text messages), email, instant messaging and access to the World Wide Web. During the development of the data communication modes, mobile phones also acquired the ability to capture still photographs and more recently, video clips complete with audio. To capture digital still images and video clips conventional mobile phones typically include an electronic camera.

Consumers expect each new generation of cameras installed in mobile phones to capture ever higher quality images at greater resolution. At the same time, the current fashion in portable electronics products is for extreme thinness. These two trends are in opposition because, for reasons of physics, high quality optics are typically large in diameter and tall. Consequently, to squeeze an electronic camera into the few millimeters of height available within a cell phone casing places great demands on the design of the optical system and improvements are desired. This is particularly true for auto focus cameras that are physically taller than the equivalent fixed focus camera.

The ability of an electronic camera to accurately capture detail in a scene is determined by the quality of the optical train and the resolution of the image sensor. A camera found in modern portable electronic devices usually has one or more lenses and a front aperture stop. A very low resolution camera may have as few as one lens and/or as few as one single aperture, while a high resolution camera will typically have four lenses and sometimes more and several apertures. As might be expected, high quality optical trains and high resolution image sensors are generally more expensive than low quality optical trains and low resolution image sensors.

Solid state cameras are available in three common flavors: fixed focus, manual focus and automatic focus. In a fixed focus camera, the focal depth of the camera is set by the manufacturer and cannot be altered in designed usage. In a manual camera, one or more components of the optical train can be adjusted by the user in a manner that permits the focus of the camera to be altered. By this means, the user can select whether objects in the scene that are either near to the camera or at a distance from it are in focus in the image. An automatic camera typically includes an electronic system that is configured to select the focus distance and adjust the optical train accordingly before the scene is captured.

Many methods have been devised to alter the focus of automatic cameras. The most common is to move the entire optical train along the optical axis of the camera, with respect to the image sensor. An alternative approach is to move only the first lens of the optical train along the optical axis of the camera with respect to the image sensor.

Fixed focus cameras have advantages in terms of smallness of physical dimensions and cost, but the performance is limited. In particular, the focus distance is often set at 1.2 m so that objects from 60 cm to infinity appear tolerably sharp. However, the image sharpness is not especially good and objects that are closer to the camera than 60 cm will typically be blurred. While it is possible to set the focus at a closer distance to correct for this problem, it means that the sharpness of distant objects declines in compensation.

If the position of the optical train is not fixed relative to the position of the image sensor, then by adjustment of the spacing between the optical train and the image sensor it is possible to alter the distance from the electronic camera at which objects will be in exact focus on the image sensor. A typical implementation of this is the auto focus camera. In an auto focus camera a system is used to determine the distance of the principal objects in the scene from the camera. The entire lens train is then moved physically along the optical axis of the camera until the principal objects in the scene are in focus on the image sensor. These objects can range from being very close (10 cm) to very distant (infinity) from the camera. This method of setting focus is generally preferred by consumers because it mimics the operation and depth of focus of the human eye. While the image sharpness from an auto focus camera is typically better than from a fixed focus camera, it comes at the expense of greater technical complexity, larger physical size, increased power consumption and higher cost.

In a conventional miniature auto focus camera the entire optical train is moved along the optical axis of the camera. A wide variety of mechanisms have been developed over the years to accomplish this. One of the more common arrangements, particularly for the highly miniaturized electronic cameras that are incorporated in portable electronic products, like mobile telephones and laptop computers, is the voice coil motor (VCM). An example is to be found in U.S. Pat. No. 7,612,957, which is incorporated by reference.

In an auto focus camera that uses a VCM the optical train is fixed in a housing called a lens turret and in a manner that allows for relatively free movement of the lens turret along the optical axis of the camera. Magnets are physically associated with the lens turret. In reasonably close proximity to the magnets is placed an electromagnet. By passing an electric current through the electromagnet a magnetic field is generated. This magnetic field then either attracts or repels the permanent magnets attached to the lens turret causing it and hence the lens train to move either towards or away from the electromagnet. Thus, by control of the electric current through the electromagnet the position of the optical train with respect the imager can be altered and hence the focus of the electronic camera.

Sometimes the permanent and electromagnets are interchanged, but the net result is the same. The principle operation of this type of component has much similarity with loudspeakers, which convert electrical energy to acoustic pressure waves, or sound, and hence they are often known colloquially as ‘voice coil motors’ (VCM).

VCMs for auto focus electronic cameras exist in a wide variety of configurations. However, they have a number of deficiencies which are evidenced as high manufacturing cost, poor reliability, slow speed of operation, high power consumption and large size. Improvements are therefore desirable and VCMs are subject to on-going innovation. Thus far the innovations in VCMs have not overcome all of their deficiencies. It is desired to have an alternative to VCMs for auto focus cameras.

MEMS typically are thin, flat bodies with oppositely facing, generally planar, front and rear surfaces and with edges extending between these surfaces. One or more portions of the body are designed to move in response to a control stimuli.

Certain other types of MEOMS are used to vary the behavior of optical systems. For example a moving element of a MEMS body can obscure an optical path, in which case it will act like a shutter. By this means the MEOMS provides an interchange between an electrical control signal and a response in the optical domain.

If a moving surface of a MEMS actuator is connected to a part of a lens train that is permitted to move along the optical axis of an electronic camera then an autofocus mechanism can be realized. An example is described in U.S. Pat. No. 7,813,634, which is incorporated by reference herein. Such an autofocus mechanism has much similarity with a VCM. One difference is the force that drives physical movement, which is in one case electrostatic and the other magnetic. Indeed, loudspeakers based on electrostatic motors have been developed and are available commercially.

In miniature fixed focus and auto focus cameras that contain multiple lenses, one of the key factors that affect the image quality is the accuracy with which the optical elements, notably the lenses, can be manufactured and assembled as an optical train. This accuracy depends on how close to the computed design that the product tends to be. Of these challenges, assembly generally presents high risk, because placement of the lenses is desired to be accurate to very high precision in five degrees of freedom. Sometimes even a very slight rotation can be significantly undesirable for lenses, e.g., when the lenses are assymmetric about the optical axis.

Two methods are commonly employed to assemble lenses in a lens turret to form an optical train. One is to fabricate a lens turret with an accurate interior space and then endeavour to insert, then affix, the lenses in the desired location inside the lens turret.

Another method is to provide each lens with physical features that register precisely with the next lens. Having accurately assembled the optical train using physical features for registration, the optical train is then inserted into the lens turret where it again mates with additional physical features that provide registration. An adhesive is then applied to hold the lens train in position in the turret. In the interests of clarity, in this disclosure suitable registration features will be depicted simply as mating cups and cones.

In an auto focus camera, an entire lens turret may be attached to an actuator, typically a VCM, so that the VCM can move the turret with respect to the lens barrel, which contains the image sensor at its bottom and hence alter the focus of the camera. Departures of the lens turret from alignment on the optical axis of the camera through motion of the actuator can tend to degrade the image quality. Indeed this can be a significant problem for miniature auto focus cameras, and manufacturers of VCMs often endeavour to provide VCMs with a tilt specification of <0.3 degrees.

In a miniature electronic camera, for reasons of Physics, the first lens is particularly susceptible to de-centering error. To overcome this, in a fixed focus camera it is usual to bond rigidly together the first and second lenses to keep the de-centering error to an acceptable specification. Consequently in an auto focus camera where just the first lens is moved by an actuator, it is generally the case that the only way to accurately position this lens is by active alignment. That is, the lens is attached to the actuator and the actuator, plus lens, are aligned to the lens turret, and then fixed to it. Although active alignment is wholly practical and fully automatic machines exist that are capable of this function, it is typically a slow process step and one that is preferably eliminated from the manufacturing flow to increase throughput and reduce cost. Alternative structures and assembly methods that offer improvements are thereby sought.

In a miniature multi-lens electronic camera the principal aperture is usually located in front of the first lens. The principal aperture determines the F-number of the camera. It usually includes a circular opening in the housing that surrounds the camera and has the luxury of being relatively imprecise in location and circularity without degrading image quality. In a fixed focus camera this aperture is fixed in position relative to the imager. However, in a conventional auto focus camera the distance between the principal aperture and the optical train will vary with the focus setting of the camera. This variation is often accommodated in the optical design causing it to be compromised and thus improvements are desired. One solution involves the first lens and principal aperture moving in tandem. However, accurate alignment of the aperture to the first lens becomes more important, and multiple active alignment steps can be tedious, and thus improvements are sought.

An additional consideration when selecting an actuator for an auto focus camera where only the first lens and optionally the aperture can move, is the structure employed to make electrical connection to the actuator. A common method of making of multiple electrical connections to an electrically controlled part of an optical train is by means of a so-called flexible circuit. A typical flexible circuit includes very thin and narrow copper tracks on a polyimide film. While flexible circuits work well, they are unsightly, susceptible to mechanical damage, are relatively expensive and there is a manufacturing cost associated with terminating both ends of the flexible circuit. Termination is usually either by a plug and socket arrangement or aligning and bonding to a printed circuit board. Plugs and sockets have an inherent unreliability, particularly in high force environments, like drop testing, while direct bonding to a circuit board either precludes or makes expensive rework and replacement of the camera should this be necessary.

In miniature cameras, the focus is typically set based upon the spacing between the optical train and the image sensor. The widely accepted method of accomplishing this is to provide the lens turret with an external screw thread and a matching screw thread on the interior of the lens barrel. The imager is aligned to the lens barrel. By rotation, the lens turret can be moved nearer or further from the imager and hence the focus can be set.

This rotation is a further reason why an actuator carrying the first lens, where the electrical connection to the actuator is by a flexible circuit, is attached and aligned after the positions of the imager and the other lenses are fixed. A flexible circuit that accommodates rotation would tend to be long, unwieldy and expensive.

It is desired to be able o make electrical connections to a lens turret where the location of the electrical contacts on the lens turret are unknown in angle of rotation and their distance from the lens barrel is also unknown. In practice, due to the precision with which optical trains, lens barrels and lens turrets can be manufactured, the uncertainty in the angle of rotation will seldom exceed 90 degrees and the uncertainty in the vertical separation is commonly less than 75 microns. Methods and structures for realizing improved electrical connections between an actuator that is configured to move the first lens in an optical train and the printed circuit board on which the camera module is attached are desired.

### BRIEF DESCRIPTION OF THE DRAWINGS

The structure and methods of fabrication of the electrostatic actuators and cameras described herein are best understood when the following description of several illustrated embodiments is read in connection with the accompanying drawings, wherein the same reference numbers are used throughout the drawings to refer to the same or like parts. The drawings are not necessarily to scale; emphasis has instead been placed upon illustrating the structural and fabrication principles of the described embodiments.

FIG. 1 is a cross-section of a radially symmetric electrostatic actuator, taken though its diameter that has fixed surface and a juxtaposed moving surface subtended by an acute angle, according to an embodiment.

FIG. 2 is a plan view of the structure in FIG. 1, according to an embodiment.

FIG. 3 is a cross-sectional drawing indicating one possible electrostatic charge distribution through the structure in FIG. 1, according to an embodiment.

FIG. 4 is an idealized cross-section though the structure in FIG. 1 expressed in geometrical symbols, according to an embodiment.

FIG. 5 shows in partial section and plan view several intermediate positions when the fixed and moving surfaces are abutted, according to an embodiment.

FIG. 6 is a cross-sectional drawing of the structure in FIG. 1 with the actuator in its fully abutted position, according to an embodiment.

FIG. 7 shows a moving surface segmented into four involute spirals to cause in-plane rotation of the central area on radially stretching of the moving surface of the actuator, according to an embodiment.

FIG. 8 is an embodiment of the radially symmetric electrostatic actuator having a second fixed surface that is a mirror of the fixed surface, including the acute subtended angle between the moving surface and the second fixed surface, according to an embodiment.

FIG. 9 depicts cross-sectional detail of various embodiments of the moving surface in an electrostatic actuator, according to an embodiment.

FIG. 10 shows several embodiments of the actuator, in partial cross-section, illustrating mechanical stops associated with the fixed surfaces, according to an embodiment.

FIG. 11 is a partial cross-section detail of the fixed surface showing an embodiment where the fixed surface has two acute angles, according to an embodiment.

FIG. 12 is a partial cross-section detail of the fixed surface showing an embodiment where the fixed surface supports a variable acute angle, according to an embodiment.

FIG. 13 is a schematic cross-section showing the principal components of an electronic camera, according to an embodiment.

FIG. 14 is an embodiment of FIG. 8, shown in cross-section, where the radially symmetric electrostatic actuator carries an optical lens to alter the position of the lens relative to other optical components and an image sensor, according to an embodiment.

FIG. 15 and FIG. 16 show the tri-state electrostatic actuator of FIG. 13 in the two extreme positions of its stroke, according to an embodiment.

FIG. 17 is a section and plan view of a bi-state electrostatic actuator where the fixed part is square and segmented into four quadrants, according to an embodiment.

FIG. 18 shows the displacement of the moving part in the actuator, according to an embodiment.

FIG. 19 is an idealized cross-section though the structure in FIG. 18 expressed in geometrical symbols, according to an embodiment.

FIG. 20 is an outline process flow to fabricate the radially symmetric actuator with acute angle electrodes shown in FIG. 8 and carrying an optical lens of the type shown in FIG. 14, according to an embodiment.

FIGS. 21-23 illustrate certain steps of the process given in FIG. 20 in additional detail, according to an embodiment.

FIG. 24 is a cross-section through the device shown schematically in FIG. 1 illustrating in detail an embodiment of the moving surface.

FIG. 25 is a plan view of a radially symmetric electrostatic actuator showing an embodiment of a possible assembly process, according to an embodiment.

FIG. 26 shows plan and sectional view of an embodiment of the electrostatic actuator where the fixed surface is divided into two radially symmetric parts, according to an embodiment.

FIG. 27 is a cross section of a fixed surface supporting two concentric conductive electrodes, according to an embodiment.

FIG. 28 is a configuration of the structure given in FIG. 11 where the two parts of the fixed surface are set at different acute angles to the moving surface, according to an embodiment.

FIG. 29 shows the actuator given in FIG. 28 with the moving surface in three positions, according to an embodiment.

FIG. 30 depicts plan and sectional views of an embodiment of the moving surface where the conductive foil is divided into two concentric regions, according to an embodiment.

FIG. 31 is a cross-section of a radially symmetric electrostatic actuator, taken through its diameter, that has a fixed surface and a juxtaposed moving surface subtended by an acute angle, according to an embodiment.

FIG. 32 is a cross-section of a radially symmetric electrostatic actuator, taken through its diameter, that has a fixed surface and a juxtaposed moving surface subtended by an acute angle, and that further has two separate fixed surface electrodes, according to an embodiment.

FIG. 33 is a cross-section of a radially symmetric electrostatic actuator, taken through its diameter, that has a fixed surface and a juxtaposed moving surface subtended by an acute angle, and that further has two separate fixed surface electrodes where the fixed surface has two acute angles, according to an embodiment.

FIG. 34 is a cross-section and plan view of a radially symmetric electrostatic actuator, that has a fixed surface and a juxtaposed moving surface subtended by an acute angle, that further has two separate fixed surface electrodes formed from a thin coating on polymer, according to an embodiment.

FIG. 35 is a cross-section and plan view of a radially symmetric electrostatic actuator, that has a fixed surface and a juxtaposed moving surface subtended by an acute angle, that further has two separate fixed surface electrodes formed from a thin coating on polymer with one electrode connected to one side of the fixed surface and the other electrode connected to the other side of the fixed surface, according to an embodiment.

FIG. 36 is a schematic diagram showing nine possible states of an electrostatic actuator having two separate fixed surface electrodes, according to an embodiment.

FIG. 37 shows the fixed surface of a tri-state electrostatic actuator having a recess at its periphery with the moving surface attached to the fixed surface by a material that is either thinner, the same thickness as, or taller than the depth of the recess, according to an embodiment.

FIG. 38 provides section and plan views of a tri-state electrostatic actuator with a peripheral recess in the fixed surface that is partly filled by a ring embedded in the material that joins the moving surface to the fixed surface, according to an embodiment.

FIG. 39 shows section and plan detail of the moving surface, where the moving surface contains a through-thickness aperture that is surrounded by a ring that is attached to the moving surface, according to an embodiment.

FIG. 40 shows a tri-state electrostatic actuator in plan and section view where embedded within the fixed surface there is a permanent magnet and embedded within the moving surface there is a coil, according to an embodiment.

FIG. 41 depicts a variety of locations for a permanent magnet to be associated with the fixed surface component, according to an embodiment.

FIG. 42 shows section and plan views of a fixed surface that has a substantially planar coil attached to one surface, according to an embodiment.

FIG. 43 shows a cross-section of a magnet in an upper electrode and a plan view of a membrane having a coil, according to an embodiment.

FIG. 44 shows a plan view of a membrane having two coils and a plan view of a membrane having one coil, according to an embodiment.

FIG. 45 shows a cross-section of an upper electrode having wire therein/thereon and a plan view of a magnetic material coated membrane, according to an embodiment.

FIG. 46 shows a cross-section of an upper electrode having wire therein/thereon and a plan view of a magnetic material coated membrane, according to an embodiment.

FIG. 47 shows a cross-section of an upper electrode having a coil therein/thereon and a plan view of a magnetic material coated membrane, according to an embodiment.

FIG. 48 shows a cross-section of an upper electrode having a coil therein/thereon and a plan view of a magnetic material coated membrane, according to an embodiment.

FIG. 49 is a cross section of a train of lenses that are aligned using physical features.

FIG. 50 is a cross section of a lens aligned to a re-useable carrier using physical features.

FIG. 51 shows a cross sectional through a tri-state electro static actuator aligned to the re-useable carrier in FIG. 50 using physical features.

FIG. 52 is a cross section through a lens turret that has been aligned to a tri-state electrostatic actuator using physical features.

FIG. 53 shows a lens turret destined for use as a miniature camera optic in which all but the first lens has been aligned and assembled. The act of placing the first lens on the second lens and aligned them by means of physical features is indicated.

FIG. 54 shows FIG. 53 with a tri-state electrostatic actuator attached to the lens turret.

FIG. 55 illustrates a moving electrode of a tri-state electrostatic actuator that is deformed in accordance with an embodiment and attached to the first lens while the first lens remains aligned to the second lens.

FIG. 56 depicts a complete optical train for a miniature camera incorporating a tri-state electrostatic electrode where the lenses have been aligned to each other by physical features.

FIG. 57 shows a lens aligned to an aperture using physical features.

FIG. 58 is a cross-sectional drawing of a tri-state electrostatic actuator according to an embodiment.

FIG. 59 is a plan view of the structure in FIG. 57.

FIG. 60 shows plan and cross-section views of a means of making electrical connection to a tri-state electrostatic actuator using sprung contacts.

FIG. 61 is a more detailed drawing of an alternative method of making electrical connection to a tri-state electrostatic actuator using sprung contacts.

FIG. 62 depicts an embodiment on FIG. 60 where the contacts can be recessed within the thickness of the structure.

FIG. 63 shows an embodiment of the electrical connections where the sprung contacts are attached to the lens turret.

FIG. 64 is an embodiment of the invention where the electrical connections are on one radius of the lens turret and lens barrel.

FIG. 65 contains cross section and plan views of a lens turret that proves electrical access to the three electrodes of a tri-state electrostatic actuator.

FIG. 66 is an embodiment of the electrical connections where the contacts are all on the same plane.

FIG. 67 is an alternative method of making electrical connections where the contacts are all on the same plane.

FIG. 68 is an embodiment of FIG. 67 that permits the contacts to all be on the same plane and recessed within the thickness of the structure.

FIG. 69 is a structure that permits connections to a tri-state electrostatic actuator to be made at its edge.

FIG. 70 is a structure that permits connections to a tri-state electrostatic actuator to be made at a sloping edge.

FIG. 71 contains cross section and plan views illustrating electrical pathways through a lens barrel.

FIG. 72 shows a detail of an electrical pathway through a lens barrel where two conductive rods join by a sliding interference fit.

FIG. 73 is a pseudo circuit diagram that illustrates back-to-back diodes being used to divide two voltages asymmetrically among three rails.

FIG. 74 is a dual edge contact to a tri-state electrostatic actuator that presumes the presence of the circuit given in FIG. 73 in the structure.

FIG. 75 is a cross-section though a tri-state electrostatic actuator showing a cover recessed within the thickness of the upper static electrode.

FIG. 76 is a sectional view indicating the principal components of a fixed focus solid state camera.

FIG. 77 shows the principal components of a tri-state electrostatic actuator in section view.

FIG. 78 depicts an autofocus camera, in section, comprising a tri-state electrostatic actuator supporting the first lens and mounted on an optical train.

FIG. 79 is a cross section drawing of an automatic focus camera incorporating a tri-state electrostatic actuator where the lower fixed electrode is part of the housing of the optical train.

FIG. 80 depicts a lens turret incorporating a tri-state electrostatic actuator that carries the second lens of an optical train, where the upper and lower fixed electrodes form part of the lens turret.

FIG. 81 illustrates a compliant structure including a conductive rod or strip that is turned away from the edge of a multi-state actuator in accordance with certain embodiments.

FIG. 82 illustrates a compliant structure including a protrusion at its end that extends towards the center of a multi-state actuator in accordance with certain embodiments.

FIG. 83 illustrates a compliant structure having a protrusion formed by bending an end towards a multi-state electrostatic electrode in accordance with certain embodiments.

FIG. 84 illustrate embodiments including a first lens on an object side of a flexible electrode and passive alignment features of the lens on the image side.

FIG. 85 illustrates a miniature camera module including a multi-state actuator in accordance with certain embodiments.

### DETAILED DESCRIPTION OF THE EMBODIMENTS

According to an embodiment, an electrostatic actuator can comprise top and bottom opposing substrates spaced apart by support walls forming a cavity therebetween. A bottom surface of the top substrate and a top surface of the bottom substrate can be inclined to each other at an acute angle and can have a modicum of electrical conductivity. For example, the sheet resistance of each of these surfaces may be approximately 1 mega ohm per square, or less.

According to an embodiment, the acute angle can range from approximately 0.1 to approximately 15 degrees, can be in the range of approximately 0.1 to approximately 5 degrees, and can be between approximately 1 and approximately 2 degrees. The acute angle can be an inclined plane on the bottom surface of the top substrate. The top substrate can be thickest at its periphery and thinnest at its center. The acute angle can be constant or can be variable so the resulting plane can be curved, parabolic, tilde-like, or stepped. Each step can be at a progressively larger acute angle.

According to an embodiment, one substrate can be rigid and the other substrate can be flexible and can be able to deform when the opposing surfaces of the cavity carry electrostatic charge. Deformation of the flexible substrate can occur through application of electrostatic charge to said top and bottom surfaces. The electrostatic charge can be developed by connection of the conductive elements of the rigid and flexible substrates to a direct current voltage source.

According to an embodiment, the direct current voltage source can have an alternating voltage component, used to ascertain the capacitance between the bottom surface of said top substrate and a top surface of said bottom substrate and thereby regulate the charge between them. The flexible substrate can deform by stretching in the in-plane direction. The flexible substrate can be segmented in curves so that stretching in the in-plane causes rotation of the central portion.

According to an embodiment, deformation of the flexible substrate can cause it to abut the rigid substrate. The rigid substrate can be segmented so that asymmetric charging causes asymmetric deformation of the flexible substrate and out of plane translation of the central portion. Relative motion between the rigid and moving substrates can result in a moving contact line where ahead of the line the rigid and moving substrates are apart and behind it they abut.

According to an embodiment, the cavity can be radially symmetric so the contact line takes the form of circle. Movement of the flexible substrate can be limited by mechanical stops. Where the acute angle between the rigid and flexible substrates is divided into discrete steps, displacement of the flexible substrate can occur in voltage steps. Displacement of the flexible substrate can be by control of the charge in the capacitor formed between the bottom surface of said top substrate and a top surface of said bottom substrate.

According to an embodiment, the rigid substrate can be a conductive metal or a conductive polymer or a dielectric polymer coated with a conductive metal. The flexible substrate can be a conductive metal or a conductive polymer or a dielectric polymer coated with a conductive metal. In a flexible substrate composed of polymer coated with metal the thickness of the metal can be no greater than one tenth of the thickness of the polymer. The surface of the fixed and flexible substrates can be textured the texture can include through holes.

According to an embodiment, there can be at least one dielectric film between the outermost conducting surface of the rigid and flexible substrates. The bottom substrate can have a top substrate on both sides so cavities exist on both sides of the flexible substrate.

According to an embodiment, the flexible substrate can contain an aperture. Spanning the aperture can be a component with optical functionality. The component with optical functionality can be a lens. The component with optical functionality can be a diffractive optic.

According to an embodiment, the electrostatic actuator with optical functionality can be an element in a train of optical components and can be present on the optical axis between a scene and an optical sensor. The electrostatic actuator with optical functionality can be part of a step focus camera system. The electrostatic actuator with optical functionality can be part of a camera system that has an opto-algorithmic (extended depth of field or EDoF) focus system. The electrostatic actuator with optical functionality can be part of an autofocus camera system. The electrostatic actuator with optical functionality can have an external diameter of 6 mm and a thickness of 1 mm and the actuator can move a 2.4 mm diameter lens distance of 30 um with a 30 volt source.

According to an embodiment, a method of manufacturing the electrostatic actuator with optical functionality can comprise taking a flexible substrate, setting the flexible substrate at a pre-defined tension, attaching fixed substrates to one or both sides, forming an aperture in the flexible substrate and affixing a lens over the aperture. Tensioning of the flexible substrate can be accomplished by attaching the flexible substrate to a ring and heating the ring to cause it to expand in circumference.

According to an embodiment, the top substrate can be made of a material that has moderate rigidity, e.g., approximately 750 GPa or more, and sufficient electrical conductivity to set up a uniform electric charge on its surface. For example, the material may exhibit a sheet resistance of one mega ohm per square or less. The material can be a metal like aluminum. The material can be a conductive polymer, such as a doped liquid crystal polymer, or a metal-filled polymer such as a dielectric material that can be filled with conductive particles like metal spheres, flakes or needles. The material can be a dielectric polymer that has a surface coating of a conductive material.

According to an embodiment, the bottom substrate can be made of a material that has low modulus and large elastic range and sufficient electrical conductivity to set up a uniform electric charge on its surface. For example, the effective modulus of the flexible electrode may be approximately 250 GPa microns, or less, and can be approximately 1 GPa micron or less, 5 GPa microns, 10 GPa microns, 50 GPa microns, 70 GPa microns, 100 GPa microns, 150 GPa microns or 200 GPa microns. The material can include a thin foil of metal like aluminum. The material can include a conductive polymer such as carbon-loaded rubber or a conductive silicone rubber sheet. The material can include a thin film of dielectric polymer, such as 3-15 um thick PET, Kapton or polyimide, coated on one or both surfaces with a thin layer of a conductive material such as 0.1 um aluminum. The material can include a thin foil of a conductive material, like aluminum, encapsulated in a thin layer of dielectric material like polyimide.

According to an embodiment, an actuator can comprise a first member and a second member that is movable with respect to the first member. Movement of the second member with respect to the first member can be responsive to both a magnetic force and an electrostatic force.

According to an embodiment, an actuator can comprise a fixed electrode and a moving electrode that is movable with respect to the fixed electrode. A comparatively large current can move the moving electrode toward the fixed electrode and a comparatively small voltage can hold the moving electrode in an actuated position.

According to an embodiment, an actuator can comprise a first member having a recess formed in a bottom surface thereof, a second member that is movable with respect to the first member, and a support separating the first member and the second member. The support can be disposed at least partially within the recess. Movement of the second member with respect to the second member can be responsive to a magnetic force and/or an electrostatic force.

According to an embodiment, an actuator can comprise a first member having a first aperture formed therein, a second member that is movable with respect to the first member and having a second aperture formed therein such that the second aperture is generally co-axial with respect to the first aperture, and a structural element configured such that the first aperture and/or the second aperture are substantially surrounded by the structural element.

Disclosed are methods for passive alignment of a lens train and optional apertures where one lens and optionally one aperture can be moved along the optical axis of the lens train preferably by a tri-state electrostatic actuator. The methods require the lenses and apertures to have structures in the form of physical features, like knife edges, to set the alignment of one lens or aperture to the next. Optionally, a re-useable carrier can be used in setting the alignment of the moving lens and optional aperture to the tri-state electrostatic actuator and of the tri-state electrostatic actuator to the fixed lenses and apertures of the optical train.

Also disclosed are structures for making electrical connection to a tri-state electrostatic actuator that can sustain contact as the angle of rotation and spacing of the tri-state electrostatic actuator varies with respect to the lens barrel. Included in this part of the disclosure are structures that form electrical pathways through the height of, on the surface of, or recessed within the surface of the lens barrel.

Further disclosed is a cover that can placed on the image side of a tri-state electrostatic actuator that can have optical functionality.

Disclosed is an electronic camera that uses an actuator to alter the position of the first lens of an optical train relative to the image sensor and so alter the focus of the camera. The actuator is a tri-state device operated by the forces of electrostatic attraction and comprises two fixed electrodes and one moving electrode that carries the first lens. The lower of the fixed electrodes extends to form a housing that accommodates the non-moving components of the optical train. Having the lower fixed electrode provide this multiplicity of function helps ensure the first lens is appropriately aligned to the optical axis of the camera module and decreases the number of components and assembly steps necessary to manufacture the camera module.

Disclosed is an electronic camera that uses an actuator to alter the position of the first lens of an optical train relative to the image sensor and so alter the focus of the camera. The position of the principal aperture can be either in front or behind of the first lens and optionally move with the first lens. Such a camera can also contain a plurality of additional lenses and apertures that are fixed in position. Where the plurality is four, the refractive power tends to increase from the first to last lens and alternate positive, negative, positive, negative. Example lens prescriptions are disclosed.

One or more embodiments of a mechanical actuator are disclosed in which movement can be accomplished by electrostatic force and the electrostatic charge can be derived from a voltage source. The actuator has two principal parts on which the electrostatic charge can be distributed. These are a fixed surface and a moving surface. The moving surface is able to move by means of elastic deformation. The fixed and moving surfaces are not parallel, but inclined relative to each other at an acute angle, e.g., of around 1 degree in certain embodiments. Motion of the moving surface is unidirectional, that is without rotation or tilt unless deliberately so engineered. The actuator can be radially symmetric.

According to an embodiment, the central portion of the actuator can be removed. The aperture in the part with the fixed surface can be left clear, while an optical component can be fastened over the aperture in the moving surface. In operation, the actuator can then be able to alter the position of the optical component relative to the fixed surface. When the optical component is a lens, the actuator can be incorporated in the optical train of an electronic camera as part of a variable focus system.

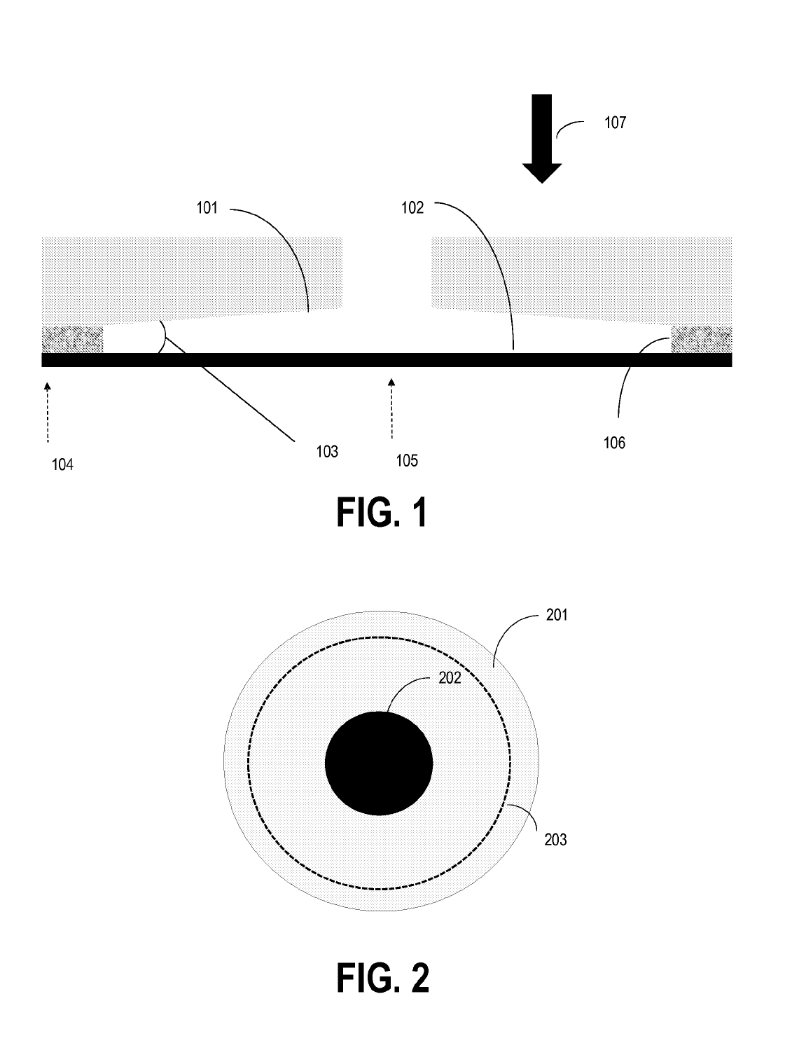

FIG. 1 is a cross-section of a radially symmetric electrostatic actuator 100, taken through its diameter that has fixed surface 101 and a juxtaposed moving surface 102 subtended by an acute angle 103, according to an embodiment. The acute angle exists because, when at rest, the moving surface is substantially flat while the fixed surface has a taper so that there is close proximity between the two surfaces at the periphery of the device 104 and a greater distance of separation towards the center of the device 105. To permit the generation of different charges on the fixed and moving surfaces of the device they are separated by a dielectric 106. In certain embodiments, the dielectric 106 has an adhesive property such that the dielectric 106 can provide the added function of joining the moving surface to the fixed surface in the vicinity of the perimeter 104 of the device. The normal viewing direction, when referring to plan views of this device is indicated by the arrow 107.

FIG. 2 is a plan view 200 of the device shown in FIG. 1, according to an embodiment. In this example the part 201, which supports the fixed surface on its hidden underside, is shown to be a radially symmetric component with an aperture in its center 202 that transverses the full thickness of the part. As will be described, part 201 is not restricted to being a circle. Likewise both the presence and shape of the aperture can take many forms. In certain embodiments according to the plan view shown in FIG. 2, the fixed and moving surfaces are concentric. To aid understanding, also shown in FIG. 2 and denoted by a dotted circle 203 is the innermost boundary of the adhesive dielectric material.

According to an embodiment, an acute angle can be formed between the fixed and moving surfaces, 103. The acute angle can range from 0.1 to 15 degrees, more typically can be over the range 0.1 to 5 degrees, and preferably can be 0.5-2 degrees.

In a conventional comb drive the equivalent acute angle is highly undesirable and is engineered to be as small as possible and can be less than 0.1 degree. This is because a very small and zero acute angle results in uniform attractive force between the static and moving teeth of the comb drive, which helps mitigate or prevent bending and warping of the combs and other non-linear effects that are difficult to control. The design of electrostatic actuator with the acute angle 103 shown in FIG. 1 desirably, for reasons that will be described, permits a non-uniform force to act on the moving surface that varies in inverse proportion to the radius of the device.

In other words, for a given charge, the attractive force between the fixed and moving surfaces will be higher at the periphery than in the center. This condition is readily met by providing the fixed surface with a small taper, when viewed in cross-section. For simplicity of manufacture the taper can be linear although other profiles such as a counter-intuitive profile resembling the tilde symbol (i.e. ˜), the detail of the profile being generated by computer modeling, can be used when manufacturing conditions permit. For the structure shown in FIG. 1, computer simulation suggests that the actuation voltage of the electrostatic actuator is approximately one third smaller when the electrodes are inclined at an acute angle compared with when the electrodes are perfectly parallel. For a tilde-shaped fixed surface, the actuation voltage is approximately half that of a parallel electrode actuator.

According to an embodiment, operation of the actuator entails contact between the fixed and moving surfaces. Normally in a comb drive this situation is avoided wherever possible since contact can cause mechanical damage to the abutting surfaces and potential sticking of the moving teeth to the static teeth through a combination of hydrated surface films and/or electrostatic potentials and Van der Waals forces.

According to an embodiment, relative motion between the fixed and moving surfaces results in a moving contact line where ahead of the line the fixed and moving surfaces are apart and behind it they are abutted. When viewed in cross-section the motion is analogous to a clothing zipper. In a conventional comb drive both the fixed and moving surfaces are made of rigid materials, like silicon, which precludes this type of motion.

According to an embodiment, a flexible substrate deforms by stretching in the in-plane. MEMs devices made in silicon commonly utilize especially engineered features like serpentine structures in order to achieve flexibility in a desired direction.

According to certain embodiments, the properties of the part supporting the fixed surface 101 include that it has sufficient strength to be mechanically self-supporting, can be fabricated in the desired shape and has sufficient electrical conductivity to set up a uniform electric charge on its surface. For these reasons the fixed part 201 can be made of a conductive material such as a metal like aluminum, a conductive polymer such as a doped liquid crystal polymer, a metal-filled polymer (i.e. a dielectric material that is filled with conductive particles like metal spheres, flakes or needles) or a dielectric polymer, like nylon, that has a surface coating of a conductive material such as aluminum.

Also according to certain embodiments, the properties for the part supporting the moving surface 102 include that it possesses adequate strength to be mechanically self-supporting, can be fabricated in the desired shape, has sufficient electrical conductivity to set up a uniform electric charge on its surface, has a low elastic modulus to enable it to be deformed by an electrostatic charge, and high elastic and fatigue limits to permit the deformation to occur many times without change or damage. The moving part may be made of a dielectric polymeric material that has either been modified to render it electrically conductive or has had applied to it a coating of metal. Owing to the relative modulii of metals and polymers, in the latter embodiment the metal coating will be smaller than one tenth of the polymer thickness in certain embodiments or substantially less.

As mentioned above, the dielectric material 106 can be an electrical insulator and can perform the additional function of joining the fixed and moving parts at the periphery of the device. Suitable polymers may be new or well known and understood and available commercially in a wide variety of forms and formulations, as long as the polymers exhibit the desired properties. Examples include pressure-sensitive adhesives, liquid adhesives, double-sided adhesive tape, chemically curing adhesives, thermally curing adhesives, and optically-cured adhesives. In this context optically usually means ultra-violet.

The device shown in FIG. 1 can be activated by electrostatic charge. Electrostatic charge can be developed by a plethora of techniques, including one that has the advantage of ready control by an electronic system and involves a high voltage power supply. The high voltage may be developed using transistor circuitry and combinations of resistors, capacitors, inductors and diodes. Depending on the design of the electrostatic actuator, the applied voltage could involve a range from very low voltages up to many tens of thousands of volts. An example of a typical range is 10-100 volts. For use with certain portable electronic equipment, the voltage can be around 30 volts. Lower voltages result in smaller electrostatic forces, while higher voltages are possible but more challenging to develop from the low voltage batteries generally found in portable electronic equipment.

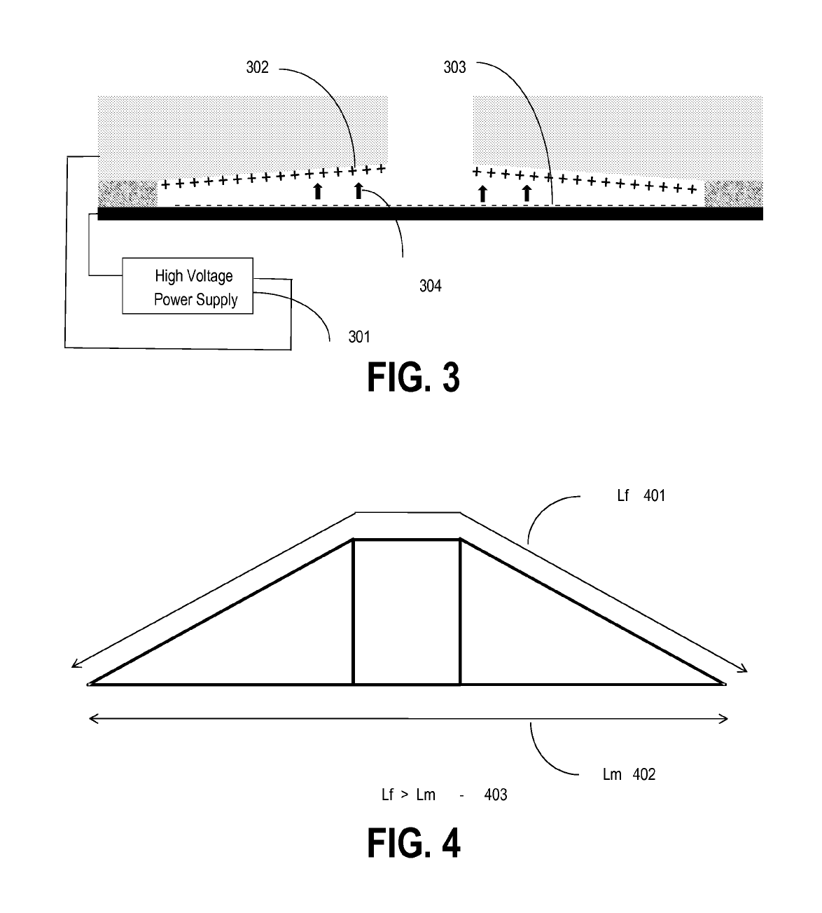

A cross-sectional view of the electrostatic actuator showing one possible charge distribution is shown in FIG. 3. One terminal of a high voltage power supply 301 (detail not shown), is connected to the fixed surface and the opposing terminal to the moving surface. The polarity of the terminals is such that positive charge 302 uniformly covers the fixed surface and negative charge 303 uniformly covers the moving surface.

In accordance with the Laws of Physics, an attractive force, depicted by arrows 304, will exist between the electrostatic charges because they are of opposite polarity. The fixed surface cannot move, since it is fixed by definition. The moving surface will therefore tend to attempt to move towards the fixed surface.

FIG. 3 shows operation of the radially symmetric actuator through generation of a positive charge on the fixed surface and a negative charge on the moving surface, according to an embodiment. It will be apparent that an identical attractive force will result if the polarity of the high voltage power supply is reversed such that positive charge is developed on the moving surface and negative charge on the fixed surface. Another embodiment is to develop charge of the same polarity on both surfaces, either positive on both or negative on both, e.g., to move the moving surface away from the fixed surface. In yet another embodiment both the polarity and rate of change of charge can be modulated by a wide variety of waveforms which will be reflected in the rate of acceleration and speed of movement of the moving surface.

The radially symmetric electrostatic actuator is not restricted to being a two-position or bi-state device. The function of the high voltage is to create an electrostatic charge. The electrostatic charges so developed attract, resulting in a tensile force that acts on the modulus of the moving surface, causing it to stretch in a radial direction. For any displacement of the moving surface there will be a mechanical restoring force from the elastic stored energy. If the force from electrostatic charge is larger than the restoring force from stored energy, the moving surface will abut the fixed surface.

When the force from electrostatic charge is small or even zero, the restoring force will dominate and the moving surface will be at its flat rest position. For intervening magnitudes of electrostatic charge and hence attractive force, these can exactly balance the elastic restoring force permitting full analogue control of the displacement of the moving surface by the voltage developed by the high voltage power supply.

With reference to FIG. 4, it will be evident that in order for the moving surface to displace towards the fixed surface it will increase in area since the fixed and moving surfaces are fixedly joined at the periphery of the device. FIG. 4 illustrates the matter when reduced to a sectional view and simplified geometric form. It can be seen that the length of the fixed surface Lf, 401, is greater than the length of the moving surface Lm, 402, such that Lf is always greater than Lm, 403. To accommodate vertical displacement the moving surface will deform by stretching because hypotenuse of a triangle is always longer than the adjacent. This means the materials selection for the moving part is driven by the combination of a low modulus, sufficiently large elastic limit and high resistance to failure by fatigue.

The stretching of the moving part in order to facilitate its displacement is one reason why there is an acute angle between the two electrodes of the device, namely the fixed and moving surfaces. Because electrostatic force is inversely proportional to the distance between the charged surfaces, the presence of the acute angle means there is a graduation in force acting on the electrostatic actuator, being high at the periphery and low at the center.

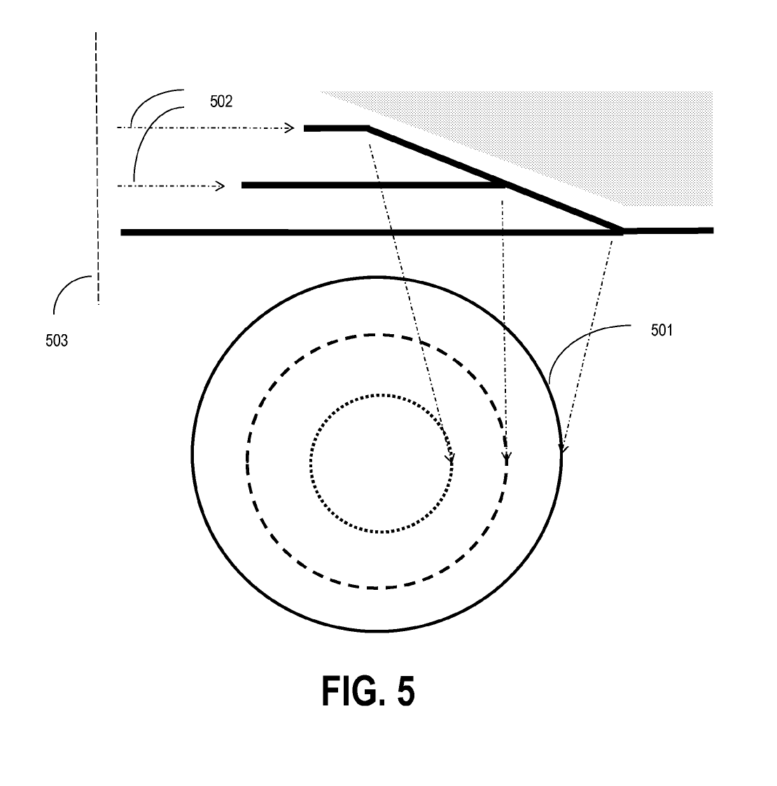

Referring to FIG. 5, it can be seen the moving surface will contact the fixed surface at the periphery first and the contact line 501 will move towards the center of the device in a concentric manner. Thus the central area of the moving surface remains flat and level throughout the device stroke, which is a highly advantageous attribute in certain applications such as when the actuator is moving a component like a lens along the optical axis of a system. FIG. 5 also shows that in order for the moving surface to abut the fixed surface the moving part will stretch 502, relative to the central axis of the device 503 as the contact line moves towards the center.

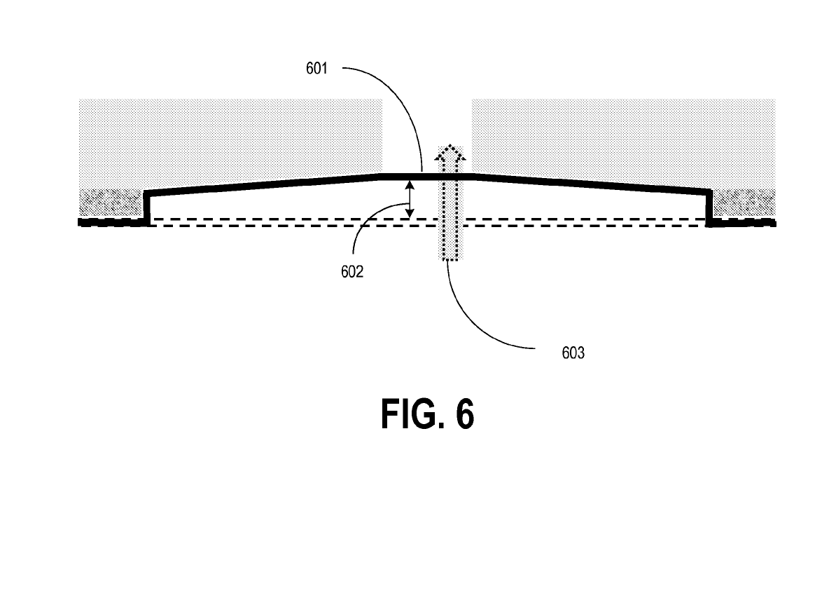

FIG. 6 shows that the maximum displacement the moving surface can experience is when it comes to rest against the fixed surface, according to an embodiment. As can be seen from FIG. 6, the central portion 601 of the moving surface has effectively experienced a linear displacement 602 towards the plan view observation direction 603 from the position of the central portion of the moving surface shown in FIG. 1. Thus the electrostatic actuator of the shown configuration can provide a translation between electric charge, derived from a high voltage power supply and linear mechanical displacement.

The displacement will be close to vertical when the actuator is radially symmetric and made of homogeneous material since the electrostatic charge and all forces are balanced. Alternative displacements are possible by deviating from this arrangement. As will be described, the device need not be either circular, with triangular, square and various regular and irregular polygon shapes all possible, nor symmetric allowing for rectangular and parallelograms and other shapes; there are no fundamental limitations to its shape when viewed in plan.

According to an embodiment, the moving part need not possess homogeneous mechanical properties, in which case a uniform force may result in non-uniform displacement. Likewise embodiments that result in non-uniform charge distribution over one or both of the fixed and moving surfaces may, without compensating adjustments, result in non-uniform forces acting over the device area and hence non-linear displacement. In some embodiments, it is desired to minimize or prevent non-uniform and/or non-linear displacements, such as when adjusting focus by translating a lens. In other embodiments, non-uniform and/or non-linear displacements may be advantageously utilized to achieve desired results. For example, it may be desired to rotate in-plane a polarized or polarizable material or a birefringent material or to rotate out of plane an optic desired to be used along a second axis directed at an angle to a first axis.

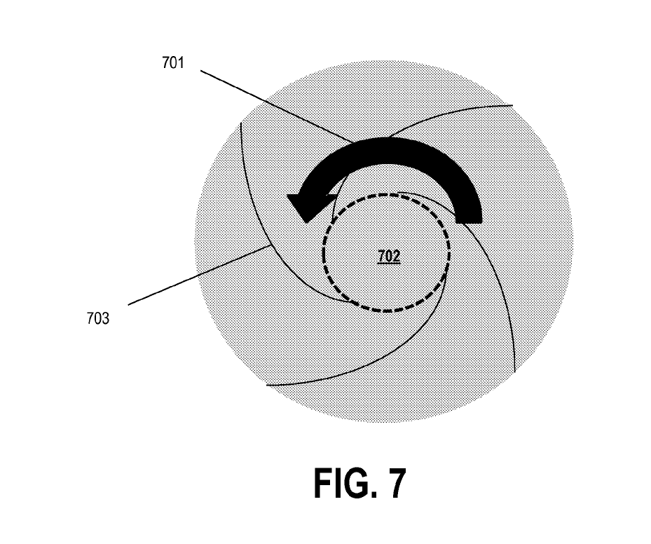

For example, with reference to FIG. 7 if the moving part comprises several spirals, its attraction towards the fixed surface will result in rotation 701 of the central area 702 in the plane of the moving member. The spirals can be accomplished in a variety of ways, one being to cut slits 703 through the thickness of the moving surface to form partial arcs.

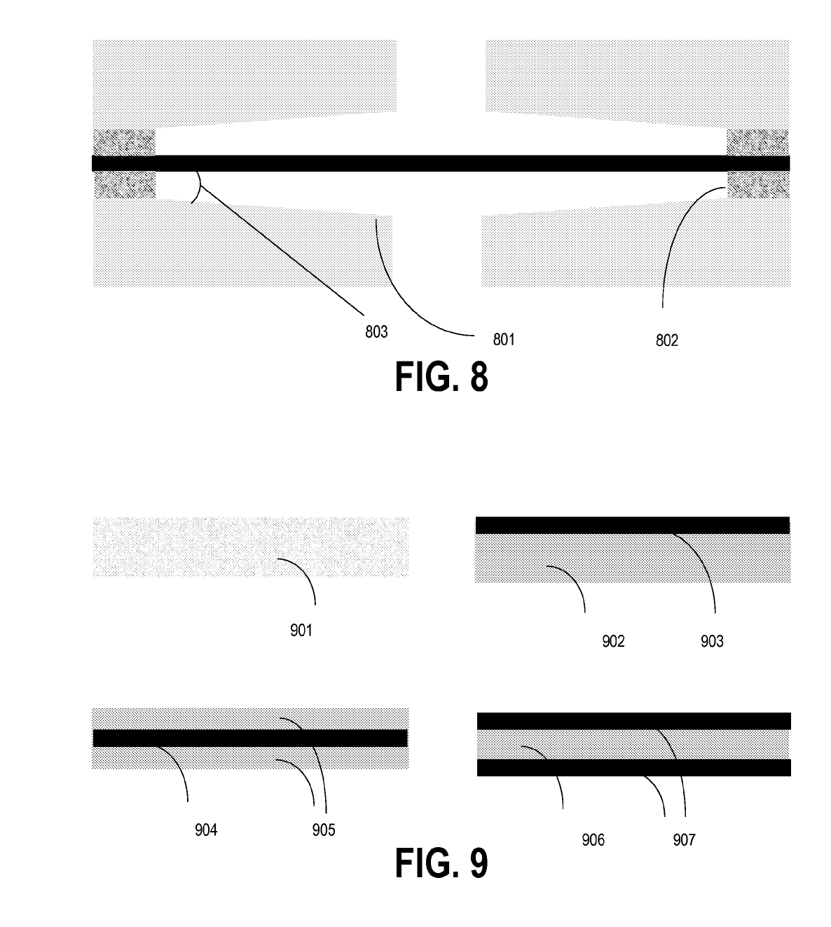

The electrostatic actuator shown in FIG. 1 can have two positions of rest; the moving surface is either flat or abutted against the flat surface. Certain embodiments described herein include an actuator of this type to have three or more positions of rest. From FIG. 8 it can be seen that three positions of rest are achieved by an embodiment that provides a second fixed surface 801, on the opposing side of the moving surface as the first fixed surface. To aid clarity, the fixed surfaces in this device will henceforth be referred to as the first fixed surface and second fixed surface, respectively. The second fixed surface is on the opposite side of the moving surface to the first fixed surface. The second fixed surface is attached and insulated from the moving surface by a picture frame of a dielectric 802, which may be the same or similar to the dielectric 106 described with reference to FIG. 1. Also, there is an acute angle 803 between the moving surface and the second fixed surface 801. Although in FIG. 8 the second fixed surface 801 is been depicted as a mirror of the first fixed surface, there is no fundamental reason for this to be the case. The second fixed surface 801 can be different from the first fixed surface in essentially all dimensional, physical and material aspects, although economic factors can make it preferable for the parts supporting the first and second fixed surfaces to be interchangeable.

Operation of the tri-state device may be the same as that described above for the bi-state device, i.e., with regard to the two positions available with the bi-state device. Application of a high voltage to the moving surface and the second fixed surface will result in electrostatic charge on those surfaces. If the charges are of opposite polarity an attractive force will arise, causing the moving surface to displace towards the second fixed surface. Again, as previously, the two electrostatic charges can be of the same or different polarities and analogue control of the actuator displacement is possible by balancing the electrostatic force against the elastic restoring force of the moving surface. Modulation of the high voltage waveform is again also possible to achieve more sophisticated means of control. Different combinations of polarities are possible with the tri-state device to achieve desired movements: like charges may be provided to the moving surface and first fixed surface or opposite charges may be provided to the moving surface and second fixed surface, or a combination of these, to move the moving surface toward the second fixed surface. Likewise, like charges may be provided to the moving surface and second fixed surface or opposite charges may be provided to the moving surface and first fixed surface, or a combination of these, to move the moving surface toward the first fixed surface.

Thus far the mode of operation of the actuator has only described the situation where there is one electrostatic charge on a fixed surface and one electrostatic charge on the moving surface. In another embodiment, the tri-state device provides for other modes of operation where electrostatic charge is applied either simultaneously or sequentially to both the first and second fixed surfaces, in addition to one or both sides of the moving surface. In a tri-state electrostatic actuator energized by two sets of electrostatic charges, the charges need not be identical in magnitude nor present at the same time. This provides an additional means of control over displacement of the actuator.

It is possible to construct the moving part of the electrostatic actuator of the types described in a variety of configurations. With reference to FIG. 9, in an embodiment, the moving part includes a homogeneous conductive material 901, exemplified by a thin film of aluminum or carbon-loaded rubber. In another embodiment, the moving part includes a thin film of dielectric material 902, such as 3-15 um thick PET, kapton or polyimide, coated on one surface with a thin layer of a conductive material 903, such as 0.1 um aluminum. In another embodiment, the moving part includes a thin film of a conductive material 904 encapsulated in a thin layer of dielectric material 905. In another embodiment, the moving part includes a thin film dielectric material 906 coated on both sides with a thin layer of conductive material 907. Further extension to the sequencing of conductive and dielectric films is possible. Of these combinations, a dielectric film coated on both sides with a conductive material has certain advantages when used in a tri-state electrostatic actuator, because it permits independent control of the polarity and charges acting on the two surfaces of the moving part.

It is possible to construct the fixed parts in a electrostatic actuator of the types described in a variety of configurations. In an embodiment, the first and second fixed parts support different acute angles between the fixed surface and the moving surface. In another embodiment, the first and second fixed surfaces have different shapes. For example the first fixed surface could be an inclined plane, when viewed in section, while the second fixed surface could be a parabola when viewed in section.

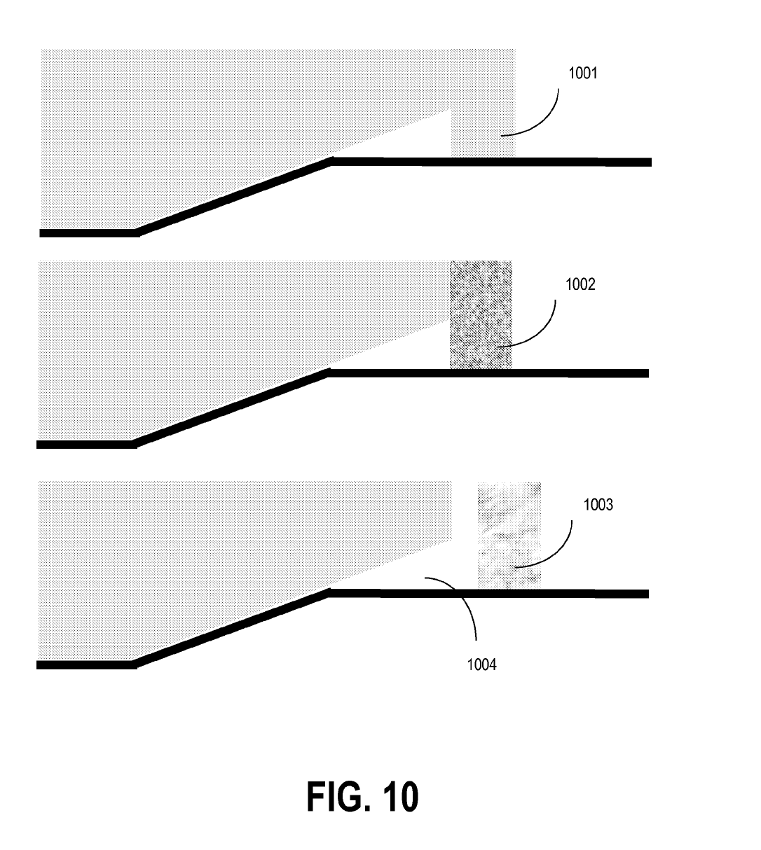

Yet another embodiment of the fixed surface involves the inclusion of mechanical stops. These may either be part of the fixed surface or independent elements. As illustrated in FIG. 10, which shows a detail of a fixed part in cross-section, a stop that is homogeneous with the fixed surface can include a protrusion 1001. The stop is considered to be homogeneous with the fixed surface if it carries electrostatic charge when the fixed surface is charged. Alternatively, the stop may be heterogeneous, in which case a protrusion 1002 may be physically coupled to the fixed surface, or a protusion 1003 may be physically separated from the fixed surface. In both cases the stops are considered to be heterogeneous if they do not deliberately carry electrostatic charge when the fixed surface is charged. There are no fundamental limitations on the shape the stops can adopt and therefore various embodiments involve shapes such as blocks, cones and knife-edges. The stops are not necessarily continuous and can be discontinuous. Because the heterogeneous stops 1002 and 1003 are, by definition, electrically independent of the fixed surface they may be independently charged and therefore alter the distribution of force acting on the moving surface in the electrostatic actuator. This provides an additional means of control over the moving surface.

A consequential benefit of having stops protruding from the fixed surface is that when the moving surface abuts the fixed surface there will remain a non-abutted space 1004. This feature can be highly beneficial in helping to assist the moving surface detach from the fixed surface when the attractive electrostatic charge is dissipated, since it provides an initiation point for detachment by peel. Weakly bonded surfaces, for example those held together by electrostatic forces or vacuum, can be difficult to separate by tensile force while also being readily separable by peel force.

In yet another embodiment, the fixed and moving surfaces are not necessarily smooth but instead textured. The texture may take a variety of forms including random roughness, grooves, ridges, pits, blind and through holes. Texture can help avoid stiction between the moving and fixed surfaces so that on dissipation of electrostatic charge they will part readily under the elastic force of the stretched moving part. Thus the texture can assist in increasing the speed at which the electrostatic actuator can transition between states.

As previously described with reference to FIG. 3, the electrostatic actuator is conveniently energized by means of a voltage source arranged to charge the fixed and moving surfaces. Two voltages are involved, one for when the moving surface is at rest, which will likely be a zero or low voltage and a second higher voltage to effect transition of the moving surface to a second stable state, namely where it abuts a fixed surface. This stable state can be with the moving surface abutting either the first or second fixed surface in a tri-state actuator.

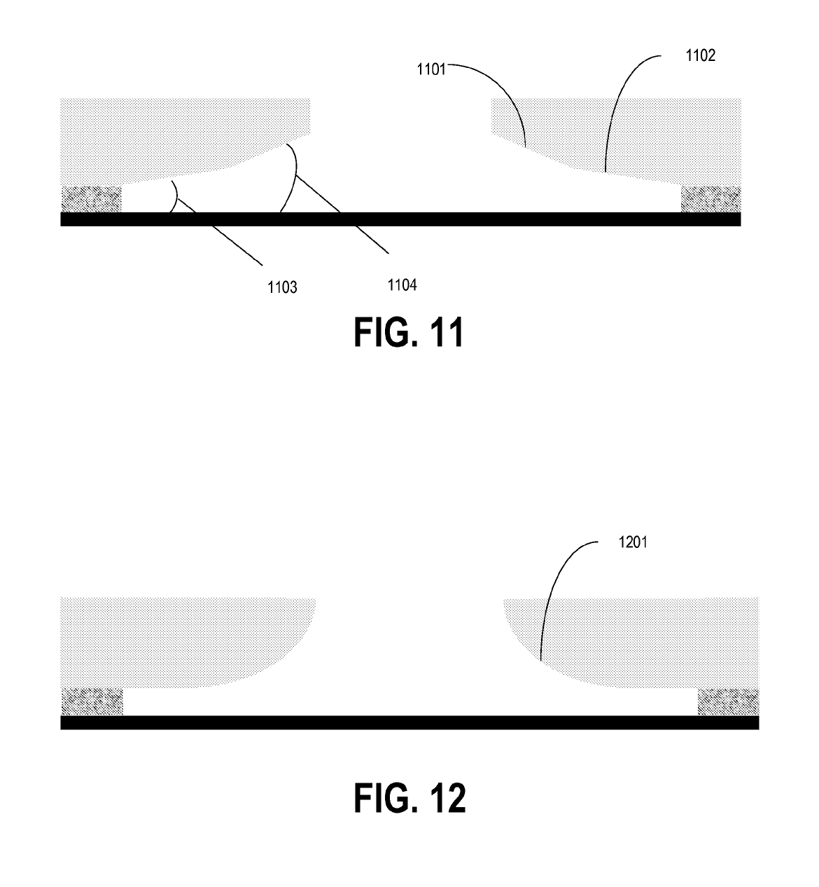

As shown in FIG. 11 an embodiment includes a fixed surface partitioned into two regions, one close to the central axis of the device 1101, the other close to the periphery 1102. These regions are distinct by virtue of having different acute angles with respect to the moving surface. The region at the periphery of the device is set at one acute angle 1103, and the region closer to the center of the device is set at a larger acute angle 1104. For a given electrostatic charge, the force acting between two plates is a function of the angle between them, and is greatest when the plates are perfectly parallel and smallest when they are perpendicular.

For this reason, a higher voltage may be applied to force the moving surface to abut the fixed surface when the acute angle between them is larger. Because the fixed surface contains an abrupt change in angle, a step change in voltage may be applied to make the moving surface transition from abutting the first portion 1101 to abutting the first and the second 1102 portion. Incorporating multiple changes in the acute angle facilitates a multi-state electrostatic actuator where selection of individual states is determined by a corresponding voltage set.

In a further embodiment, linear positional control of the actuator by voltage is possible by making the acute angle between the fixed and moving electrodes follow a curve, like a parabola. FIG. 12 schematically shows an example of a fixed surface 1201 having an acute angle that follows the shape of a simple curve, when viewed in cross-section, according to an embodiment.

It is much easier to manufacture a flat surface than a controlled curve, especially if the curve has complex shape. In a further embodiment the acute angle between the fixed and moving surfaces remains constant or nearly so over the radius of the actuator and linear position control of the moving surface is accomplished by an electronic circuit that controls the electrostatic charge.

As given by the laws of physics, there is an interrelationship between voltage, charge and capacitance. An electrostatic actuator can be energized by a direct current voltage as the primary source of the charge. By modulating the voltage with an alternating component that may include pulse width modulation, the same electrical system can be used to determine the capacitance between the fixed and moving electrodes. By this means the direct current voltage can be adjusted so that there exists controlled charge in the capacitor and hence the force acting between the fixed and moving surfaces can be controlled. Provided the material from which the moving surface is made is elastic, the force will translate directly into an extent of stretch by the moving surface. Hence the exact position of the contact line between the fixed and moving surfaces along the inclined plane formed by having the fixed surface at an acute angle to the moving surface can be repeatedly set.

One possible application of a tri-state electrostatic actuator with acute angle electrodes is as a means for altering the focus of a lens train and thereby permit autofocus of an electronic camera. Aspects of this embodiment will now be described in detail. For simplicity the example will only refer to the actuator in the three rest states. It will be apparent from the preceding teachings that the position of the actuator can, in certain embodiments, be controlled between these extremes.

A fixed focus electronic camera of moderate or higher quality will have more than one lens, typically between two and five, according to an embodiment. As a general rule, the greater the number of lenses the better will be the resulting image quality, although there is usually an associated manufacturing cost and physical size penalty. There exist a number of techniques by which the focus of a lens train and hence a camera can be adjusted. An approach popular among electronic cameras intended for incorporation in portable electronics products is to make the position of the lens furthest from the imager moveable along the optical axis of the system.

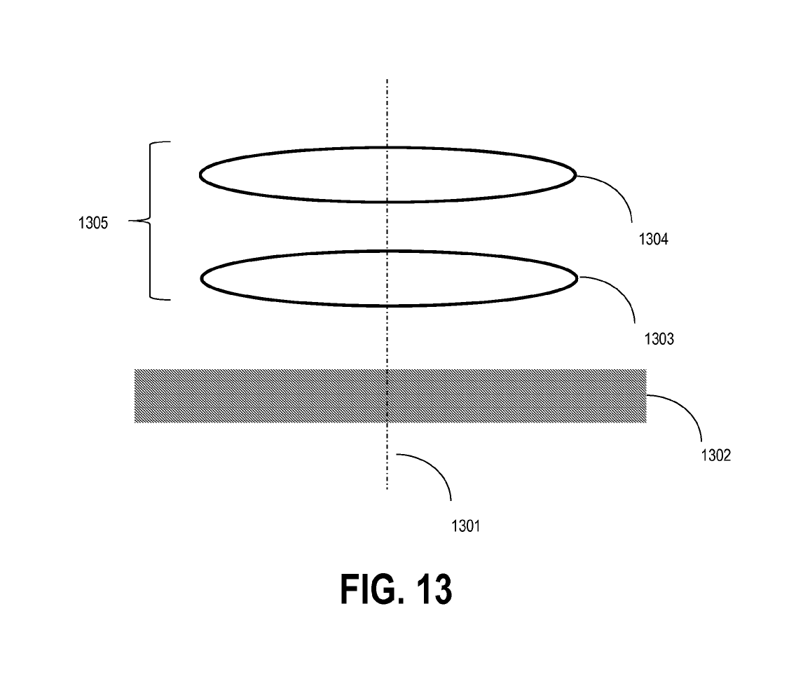

Referring to FIG. 13, 1301 is the optical axis of the camera. The optically sensitive area of the image sensor 1302 is centered on and perpendicular to the optical axis, as are the clear apertures of the second 1303 and first 1304 lenses of the optical train 1305. Only two lenses are shown for clarity. For reasons that are well known and understood, when viewed in plan the optically sensitive area of the image sensor is usually rectangular while the lenses are circular or slightly elliptical. A complete camera module will have many other components not limited to apertures, stops, baffles, shutters, more lenses, etc., but for ease of discussion, the example illustrated schematically in FIG. 13 only includes two lenses 1303 and 1304 and an image sensor 1302.

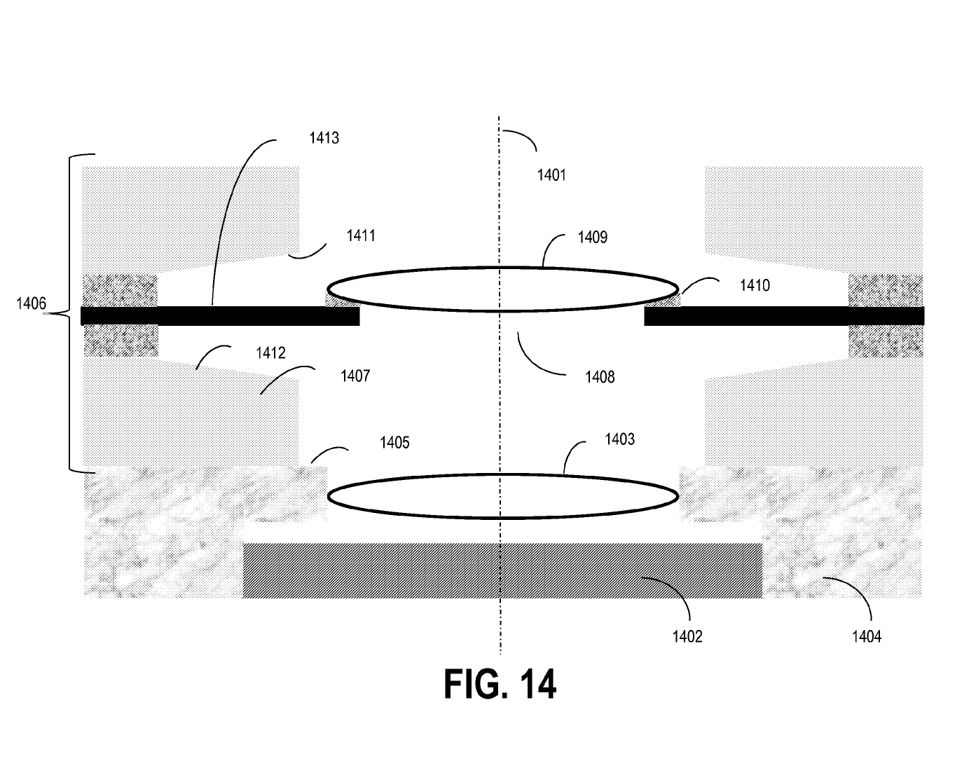

To provide the electronic camera shown in FIG. 13 with adjustable focus, the first lens 1304 can be displaced along the optical axis of the camera. FIG. 14 shows an embodiment by which this may be accomplished using a tri-state electrostatic actuator with acute angle electrodes. Reference numeral 1401 is used to identify the optical axis of the camera, which also includes image sensor 1402 and second lens 1403 that is held in a fixed position relative to the image sensor 1402 by housing 1404. To the upper surface 1405 of the housing is attached the tri-state electrostatic actuator 1406 by the part supporting the second fixed surface 1407. The central portion of the moving part that always remains parallel to the optical axis defines an aperture 1408, e.g., where in one embodiment a portion of material of certain shape and size has been removed from an initially continuous sheet. The first lens 1409 is attached to this aperture in the moving part 1403 by adhesive 1410, or another joining technique. Terminals of a direct current voltage supply (not shown) that develops the electrostatic charge are connected to the first fixed surface 1411, the second fixed surface 1412 and the moving surface 1413. FIG. 13, depicts the moving surface at its neutral position, that is, the first lens is in the mid-position of the focus range.

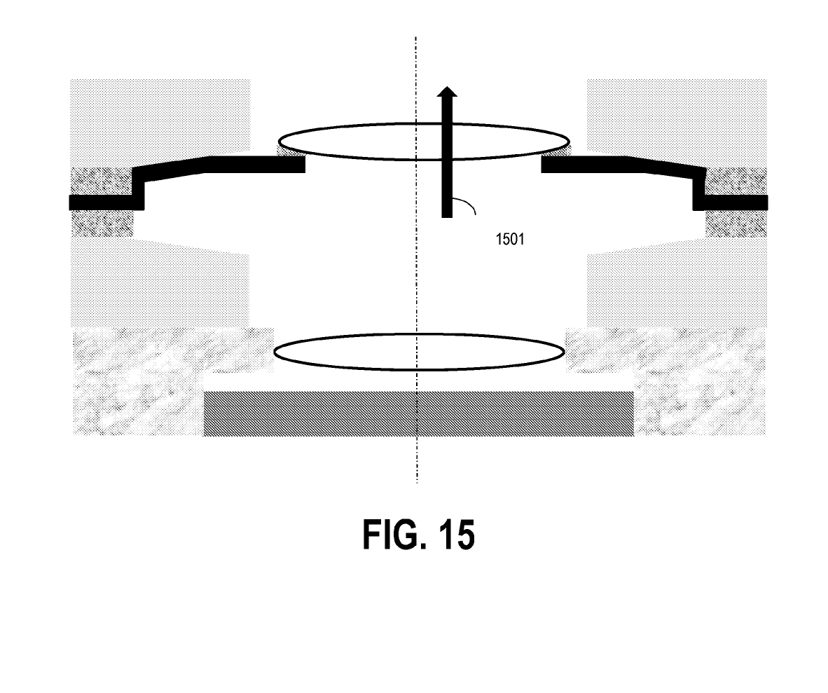

The first lens may be moved to the position of its stroke furthest from the image sensor by applying opposite electrostatic charges to the first fixed surface and the moving surface and/or like electrostatic charges to the moving surface and the second fixed surface. The force from the electrostatic charge will result in the moving surface coming to rest abutting the first fixed surface. The structure then resembles the arrangement shown in FIG. 15. The displacement of the moving part that has occurred is indicated by the arrow 1501. It will be evident by comparing FIG. 14 and FIG. 15 that because the first lens is further displaced from the image sensor by the action of the tri-state electrostatic actuator, the focus of the camera is now on objects that are a greater distance from it.

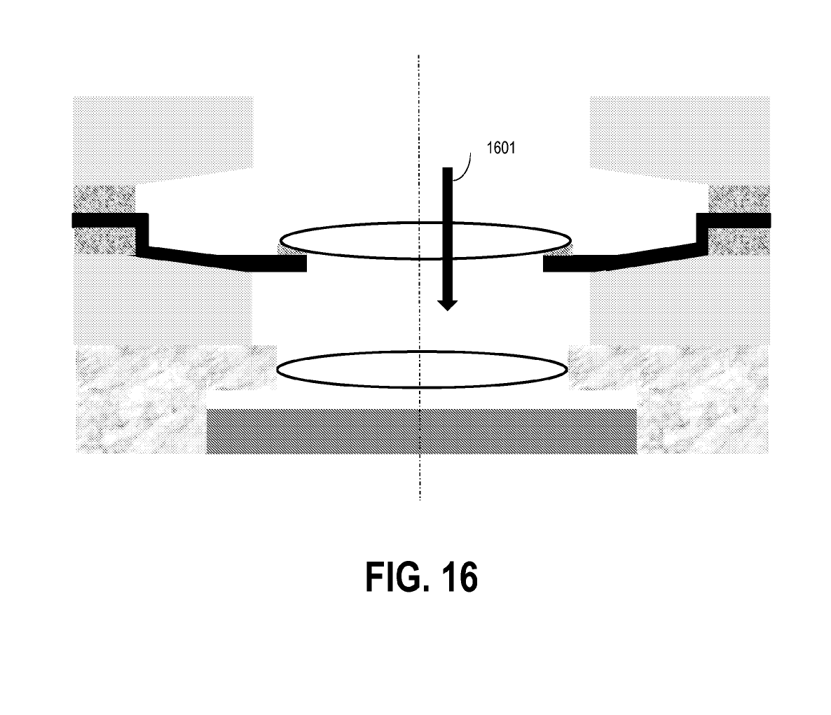

The first lens may also be moved to the closest position of its stroke to the image sensor by applying opposite electrostatic charges to the second fixed surface and the moving surface and/or like electrostatic charges to the moving surface and the first fixed surface. The structure then resembles the arrangement shown in FIG. 16. The displacement of the moving part that has occurred is indicated by the arrow 1601. Because the first lens is rendered closer to the image sensor by the action of the tri-state electrostatic actuator, the focus of the camera is now on objects that are close to it. Thus the tri-state electrostatic actuator with acute angle electrodes provides a means of translation of a lens that utilizes an applied voltage to move the lens and adjust the focus of an optical train in an advantageous auto-focus electronic camera system in accordance with certain embodiments.

A tri-state electrostatic actuator with acute angle electrodes provides a number of technical and economic benefits compared with conventional technology. Firstly, the acute angle between the fixed and moving surfaces that results in concentric lines of contact ensure the travel of the moving surface is along the optical axis of the camera. Typically, if the lens is moved off this line the focus will change over the imager area, resulting in a defective image.

Similarly, the acute angle ensures that the central portion of the moving part, which in this application example is effectively substituted by the first lens, remains perpendicular to the optical axis of the camera throughout the stroke of the actuator. Any tilt of the first lens will result in a variation in focus over the imager area and hence a defective image. Because the electrostatic actuator mechanism includes a moving surface with a thin membrane, it has very low mass.

This makes high speed movement of the lens more practical, rendering it compatible with applications like video capture where the adjustment of focus may be typically faster that the frame rate, which can be 30 or more frames per second. An electrostatic actuator in accordance with certain embodiments is also approximately silent and consumes very little to negligible power, both of which are advantages for portable electronics products.

The moving surface can be a metalized polymer dielectric film, according to an embodiment. This film is selected to be both low modulus and highly elastic. This means that under external mechanical loads it can flex without breaking A common mode of failure of conventional autofocus actuators, including VCMs, is irreparable or catastrophic damage when the portable electronic product is dropped onto a hard surface. Because the tri-state electrostatic actuator is built around an inherently flexible membrane and the lens will often be polymeric for reasons of cost, the structure is well suited to surviving the high g-forces associated with shock loads of the type encountered during accidental drop.

The tri-state electrostatic actuator is also very low profile. The minimum thickness is determined by the combined thickness of the moving surface, the two adhesive dielectricss and the taper of the fixed surfaces on each side of the moving surface. This thickness can be a little as 100 um in certain embodiments, although even a tri-state electrostatic actuator of practical thickness closer to 1 mm is advantageous.

This is substantially lower profile than a VCM. Having a thin actuator decreases the total height of the electronic camera, which is particularly advantageous as this component is often instrumental in determining the minimum thickness of portable electronics products like cellular telephones, where the current fashion is for extreme thinness.

A further advantage of the tri-state electrostatic actuator is that it has very few components and these are all made from readily available and cheaply shaped materials. Consequently the bill of materials and cost of assembly will be low. One of the impediments to wider proliferation of conventional autofocus mechanisms in combination with electronic cameras is the cost of VCMs.

The above-described electrostatic actuator examples in combination with an electronic camera involve movement of the first lens between either two or three positions, such as those at the extremities of the stroke. It is desired to have an autofocus electronic camera that has a minimum a five focus positions. The step in focus resulting from an optical train with bi- or tri-state focus can be remedied by another embodiment that operates in conjunction with opto-algorithmic techniques (e.g. Extended Depth of Field EDoF) to increase depth of focus. Such techniques are well known and understood. Examples can be found in PCT Patent Application Publications WO2008/128772 and WO2009/061519, which are hereby incorporated by reference.

This embodiment has the advantage that the range of movement of the first lens to achieve a same total focus range diminishes from about 250 um to 30 um, which is well with the realm of possibility for a tri-state electrostatic actuator.

Certain types of optical element are sensitive to the angle of rotation of the element relative to the optical axis of the system. For example, a diffractive optic pattern generator can transform the output beam of a laser or light emitting diode into a different beam shape, such as a line or cross. The orientation of the line is referenced to the diffractive optic component such that rotating the diffractive optic in-plane will cause the projected line to rotate through the same angle.

Another application example of the bi- or tri-state electrostatic actuator derives from the possibility of translating the stretch of the moving surface into rotational motion. This was described and illustrated above with particular reference to FIG. 7. By making the moving surface in the form shown in FIG. 7, but with a central aperture and affixing a diffractive optic component over the aperture, it is possible to use the electrostatic actuator to translate between applied voltage and, say, the angle of rotation of a projected beam.

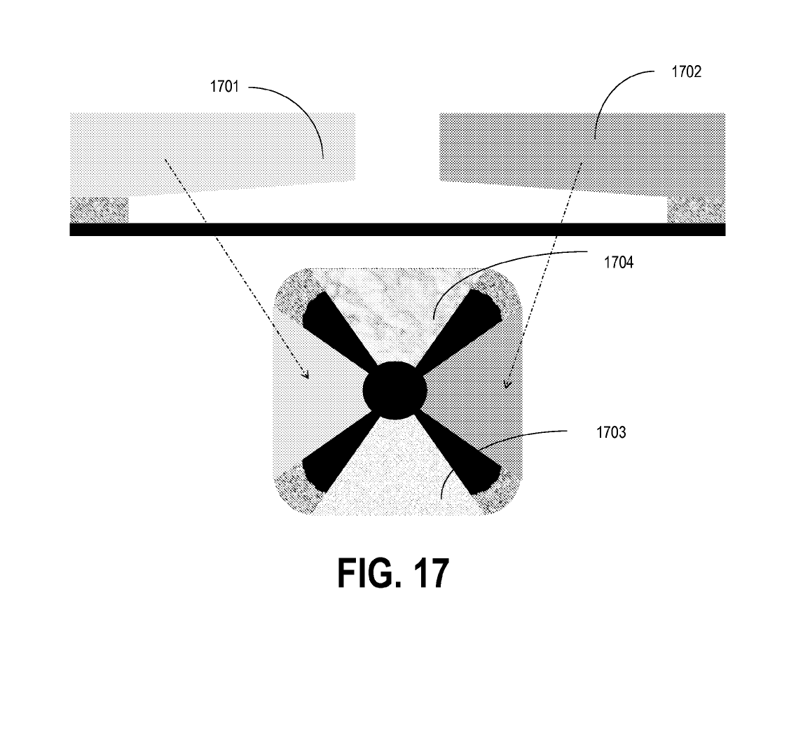

Yet another embodiment of the electrostatic actuator facilitates another application example. In the above description of the electrostatic actuator, the fixed surface can be a radially symmetric and unitary component. However, the fixed surface can be any shape and comprise multiple parts. For example, FIG. 17 illustrates in plan and section views a fixed part of a bi-state electrostatic actuator having acute angle electrodes that is ostensibly square and divided into four quadrants, 1701-4, each of which can be separately charged relative to the moving surface. For clarity only two of the quadrant electrodes 1701 and 1702 are shown in the section view.

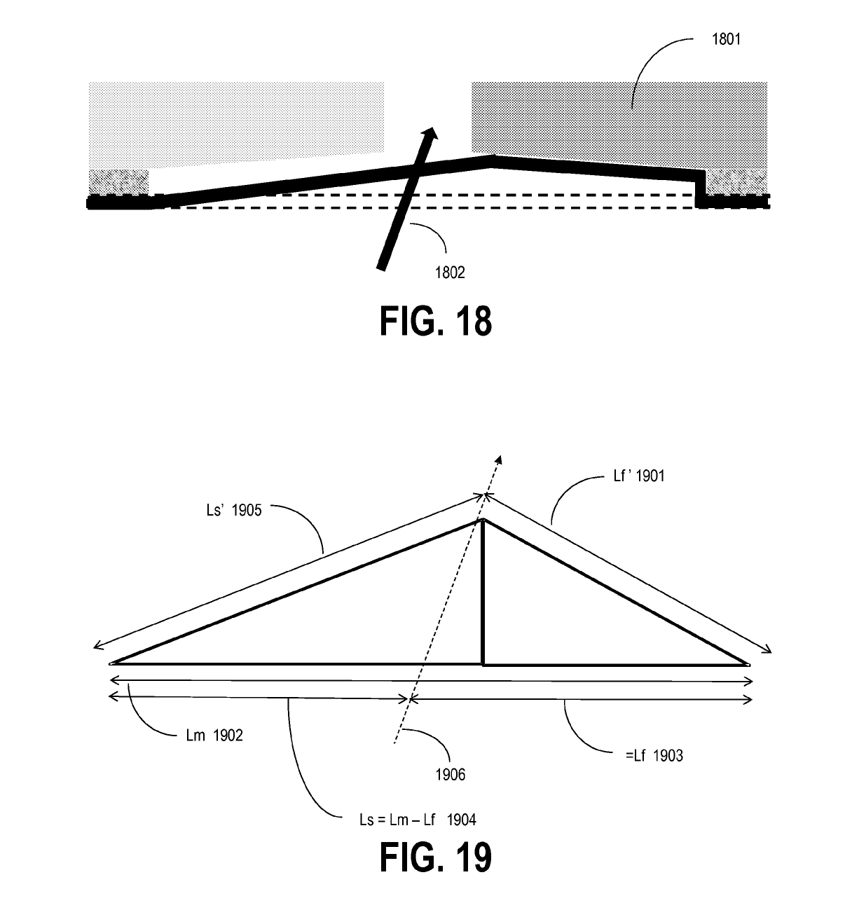

Consider the case illustrated in FIG. 18 where only one of the four electrodes 1801 is charged by application of a voltage, so that the moving surface abuts only that fixed surface. Because the acute angle of the electrodes can be small, such as between 1 and 2 degrees, the tilt of the moving surface will be small or even negligible because, owing to the geometric relationship it must always be less than the acute angle. As will be described the relative motion of the moving surface is indicated by the arrow 1802.

As was discussed above with reference to FIG. 4, the moving part of these described embodiments increases in area to permit actuation of the device. In FIG. 19, the geometry of FIG. 4 is redrawn for the case where only one quadrant of a split fixed part of electrostatic actuator is charged. The contact line between the moving surface and the fixed surface will move towards the center or up the fixed surface, which has a length Lf′, 1901. The moving surface is originally of length Lm 1902 equals Ls (1902)+Lf (1903). Where the moving surface abuts the fixed surface it will be held by stiction and be unable to stretch. Therefore the portion of the moving surface available to stretch is Ls 1904, where Ls=Lm−Lf. Ls will stretch to Ls′ 1905. Because Ls′ 1905 is larger than Ls, the effective central position of Lm will move from left to right and slightly upwards, as indicated by the dotted line 1906. It will be apparent that the stretch of the moving surface occurs asymmetrically such that actuation causes lateral and slight vertical motion.

When capturing photographs or taking video clips using an electronic hand held camera, a common problem is camera shake, which results in blurring of the image. Camera shake can be compensated for to a certain extent moving laterally one lens in the optical train. An electrostatic actuator having acute angle and split fixed electrodes and containing a central aperture with a lens attached to the moving surface of the actuator can provide an advantageous component in an optical image stabilization mechanism.

These examples serve only to illustrate examples of possible applications for the electrostatic actuator described and should not be interpreted as a limit on the scope or circumstance or the appended claims. As one skilled in the art will appreciate there exist many other instances where physical movement of electrical, optical, magnetic and mechanical components joined or connected to the moving surface of an electrostatic actuator with acute angle electrodes can be usefully exploited.

### METHOD OF FABRICATION

A means of fabricating an autofocus lens utilizing an electro static actuator with acute angle electrodes will be described, according to an embodiment. This example is merely an overview and refers to one particular sequence of process steps. A wide variety of other processes, conducted in a different sequence to that described could be used to arrive at a similar final structure. The choice will be influenced by many factors, key amongst which are the function of the device and the economics of the market where the device is employed.

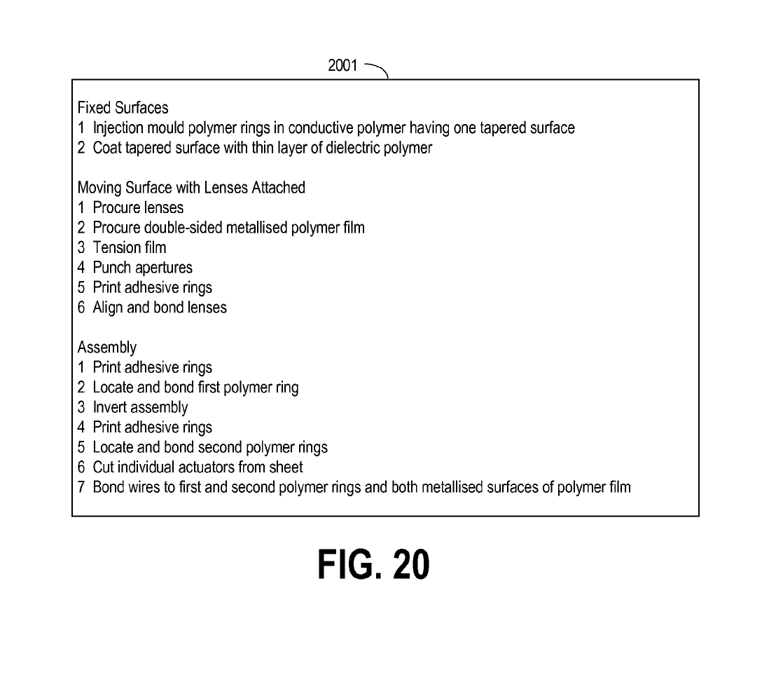

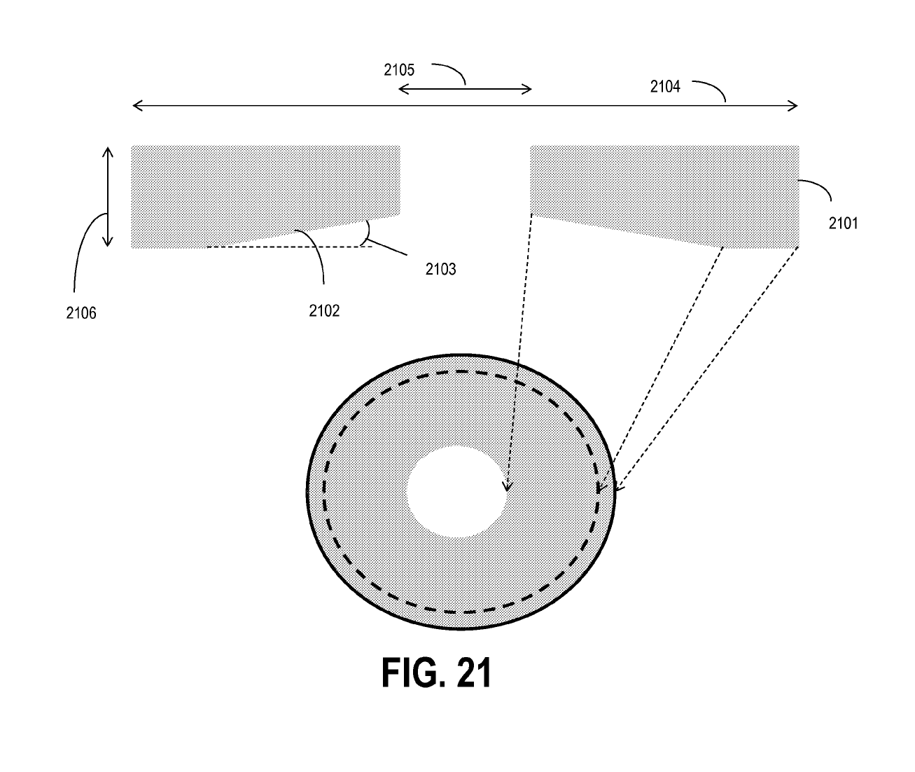

FIG. 20 indicates a series of steps 2001 that could be used to produce the tri-state electrostatic actuator device of FIG. 14, incorporating a moving lens over a central aperture. FIGS. 21-23 illustrate certain steps in additional detail.

One step in the process is procurement of the fixed surface parts. As shown in FIG. 21, these may include rings 2101 where the so-called fixed electrode surface 2102 can be set at an angle between 1 and 2 degrees 2103. The rings can be made by injection molding of a conductive liquid crystal polymer. To be compatible with a miniature electronic camera, typically the rings will have an exterior diameter 2104 of 6 mm and an interior diameter 2105 of 2.5 mm and a thickness 2106 of 0.4 mm. The fixed surface may be coated with a very thin layer of dielectric material (not shown) to provide electrical insulation when it is abutted by the moving surface of the actuator. Two rings may be used for each tri-state electrostatic actuator in accordance with certain embodiments.

Another step in the manufacturing process is preparation of the moving surface part. This involves procuring a thin polymer film that is metalized on both sides. Suitable films are widely used as components of food and beverage containers. The moving surface part also includes a lens selected as appropriate for the electronic camera with which the tri-state electrostatic actuator will be used. To allow for fluctuation in the operating temperature of an electronic camera, the film may be pre-tensioned so that thermal expansion by the material of the moving part does not cause the flexible surface to become slack or wrinkled at elevated temperature.

The tension may be maintained through the manufacturing process by means of a peripheral handling frame to which the film may be bonded.

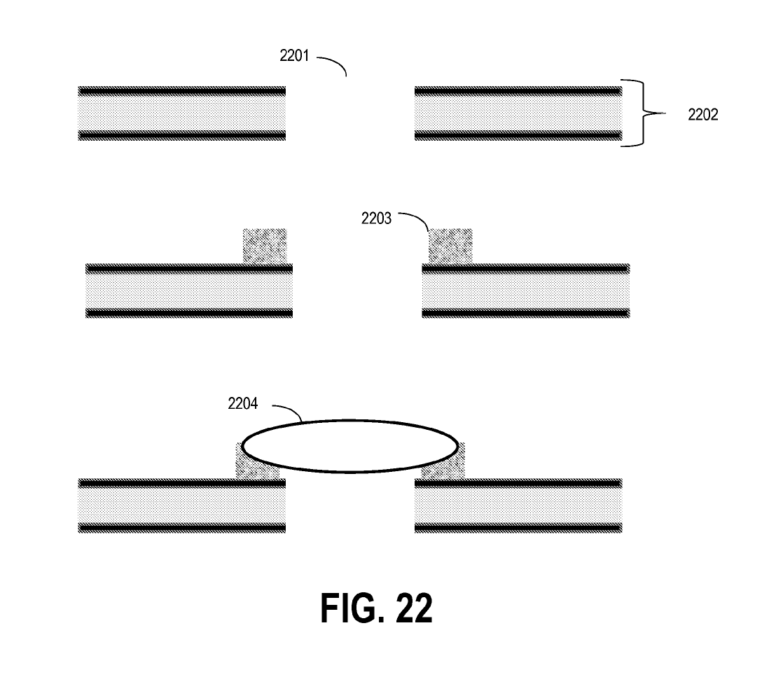

As shown in FIG. 22, apertures 2201 are formed in the metalized moving part film 2202. Suitable techniques include punching and laser shaping among others. The apertures in certain embodiments may be around 2.2 mm, which is slightly smaller in diameter than the lens diameter, which for a miniature electronic camera can typically be about 2.4 mm, A lens of this size will have a clear aperture, or useable diameter of about 2.0 mm.

A ring of adhesive 2203 can be placed around the aperture and a lens 2204 aligned and adhered in place. Many different types of adhesive are suitable. The choice can be made on the basis of compatibility with the surfaces to be joined and the subsequent mechanical and environmental regimes to which the joint will be subjected.

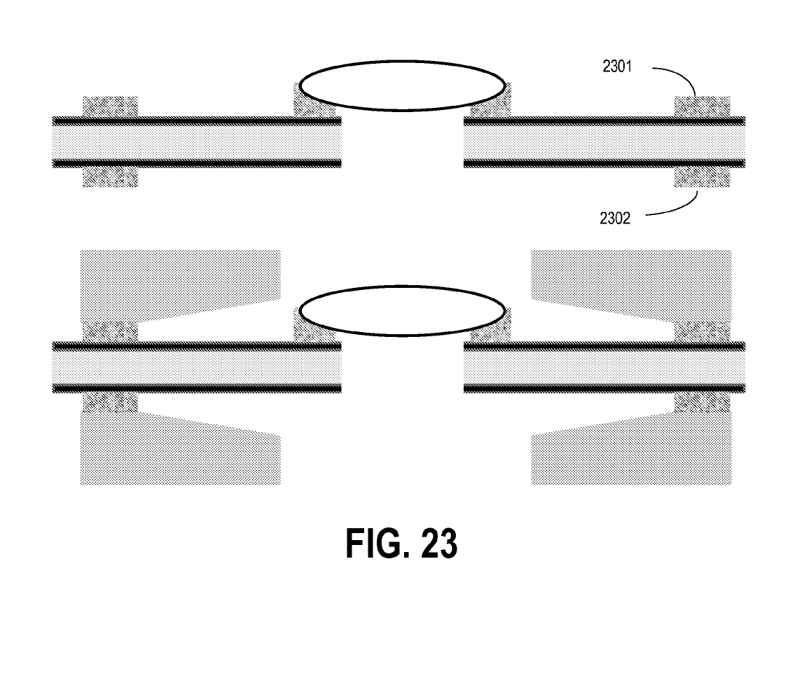

Another step of manufacture can be assembly of the complete tri-state electrostatic actuator. As depicted in FIG. 23 this involves in certain embodiments two cycles of applying rings of adhesive 2301 and 2302 to the moving surface film carrying the lens and then aligning and attaching the fixed surface rings that also form the housing of the actuator. The surplus moving surface film protruding beyond the exterior of the fixed surface rings can then be trimmed off, if desired, and wires bonded at appropriate locations to provide connection to electrically active areas of the actuator.

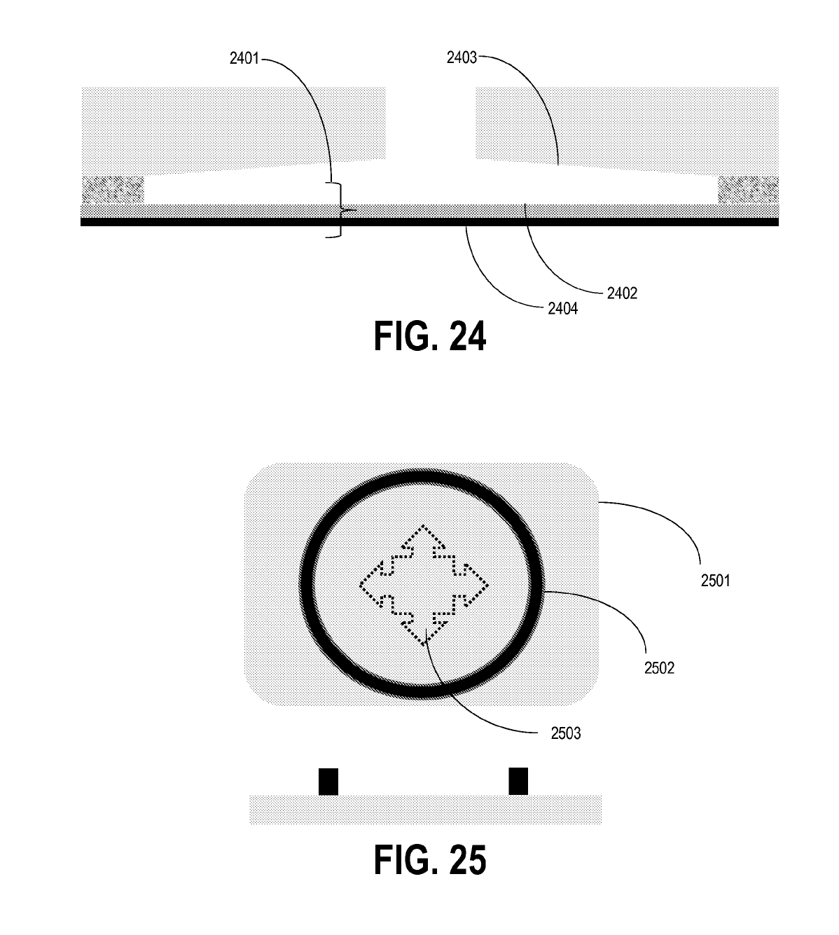

An embodiment of the method involves, for reasons of cost for example, to omit the dielectric coating applied to the fixed surface of the rings that support the acute angle. The moving part is then replaced by polymer film, metalized on one side. Suitable films are widely used as a starting material for manufacturing flexible substrates in the electronics industry. With reference to FIG. 24, in a bi-state actuator this material 2401 can be used as supplied provided it is fixed with the dielectric surface 2402 facing towards the fixed surface 2403 and the metalized surface 2404 faces away from the fixed surface, so that when the fixed and moving surfaces abut, an electrical short does not occur.

In a tri-state actuator in accordance with certain embodiments, a dielectric film is applied over the metallization of the thin polymer film, so the metallization is electrically isolated on both sides.

In another embodiment of the method of manufacture (see FIG. 25), tensioning of the moving surface film 2501 is accomplished by attaching to it an expansion ring 2502 made of a material having high coefficient of thermal expansion. Heating of the sub-assembly to a controlled temperature will cause the perimeter of the ring to expand so it covers a larger area.

Because the material of the moving surface is fixed to the ring it will also expand in area i.e. by radially stretching 2503. Provided the material of the expansion ring and dimensions are chosen judiciously, elevated temperature can be used to induce controlled and uniform tension in the material of the moving surface.

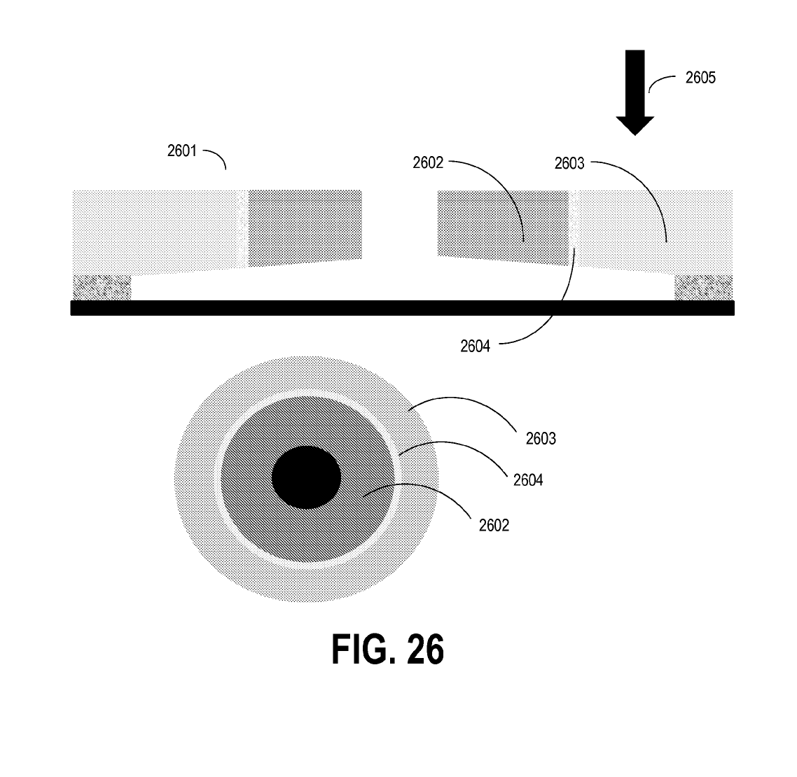

In yet another embodiment, the fixed surface is divided into multiple regions. With reference to FIG. 26, the fixed surface 2601 is made of a conductive material but divided into two concentric regions 2602 and 2603 by an electrical insulator 2604. The plan view of the section drawing is seen from the viewing direction denoted by the arrow 2605.

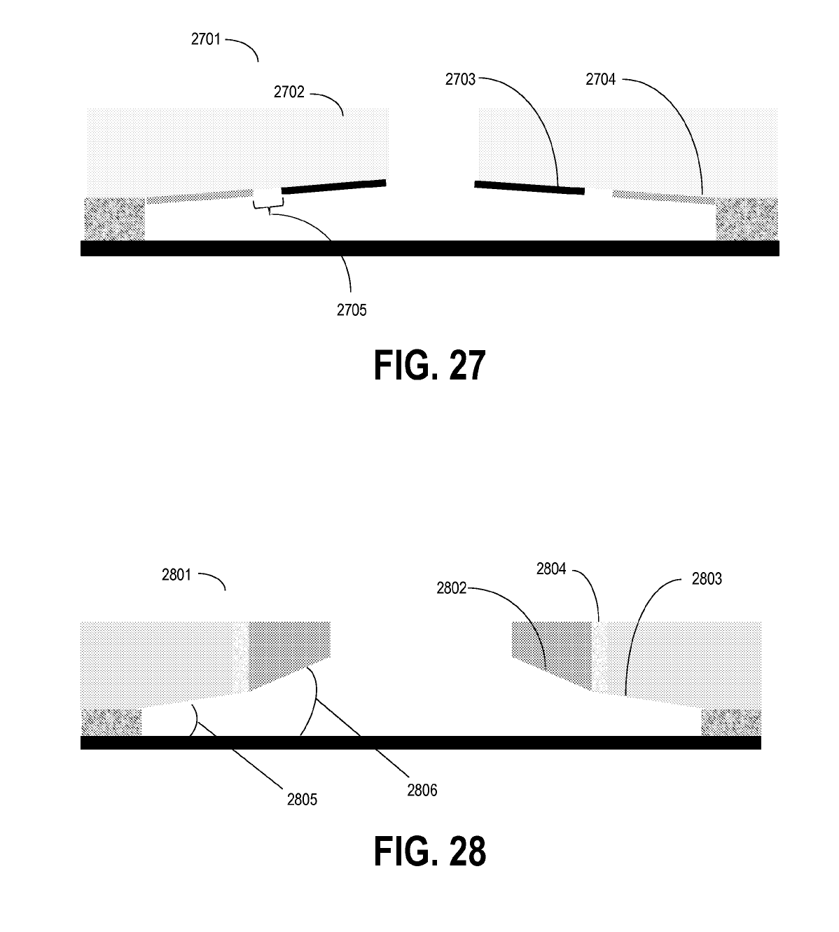

Alternatively, as shown in FIG. 27, another functionally advantageous structure may be achieved by making the fixed surface 2701 out of a dielectric material 2702 and applying conductive material to the fixed surface so as to form two concentric electrodes 2703 and 2704 that are separated by a short distance 2705. The short distance could be filled with a solid or preferably gaseous dielectric, such as air. Although FIG. 26 and FIG. 27 depict only two electrodes, it will be apparent that the fixed surface could be divided into any number of smaller areas each of which could be separately charged as an electrode in an electrostatic actuator. The regions can be symmetric or asymmetric in radius and/or in area. The use of such regions can facilitate movement of a moving electrode of the actuator (and thus movement of a lens, for example) to a greater number of different portions. The regions can be generally concentric areas in certain embodiments. In other embodiments, the regions can be non-concentric regions. For example, the regions can be wedge shaped, like pie slices. The regions can be a combination of different shapes. For example, one or more concentric circular regions can be subdivided into somewhat wedge shaped areas, similar to the sectors of a computer's hard disk drive.

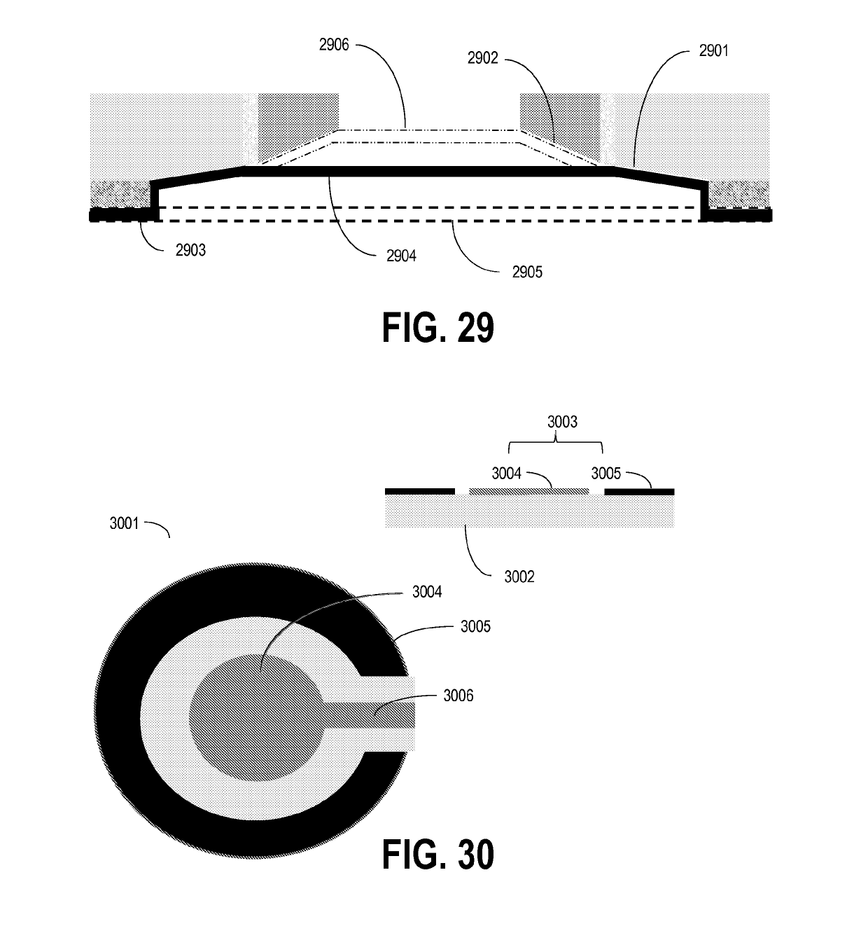

FIG. 28 schematically illustrates a further embodiment where the fixed surface 2801 is divided into two radially symmetric electrodes 2802 and 2803, separated by a dielectric 2804, where each electrode is set at a different acute angle (similar to the actuator of FIG. 11). In some embodiments, the outermost electrode 2803 is set at a small acute angle 2805 and the more central electrode 2802 is set at a slightly greater acute angle 2806. Although the structure schematically illustrated in FIG. 28 has great similarity with that shown in FIG. 11, it may be operated in a different manner. Sub-division of the fixed surface in the manner illustrated in FIG. 28 provides for sub-division in the range of actuation of the moving surface by application of independent electrostatic charges to each electrode. As illustrated in FIG. 29, there exists a stable intermediate position of the moving surface, where the first portion 2901 of the fixed surface electrode is charged, but not the second portion 2902. Consequently, the moving surface of the electrostatic actuator 2903 resides at an intermediate position 2904, between the lower 2905 and upper 2906 extremes of its stroke. To achieve the upper stroke position requires charging of both electrodes 2901 and 2902. To achieve the rest position 2905, in certain embodiments, neither electrode is charged (both electrodes remain uncharged). Thus, if configured in a double-sided structure of the type shown in FIG. 8, for example, the device is effectively a penta-step electrostatic actuator. Utilizing the ability to apply independent positive or negative charge to each of the four electrodes in a double sided device of the type shown in FIG. 28 will achieve nine stable states. Different desired numbers of electrodes can result in different desired numbers of states.

In the preceding descriptions, the moving surface has been taken to be homogenous with regard to its ability to support electrostatic charge on its surface. Certain embodiments have been described wherein the fixed surface of the electrostatic actuator is sub-divided into regions that are subject to independent charge. In further embodiments, the moving surface is likewise sub-divided. Where the moving part includes a dielectric material in combination with a conductive film, the conductive film may be patterned so it is present in some areas and absent in others.

FIG. 30 shows plan view 3001 and sectional view 3002 of a conductive material 3003. The conductive material has been patterned into two concentric regions, 3004 and 3005. The outermost region 3005 is incomplete in its circumference since the conductive film also has to provide an electrical pathway 3006 between the innermost conductive region and the periphery of the device to facilitate its charging by an electrical circuit. Other configurations are contemplated where conducting regions 3004 and 3005 are at opposite sides of 3002, enabling electrical connection to both of them while keeping ring 3005 complete.

The fixed electrode and/or the moving electrode can be segmented such that each segment is independently chargeable with respect to each other segment. Such segments can facilitate movement, e.g., translation and/or rotation, of the lens to a greater number of different positions and/or orientations, respectively. For example, symmetric charging of the segments can result in translation of the lens along its optical axis, wherein such translation can be used for focusing or zooming. As a further example, asymmetric charging of the segments can result in rotation of the lens about an axis that is generally in the plane of the lens (an axis other than the optical axis), wherein such translation can be used for alignment of the lens and/or optical image stabilization.

Although a lens is used herein as an example of an object that can be moved by the electrostatic actuator, such is by way of example and not by way of limitation. Any desired optic or other object can be moved by the actuator. For example, a filter, a mirror, a diffraction grating, or any other item can be moved by the actuator.

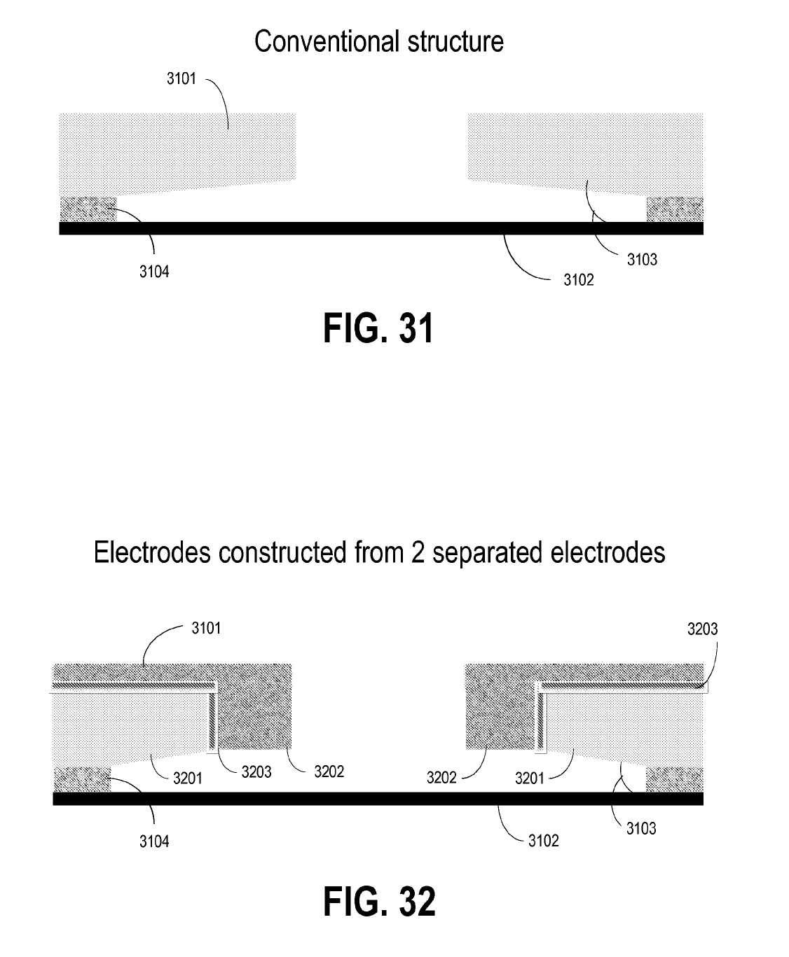

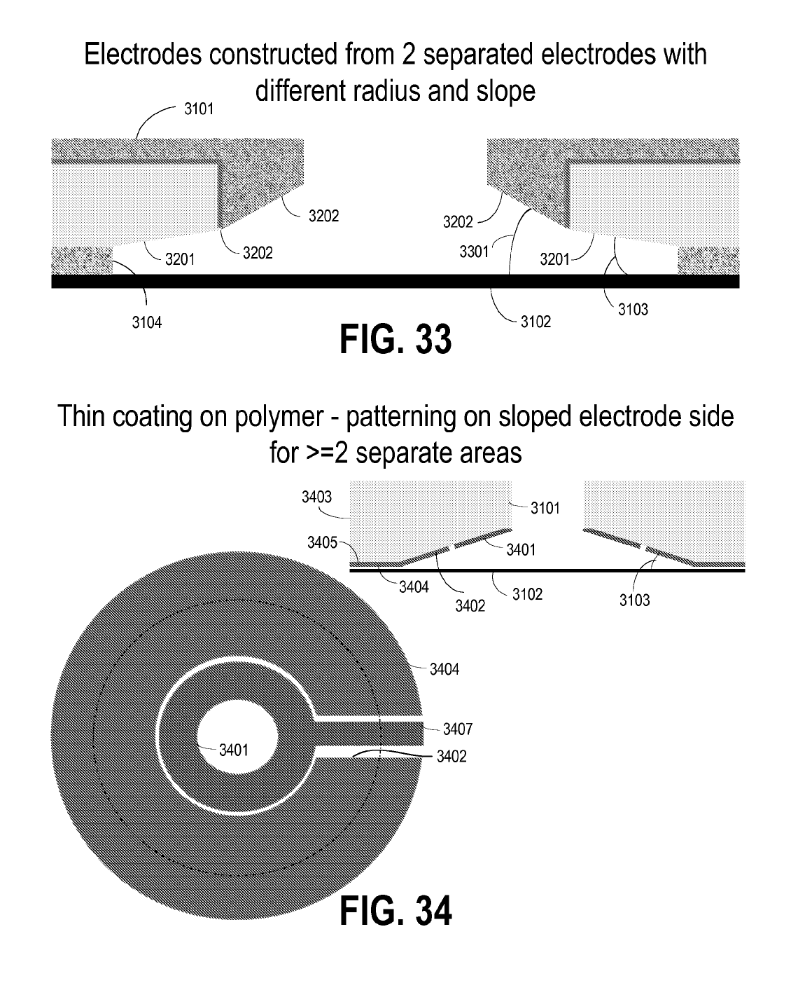

FIG. 31 is a cross-section of a radially symmetric electrostatic actuator 3100, taken through its diameter, that has a fixed surface 3101 and a juxtaposed moving surface 3102 subtended by an acute angle 3103, according to an embodiment. A dielectric 3104 separates the fixed surface 3101 from the moving surface 3102. The fixed surface 3101 can be modified to provide the electrostatic actuator of FIG. 32 or the electrostatic actuator of FIG. 33, as discussed herein.

FIG. 32 is a cross-section of a radially symmetric electrostatic actuator 3200, taken through its diameter, that has a fixed surface 3101 and a juxtaposed moving surface 3102 subtended by an acute angle 3103, and that further has two separate fixed surface electrodes 3201 and 3202, according to an embodiment. The electrodes 3201 and 3202 can be formed, for example, by removing material from the fixed surface 3101 shown in FIG. 31 so as to define the electrode 3201, then adding a dielectric 3203 to the electrode 3201, and then adding the electrode 3202.

FIG. 33 is a cross-section of a radially symmetric electrostatic actuator 3300, taken through its diameter, that has a fixed surface 3101 and a juxtaposed moving surface 3102 subtended at least partially by the acute angle 3103, according to an embodiment. The electrostatic actuator 3300 further has two separate fixed surface electrodes 3201 and 3202, where the fixed surface 3101 has a second acute angle 3301, according to an embodiment. The first fixed surface electrode 3201 is formed at the first acute angle 3103 and the second fixed surface electrode 3202 is formed at the second acute angle 3301. Thus, according to this embodiment there are two fixed electrodes 3201 and 3202 formed at two different acute angles 3103 and 3301 with respect to the moving surface 3102.

The acute angle 3301 can be formed by modifying the electrostatic actuator 3200 of FIG. 32. For example, material can be removed from the electrode 3202 of FIG. 32 to define the acute angle 3301.

FIG. 34 is a cross-section and plan view of a radially symmetric electrostatic actuator 3400, having a juxtaposed moving surface 3102 subtended by an acute angle 3103, that further has two separate fixed surface electrodes 3401 and 3402 formed from a thin conductive film or coating formed upon the lower surface 3405 of a polymer 3403 that at least partially defines the fixed surface 3101, according to an embodiment.

The thin conductive film can be patterned as shown in FIG. 34 so as to provide a current path to the inner fixed surface electrode 3401, such as via trace 3407. The thin conductive film can have a periphery 3404 that is configured to provide a current path to the outer fixed surface electrode 3402. In this manner, two or more fixed surface electrodes can be formed and provided electrical connectivity.

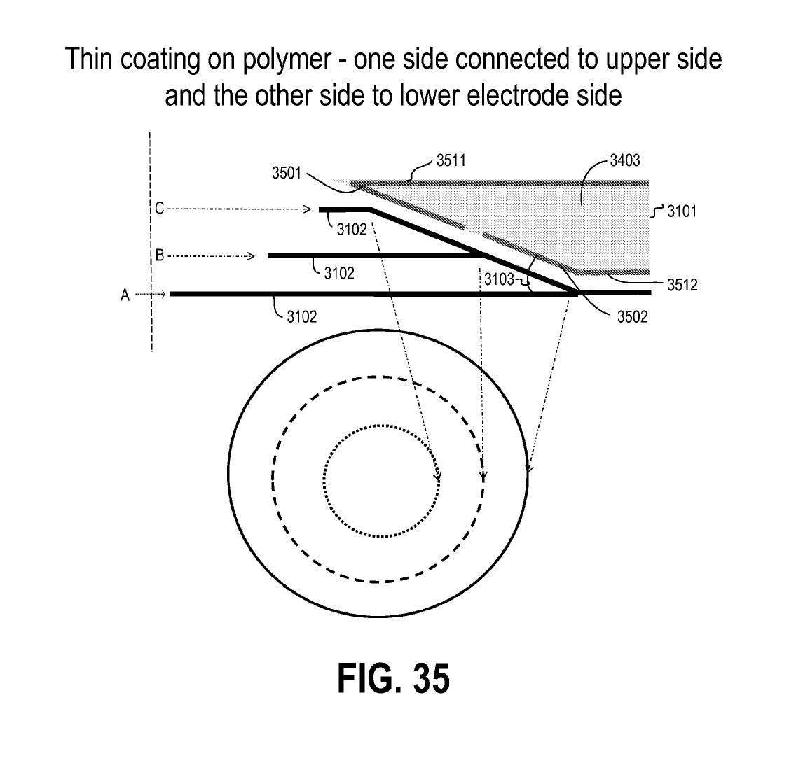

FIG. 35 is a cross-section and plan view of a radially symmetric electrostatic actuator 3500, having a juxtaposed moving surface 3102 subtended by an acute angle 3103, that further has two separate fixed surface electrodes 3501 and 3502 formed from a thin coating on a polymer 3403 with one electrode 3501 connected to one side (the top) of the fixed surface 3101 and the other electrode 3502 connected to the other side (the bottom) of the fixed surface 3101, according to an embodiment.

Electrode 3501 is connected to thin film 3511 formed upon the top of the fixed surface 3101. Electrode 3502 is connected to thin film 3512 formed upon the bottom of the fixed surface 3101. Thin films 3511 and 3512 provide current paths to the two electrodes 3501 and 3502, respectively.

The movable surface 3102 is shown in FIG. 35 in each of three different positions. Position A shows the movable surface 3102 with no voltage applied to either electrode 3501 and 3502. Position B shows the movable surface 3102 with an attractive voltage applied to electrode 3502 and no voltage applied to electrode 3501. Position C shows the movable surface 3102 with an attractive voltage applied to electrode 3501 and an attractive voltage applied to electrode 3502.

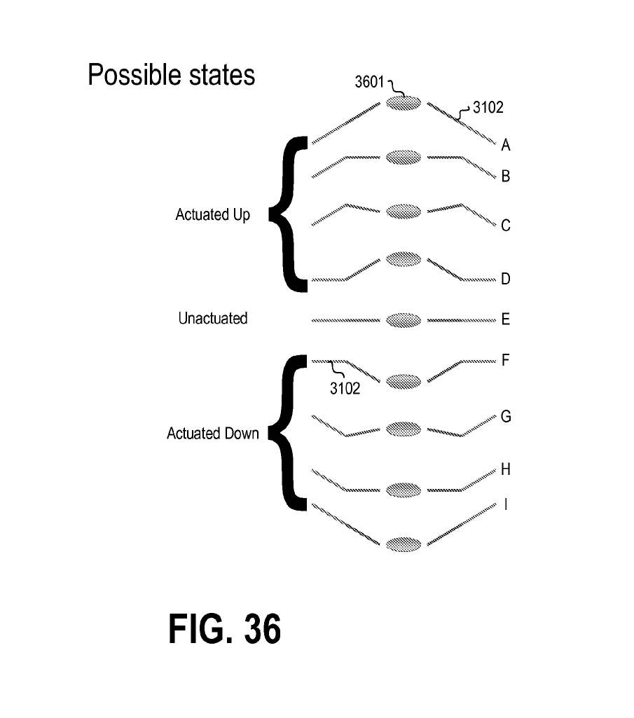

FIG. 36 is a schematic diagram showing nine possible states of an electrostatic actuator, such as the electrostatic actuator 3500 of FIG. 35, having a fixed surface 3101, which may in certain embodiments include a single fixed surface 3101, and having two separate fixed surface electrodes 3501 and 3502, according to an embodiment. The same nine possible states can apply to an electrostatic actuator having two fixed surfaces (an upper fixed surface and a lower fixed surface, similar to the bottom electrostatic actuator of FIG. 23). The movable surface 3102 can be attached to and move a lens 3601, for example. The moveable surface 3102 can move any other desired item.

Position E is unactuated (no voltage applied to either electrode). Positions A-D are actuated in the upward direction, wherein the movable surface 3102 moves upwardly toward the fixed surface 3101. Positions F-I are actuated in the downward direction, wherein the movable surface 3102 moves downwardly away from the fixed surface 3101 and optionally toward a similar fixed surface (not shown) below the fixed surface 3101, such as for a double sided electrostatic actuator similar to that shown in the bottom of FIG. 23. Movement in the upward direction can be effected by applying a voltage to one or both of the upper electrodes 3501 and 3502 in a manner that attracts the movable surface 3102. Movement in the downward direction can be effected by applying a voltage to one or both of the lower (mirror) electrodes 3501 and 3502 in a manner that attracts the movable surface 3102.

Position D can be achieved by applying a voltage to electrode 3501 of the upper electrode and applying no voltage to electrodes 3502. Position C can be achieved by applying a voltage to upper electrode 3502 and applying a voltage to lower electrode 3501. Position B can be achieved by applying a voltage to upper electrode 3502 and applying no voltage to electrodes 3501.

Position A can be achieved by applying a voltage to upper electrodes 3501 and 3502. Positions F-I can be achieved by applying the same voltages discussed in connection with positions A-D, by switching between the upper and lower electrodes used to obtain positions A-D.

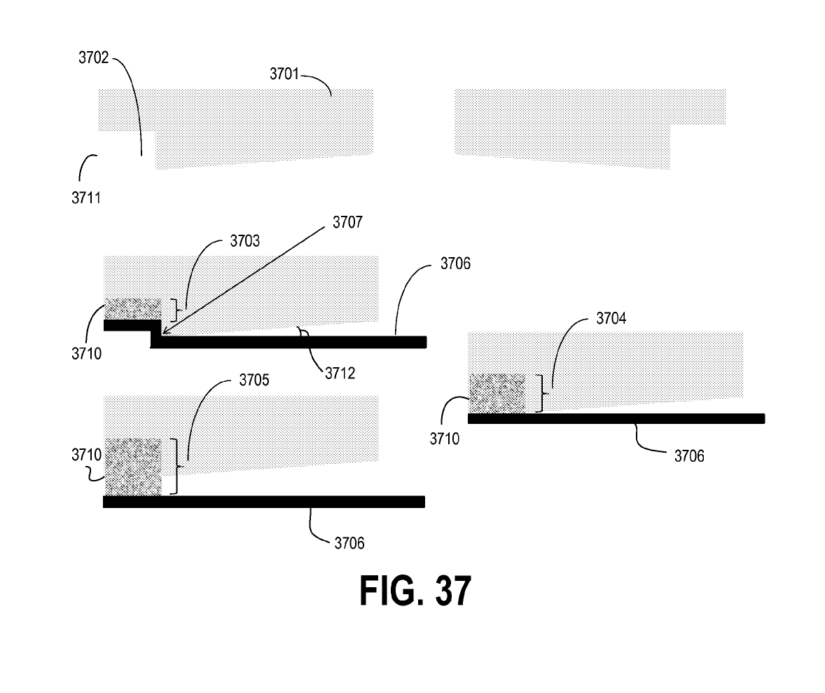

FIG. 37 schematically illustrates examples of the fixed surface of a tri-state electrostatic actuator having a recess 3702 at its periphery with the moving surface 3706 attached to the fixed surface 3701 by a dielectric material 3710 that can be thinner (see 3703), approximately the same thickness as (see 3704), or thicker, e.g., taller (see 3705), than a depth 3711 of the recess, according to an embodiment. The dielectric material 3710 can separate the fixed surface 3701 from the moving surfaces 3706 and can be disposed at least partially within the body of the fixed surface 3701.

The dielectric material 3710 can be completely within the recess 3702 or can extend substantially from the recess 3702. The dielectric material 3710 can be either an adhesive or can be used in combination with one or more layers of adhesive to join the moving surface 3706 to the fixed surface 3701 at the periphery of the fixed surface 3701.

Each different thickness of the dielectric material 3710 can have particular benefits and limitations. The desired thickness may depend on other details of the structure and/or the application of the tri-state electrostatic actuator. For example, if the dielectric material 3710 is thinner than the recess (see 3703), then the material of the moving surface 3706 can be stretched over a corner 3707 that is formed where the fixed surface 3701 transitions between the recess 3702 and an acute angle 3712. This corner 3707 can help to set a tension in the material of the moving surface 3706 and can help to ensure that physical contact between the moving surface 3706 and fixed surface 3701 originates from one known location proximate a circumference of the actuator, e.g. proximate a circumference of the moving surface 3706 and/or the fixed surface 3701.

As a further example, if the dielectric material 3710 is approximately the same thickness as the recess (see 3704), the electrostatic charge involved in the actuation will tend to be reduced. As yet a further example, if the dielectric material N10 is substantially thicker than the recess (see 3705), then the total possible displacement of the moving surface N06 will tend to be increased.

Joining the fixed surface 3701, the moving surface 3706, and the dielectric material 3710 can be accomplished by a variety of different techniques. For example, such joining can be accomplished via adhesive bonding, thermo-compression bonding, spot welding, ultrasonic welding, and/or mechanical interlocking

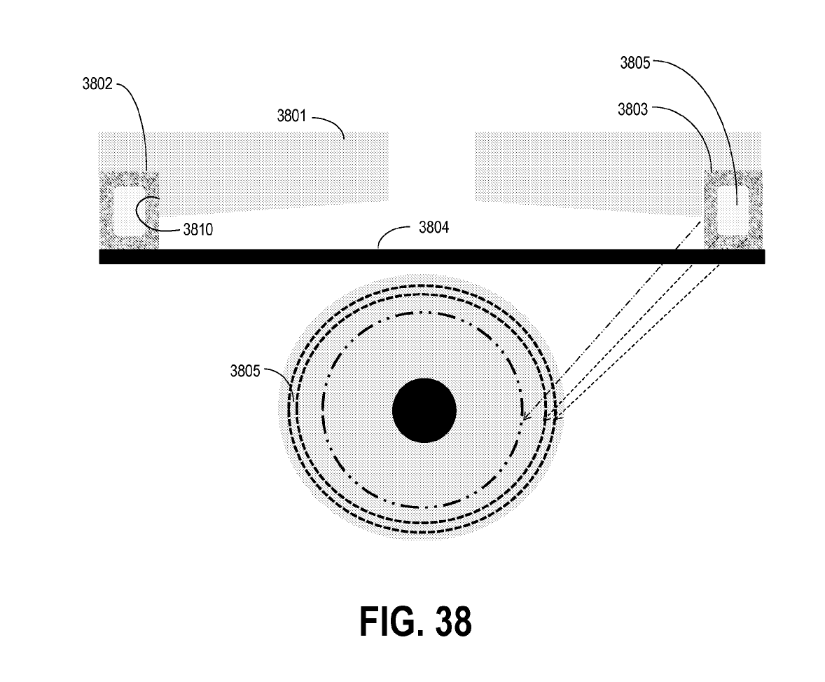

FIG. 38 provides section and plan views of a tri-state electrostatic actuator having a peripheral recess 3810 in a fixed surface 3801 that is partly filled by a ring 3803 embedded in the material, e.g., adhesive, that joins the moving surface 3804 to the fixed surface 3801, according to an embodiment. Thus, the dielectric material that separates the moving surface 3804 from the fixed surface 3801 may optionally include a solid structure, such as the ring 3803.

The recess 3810 can be filled substantially by the ring 3803. The ring 3803 can be attached to both the moving surface 3804 and the recess 3810 by an adhesive 3805. The ring 3810 can have openings formed therein such that the adhesive 3805 within the ring 3803 can bond the ring 3803 to the moving surface 3804 and the recess 3810 of the fixed surface 3801 through the openings. That is, adhesive inside the ring 3803 can contact the moving surface 3804 and the recess 3810. Alternatively, the adhesive 3805 can simply be applied to the exterior of the ring 3803 to effect such bonding.

The ring 3803 can be made of a dielectric material and/or a conductor. If the ring 3803 is made of a conductor, then at least one dielectric layer can be formed between the fixed surface 3801 and the moving surface 3804 to prevent shorting therebetween.

The ring 3803 can have the function of holding the material of the moving surface 3805 at a controlled tension when the tri-state electrostatic actuator is in a position of rest, i.e. with no charge applied. Placing the material of the moving surface 3805 in tension in certain embodiments eases manufacture of the component by preventing the material of the moving surface 3804 from curling or wrinkling as it is being manipulated. Although drawn as circular in the plan view in FIG. 38, the ring 3803 can take a variety of alternative geometries, examples including, but not being limited to, square, triangular and spiral.

As has been disclosed, the moving surface 3804 of the electrostatic actuator can carry an optical component. The example described above was a lens, but could be another type of optical component, the choice not being limited to mirrors, prisms, apertures and diffractive optical elements. Some of these optical elements may be included in embodiments wherein the moving surface contains an aperture so that the light can pass through the optical element unimpeded by the materials from which the moving surface is made. Forming an aperture in the material of the moving surface decreases its strength and increases the risk of failure through mechanisms such as tearing, particularly if the aperture has a acute angle features, for example like a star shape. Thus, a further embodiment involves surrounding an aperture in the moving surface with a structure that has no acute angle features.

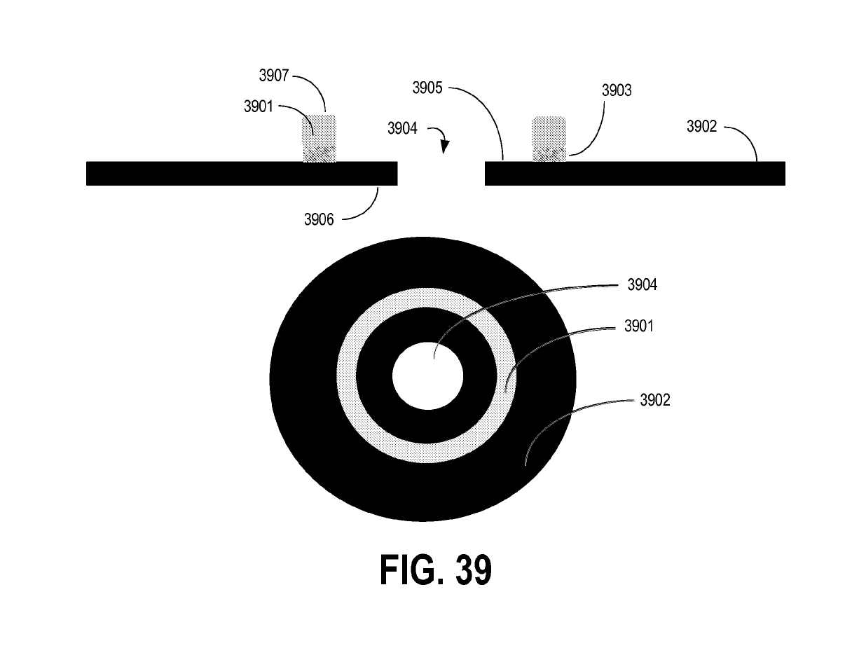

FIG. 39 shows section and plan views of a moving surface 3902, where the moving surface 3902 contains a through-thickness aperture 3904 that is surrounded by a structure such as a ring 3901 that is attached to the moving surface 3902, according to an embodiment. The ring 3901 that can be attached to the moving surface 3902 by use of an adhesive 3903, for example. The ring 3901 can be configured so as to completely surround the aperture 3904. The ring 3901 can be configured so as to partially surround the aperture 3904. The ring 3901 can be of unitary construction or can be segmented.

If desired, one or more rings 3901 can be placed on both sides of the moving surface 3902 and the rings 3901 can have the same or different geometries and can be made of the same or different materials. Although drawn as circular in the plan view in FIG. 39, the ring can take a variety of different geometries, including but not limited to circular, oval, square, triangular and spiral.

In those instances where the moving surface 3902 holds an optical component, the optical component (not shown) can be attached to either the upper 3905 or lower 3906 side of the moving surface 3902 or to the upper side 3907 of the ring 3902. The preceding discussion referred to ‘light’ and ‘optical’ components. That ‘light’ could be any wavelength from the far infra-red to deep ultra violet and beyond, while the ‘optical’ component can be tailored to work at that wavelength. Items other than optical components can be moved with the actuator.

Actuation of the moving surface 3902 has been described in accordance with certain embodiments as being accomplished through the use of electrostatic charges. According to other embodiments, various different forces or phenomena can be used to provide attractive and/or repulsive forces between the fixed surface and the moving surface so as to facilitate actuation of the device.

One example of such a force is magnetic force. A magnetic field can be provided by the passage of an electric current through a coil, to define an electromagnet. Such a device can be controlled by electrical means.

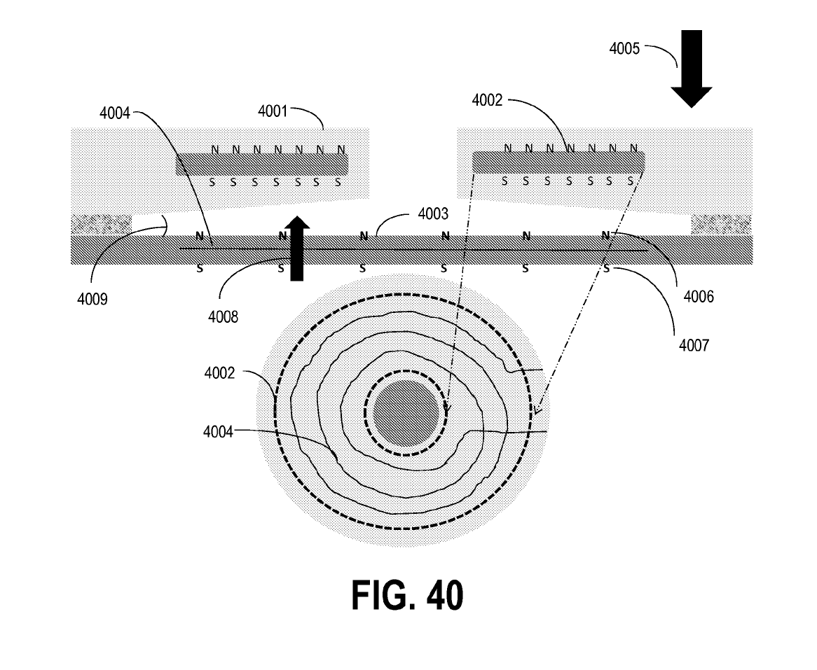

FIG. 40 shows a tri-state electrostatic/electromagnetic actuator in plan and section view where embedded within the fixed surface 4001 there is a permanent magnet 4002 and embedded within the moving surface 4003 there is a coil 4004, according to an embodiment. Due to the geometry of the moving surface 4003, the coil 4004 will typically be substantially planar. Means (not shown) can be provided for making electrical connection to the coil 4004. Such means can include contact pads formed upon the moving surface 4003 and/or wires bonded to the coil 4004.

The coil 4004 can have one or more turns. The optimal number of turns can depend, at least partially, on the electrical characteristics of the materials from which the coil 4004 and the moving surface are formed. Such characteristics can include resistivity, heat conduction and heat capacity, as well as the method of manufacturing of the coil and attaching it to the moving surface. Typically, the number of turns should generally be as large as practical, in order to tend to maximize the magnetic force. However, the number of turns is generally limited by the heating of the coil by the electric current. The calculations of optimal parameters for the coil are well known to those skilled in the art. The thickness of the coil should generally be as small as practical, in order to tend to minimize the effect of the coil on the moving surface mechanical characteristics. However, the coil thickness should be sufficiently large to avoid excessive heating of the coil.

In addition to generating magnetic force, coil 4004 can be used for generating electrostatic charge. This is possible by driving an electric current through the coil, and at the same time applying an average voltage to the coil with respect to the fixed surface voltage. For example, the average voltage of the coil can be 5V, while the magnetic force can be generated by driving 100 mA through the coil. Such 100 mA can cause a typical voltage drop of 1V between the coil terminals for coil resistance of typically 10 Ohm.

In such cases where the coil is used for both magnetic force and electrostatic attraction, the portion of surface area of the moving surface covered by the coil should generally be as large as possible, in order to maximize the electrostatic force.

The coil 4004 can be formed of wire or can be formed in any other desired manner, e.g., via electroplating, vapor deposition, and/or photolithography.

The embedded permanent magnet 4002 can be orientated such that the magnetic poles are perpendicular to the top and bottom surfaces of the fixed surface 4001. That is, the magnetic poles can be aligned with the viewing direction 4005. The magnetic poles are indicated by N for North and S for south, respectively in FIG. 40.

By passage of direct current of appropriate polarity though the embedded coil 4004, temporary magnetic poles can be generated that are normal to the moving surface 4003. Again, this is indicated in FIG. 40 by N and S for the two poles. If the poles 4006 on the upper surface of the moving surface 4003 are the opposite polarity to the nearest pole of the embedded permanent magnet 4002, then the moving surface will be attracted toward the fixed surface 4001, thus causing the moving surface 4003 to move towards the fixed surface 4001, as indicated by the arrow 4008. If these poles are of opposite polarity then the poles will repel and the moving surface 4003 will be repelled away from the fixed surface 4001 so as to increase the acute angle 4009 between the fixed and moving surfaces.

Because electrostatic charge and magnetism are different physical phenomenon and therefore do not interact or interfere with each other, it will be apparent that they can readily be combined to facilitate displacement of the moving surface in a tri-state electrostatic actuator. For example, in an electrostatic actuator the attractive force increases in inverse proportion to the distance of separation between the fixed and moving surfaces. Therefore when the fixed and moving surfaces are widely separated, the force is small. However, once the moving surface is lying on the fixed surface, for example when it is mid-way through it's stroke, the distance of separation will be small and hence the force available to continue the motion of the moving surface will be large. It is therefore possible to define a configuration where the moving surface cannot commence movement because the electrostatic attraction is too small, but once movement has started, the available force is adequate or even excessive.

The force between two magnetic poles likewise diminishes with distance. In the case of a magnetic field generated by the passage of electric current through a coil, the intensity of the magnetic field, and hence the mechanical force is dependent on the current. Most portable electronic equipment is powered by batteries. Therefore, to maximize the operating period between charges it is desirable that electronic equipment consumes very little power. Electrostatic force derived from electric charge fulfills this goal since only a very small amount of energy is involved in charging the capacitor formed between the fixed and moving surfaces of the tri-state electrostatic actuator. In certain embodiments, high voltage is used to develop significant electrostatic charge, and hence mechanical force, wherein additional engineering efforts are utilized to ensure sufficient electrical isolation between the various parts of the device, including the power supply. In other embodiments, magnetic force derived from electrical current flow involves appreciable power. The total energy consumption of an electromagnet is greatly reduced in certain embodiments by restricting the duration of current flow to a brief pulse.

According to one or more embodiments, a tri-state electrostatic actuator is provided wherein an electrostatic force is selected that is sufficient to maintain actuation once started, but insufficient to start the movement. The electrostatic actuator can therefore be designed to work at low voltage. To trigger actuation, a pulse of current is sent through the electromagnet to generate a temporary, additional force from magnetism. By limiting the duration of the current pulse, the energy consumption can be restricted to the point where a combined tri-state electrostatic-magnetic actuator is suitable for use in portable electronic equipment.

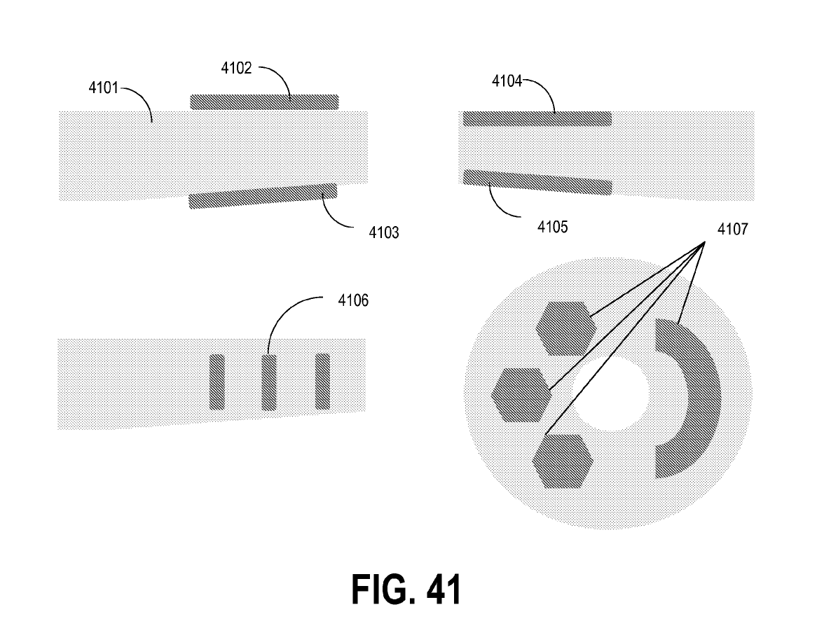

FIG. 41 depicts a variety of locations for permanent magnets 4102-4107, which are to be associated with the fixed surface 4101, according to an embodiment. For example, the permanent magnets 4102 and 4103 can be located on the exterior of the fixed surface 4101, either being away from (as is 4102), or close to (as is 4103), the moving surface (not shown in this figure). Alternatively the permanent magnets 4104 and 4105 can be embedded so as to be flush with the exterior. The permanent magnets 4106 can be rod-like when viewed in section or the permanent magnets 4107 can be multi-part and of any desired shape when viewed in plan.

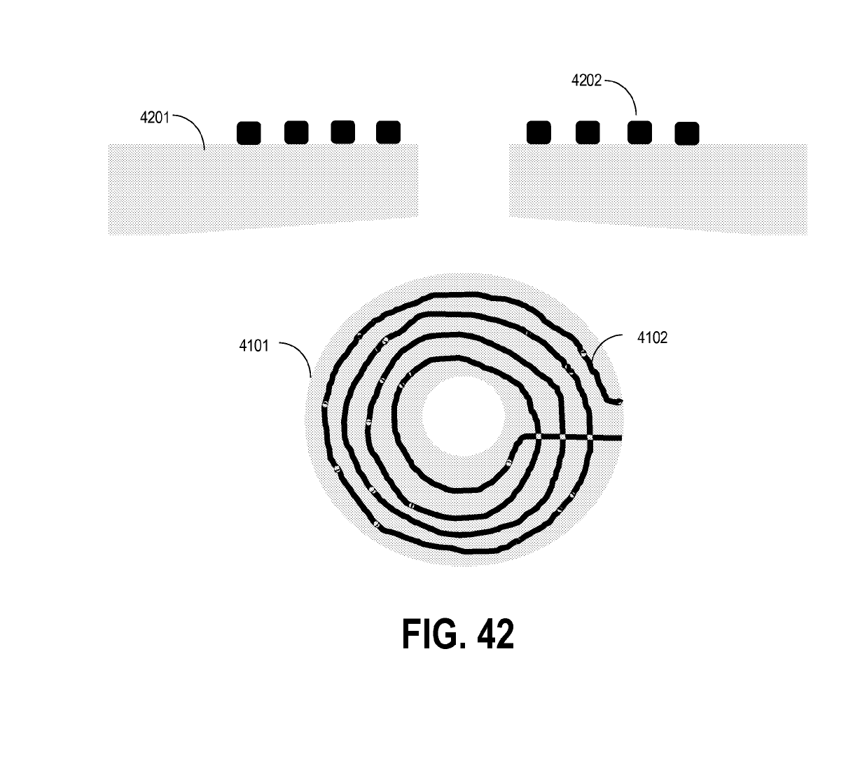

FIG. 42 shows section and plan views of a fixed surface 4201 that has a substantially planar coil 4202 attached to one surface thereof, according to an embodiment. The coil 4202 can be attached to either side of the fixed surface 4201. Because the purpose of an embedded magnet is simply to provide a stationary magnetic pole with which the electromagnet within the moving surface can interact, such a magnet embedded in the fixed surface can also be constructed as an electromagnet. As with the permanent magnets, the coil 4202 can be embedded within the body of the fixed surface 4201, attached to one of is surfaces, and/or mounted so as to be flush with one of its surfaces. Similarly, the coil 4202 could be a single coil, or multiple coils. The coil 4202 can have electrical connections as discussed herein.

Making the magnet associated with the fixed surface an electromagnet provides for an embodiment where the magnet associated with the moving surface includes a permanent magnet. The permanent magnet could be embedded within the moving surface, attached to the moving surface, or mounted so as to be flush with the moving surface. The permanent magnet could include a unitary item or may be distributed as an array of smaller individual magnets.

In a further embodiment, where the magnet associated with the fixed surface includes an electromagnet, the magnetic pole associated with the moving surface can include a soft magnet. For example, the moving surface could contain embedded within it a distribution of fine particles of ferrite. Alternatively, if the moving surface is composed of a dielectric material in combination with a conductive film, the conductive film could include a soft magnetic material and so perform the dual functions of an electrostatic electrode and a magnetic pole. Various compositions and structures of homogeneous materials and multi-layer films that have soft magnetic properties may be used in accordance with embodiments.

When using electrostatic force alone, comparatively high voltages are used to pull the moving surface towards one of the fixed surfaces (such as those of FIG. 8), even though application of very little power can be sufficient to keep it there. When using magnetic force alone, comparatively high currents and power are involved in keeping the moving surface at one of the fixed surfaces (such as those of FIG. 8), even though use of little energy and low voltages can be sufficient to move it there.

According to one or more embodiments, a combined electrostatic and magnetic device, e.g. actuator, is provided. A comparatively large current pulse can be used to get the diaphragm or membrane closer to one of the electrodes, thus lowering the applied voltage for doing the rest of the work, e.g., moving and/or holding the diaphragm, with electrostatic attraction, that consumes very little power.

In the case that the planar coil is in a membrane, then the membrane can cover a large portion of the actuator surface area so as to provide enough electrostatic pull-in force while the membrane is close to the electrode. The electrode material can still be made of conductive polymer or other conductive material that won't interfere with the magnetic field.

This approach can support the option of a coil in electrode and a magnetic membrane. The magnetic material can also serve as conductive for the electrostatic mode or the membrane can have a separate conductive layer.

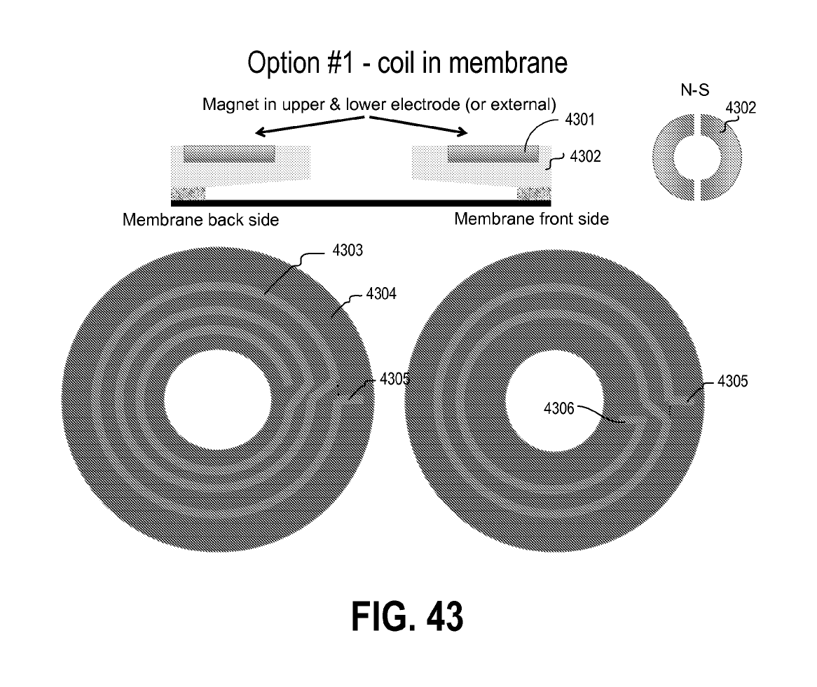

FIG. 43 shows a cross-section of a permanent magnet 4301 in an upper electrode 4302 and a plan view of a membrane 4304 having a coil 4303, according to an embodiment. The permanent magnet takes the form of a ring with a hole through its centre. The permanent magnet has a magnetic field orientation so that one pole faces the moving member and the other pole faces the object side of the camera. One or more coils 4303 can be attached to and/or disposed within the moving surface 4304.

The coil 4303 can be formed upon both the front and back side of the moving member 4304 and can be connected to one another using a via 4306 formed in the moving member 4304. Contacts or contact pads 4305 can facilitate electrical connection to the coil, such as via soldering.

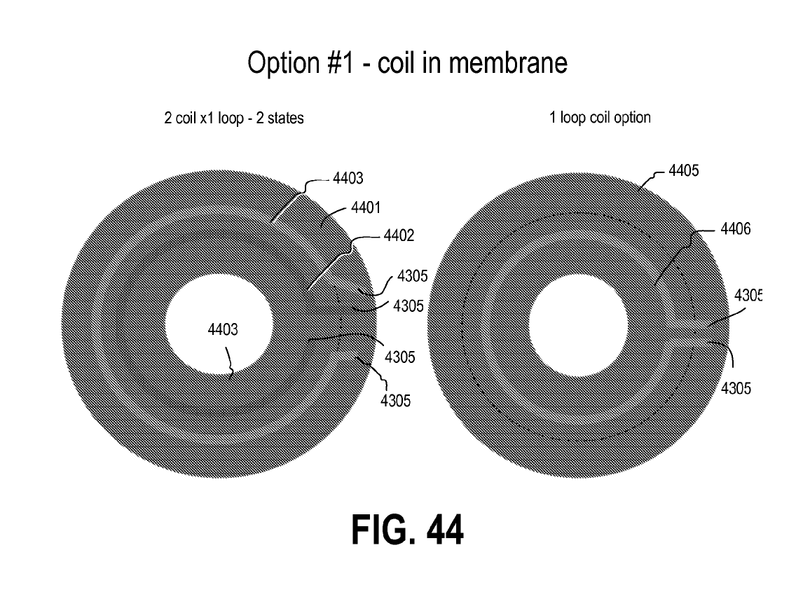

FIG. 44 shows a plan view of a membrane 4401 having two coils 4402 and 4403 on one side thereof and a plan view of a membrane 4405 having one coil 4406 on one side thereof, according to an embodiment. Embodiments can have any desired number of coils on each side thereof.

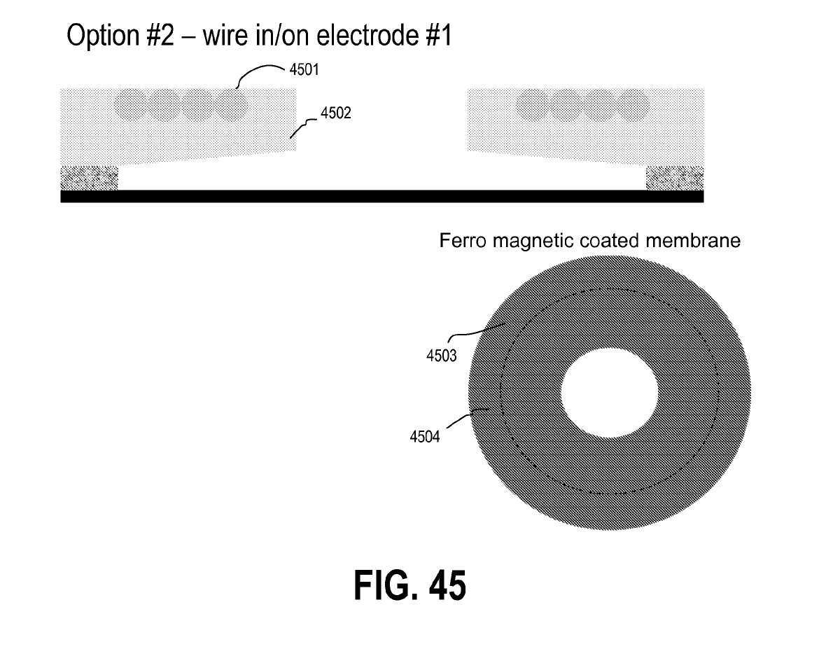

FIG. 45 shows a cross-section of an upper electrode 4502 having wire coil 4501 therein and/or thereon and a plan view of lower electrode or membrane 4503 having a magnetic material coating 4504 formed thereon, according to an embodiment.

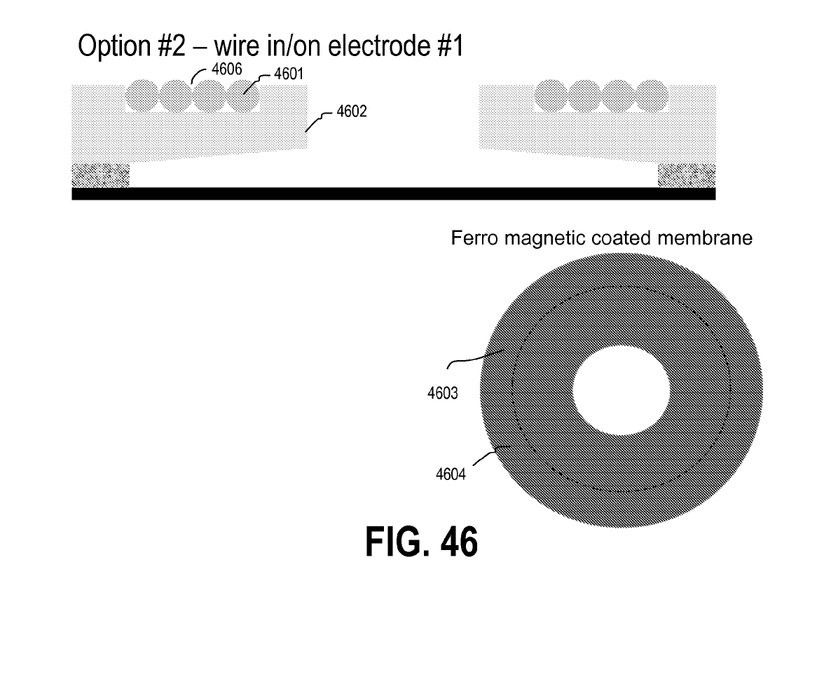

FIG. 46 shows a cross-section of an upper electrode 4602 having wire coil 4601 in a groove or channel 4606 thereof and a plan view of lower electrode or membrane 4603 having a magnetic material coating 4604 formed thereon, according to an embodiment.

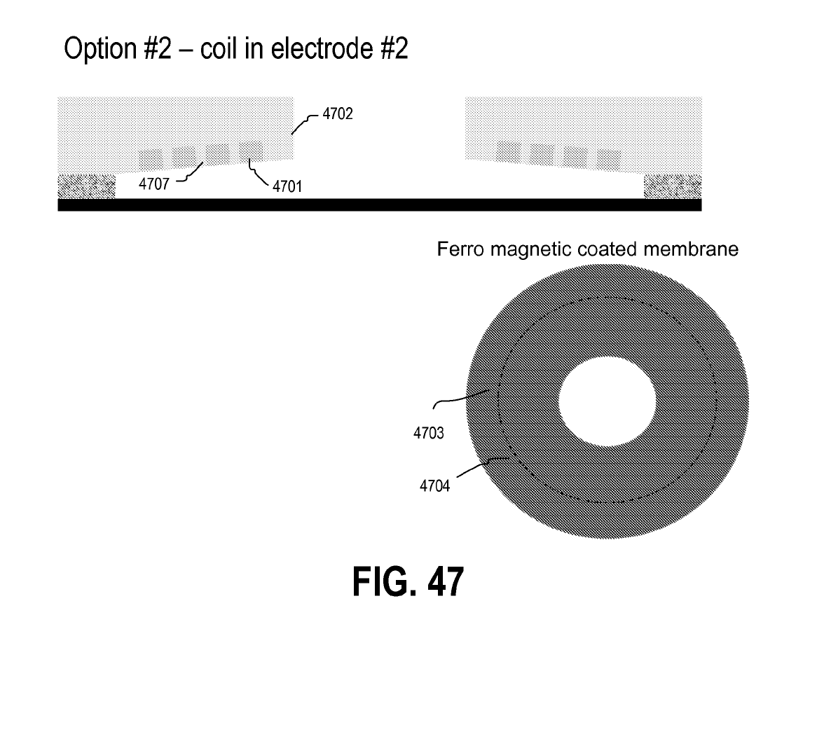

FIG. 47 shows a cross-section of an upper electrode 4702 having coil 4701 therein and/or thereon, e.g., proximate a lower surface 4707 thereof and a plan view of lower electrode or membrane 4703 having a magnetic material coating 4704 formed thereon, according to an embodiment. The coil 4701 can be formed of wire or can be formed in any other desired manner, e.g., via electroplating, vapor deposition, and/or photolithography.

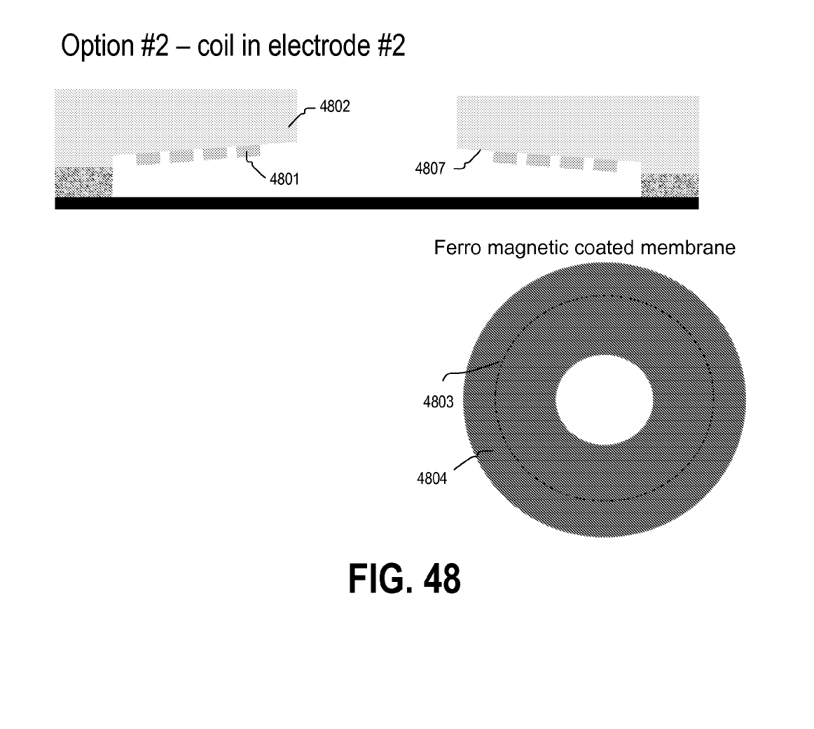

FIG. 48 shows a cross-section of an upper electrode 4802 having coil 4801 therein, e.g., proximate a lower surface 4807 thereof and a plan view of lower electrode or membrane 4803 having a magnetic material coating 4804 formed thereon, according to an embodiment. The coil 4801 can be formed of wire or can be formed in any other desired manner, e.g., via electroplating, vapor deposition, and/or photolithography.

Such methods as described above for combining magnetic and electrostatic forces for optimization of the power consumption and voltage usage of the actuator, can also be used in combination with methods for adding more fidelity to the control of the moving surface, such as (but not limited to) the methods shown and discussed in relation to FIGS. 11, 12, 26-30, and 32-36.

As used herein, the terms fixed substrate, fixed surface, top member, rigid member, upper electrode, and the like can be used to designate the stationary element of an actuator. As used herein, the terms moving substrate, moving surface, membrane, diaphragm, flexible member, bottom member, lower electrode and the like can be used to designate the moving element of an actuator. In certain embodiments of a miniature electronic camera, the lens alignment in the optical train are advantageously attained and sustained resulting in a camera that provides high image quality. The structures and methods disclosed herein can be used to fabricate an optical train in a manner that achieves precise registration between combinations of lenses and optionally an aperture as well, despite the first lens and optional aperture being free to move along the optical axis of the camera.

The structures and methods involve various advantageous components having features to permit their precise physical registration to one another. In the accompanying drawings these are illustrated as cups and cones as example, and suitable structures may be otherwise configured.

An example according to certain embodiments includes an auto focus camera module where the first lens is able to move by means of a tri-state electrostatic actuator, while three further lenses are fixed in position.

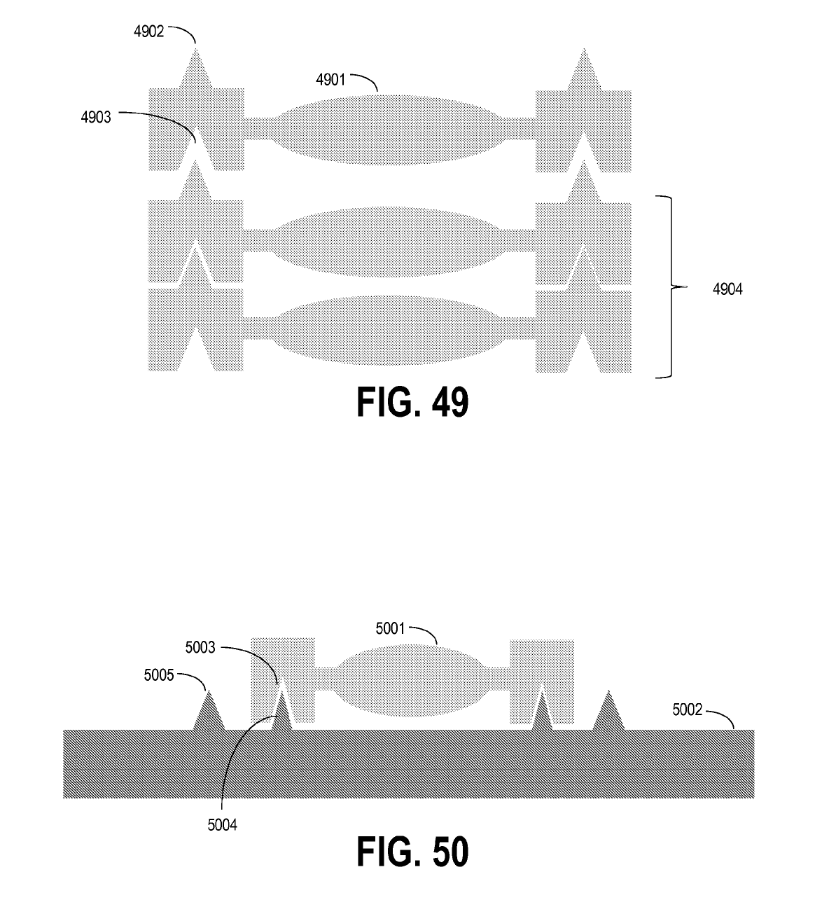

With reference to FIG. 49, the three fixed lenses are each provided with features that permit physical registration of one with another. Each lens 4901 has a cone 4902 on its object side and a cup 4903 on its image side. In other embodiments, the cones and cups are reversed so the cups are on the image side and the cones are on the object side. A lens train can be assembled by stacking of lenses 4904. The cups and cones provide precise registration in plan and rotation from the object side of one lens to the image side of the next. The pitch, yaw and vertical spacing between lenses is dictated by the precision with which the physical registration features abut. In FIG. 49, it is the lens surfaces that are depicted as abutting; however various types of physical registration features may be utilized.

In a separate operation (see FIG. 50), the first lens in the optical train 5001, which will be carried by the tri-state electrostatic actuator, is placed on a re-useable carrier 5002. The lens is precisely located on the re-useable carrier by means of cups in the lens carrier 5003 and cones on the re-useable carrier 5004. The re-useable carrier supports an additional set of cones 5005 near its periphery.

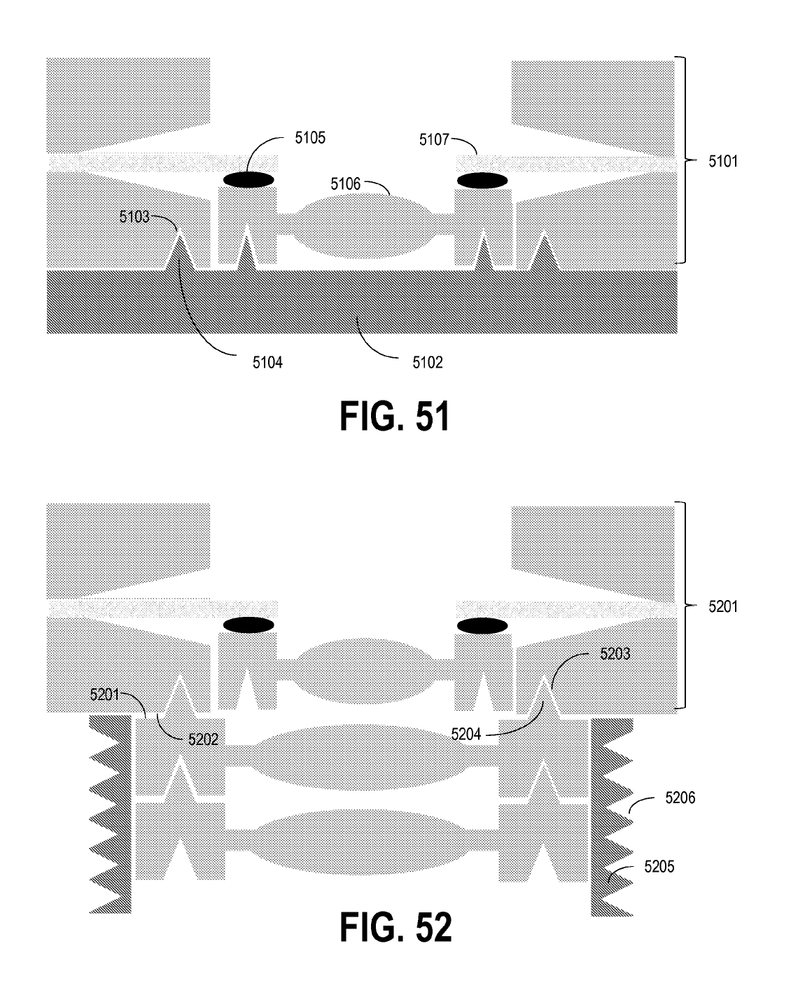

Next, (see FIG. 51) the tri-state electrostatic actuator 5101 is placed on the reuseable carrier 5102 and aligned to it by means of physical registration features 5103 and 5104. This means at this juncture the lens is precisely aligned to the actuator. Adhesive 5105, or another joining method, is applied and activated to attach the first lens 5106 to the moving electrode 5107 of the electrostatic actuator.

With the alignment of the lens to the actuator locked, the re-useable carrier is removed (see FIG. 52) and the three pre-aligned fixed lenses (from FIG. 49) are joined to the electrostatic actuator (only two of the three pre-aligned fixed lenses are shown in FIG. 52 in the interest of the clarity of the illustrated example). Alignment between the object side of the upper fixed lens 5201 and the image side of the actuator 5202 is achieved in this embodiment by means of physical registration features 5203 and 5204. To complete the assembly a hollow lens turret 5205 with an exterior thread 5206 is placed over the three fixed lenses and joints made to secure the lenses in place and the barrel to the actuator. The latter joint is included in certain embodiments as the actuator forms the effective head of the screw thread on the turret. The methods of making the joints may include adhesive bonding.

The described method and structure achieves passive, but precise, alignment between are fixed and moving lenses of the camera optic by means of a re-useable carrier.

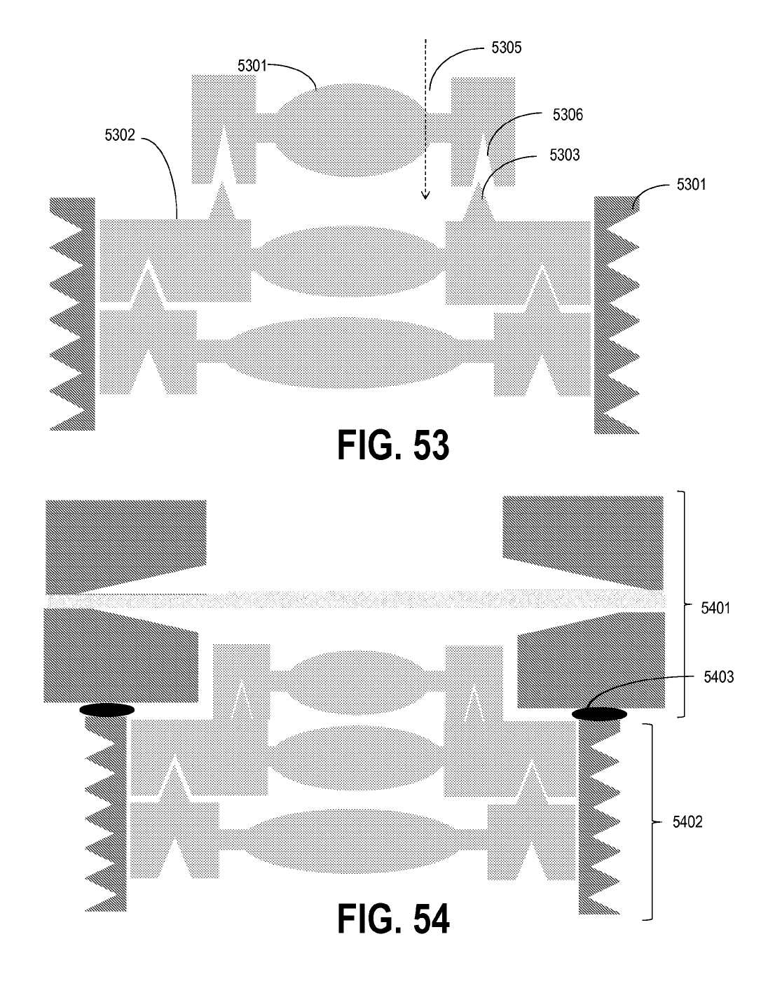

Another example of method and structure that achieves the same or similar result will now be described with reference to FIGS. 53-57. FIG. 53 shows a lens turret 5301 that may be used as a miniature camera optic in which all but the first lens has been aligned and assembled. The upper surface of the second lens 5302 has physical features 5303 that may be configured and utilized to physically locate the first lens.

The first lens is free in certain embodiments to move along the optical axis of the camera in order to permit the focus to be altered. Accordingly, in the next step of the assembly process, the first lens 5304 is merely placed on the second lens, as indicated by the dotted arrow 5305, but is not joined to it. The mating physical alignment features 5303 and 5306 ensure that the first lens is aligned to the second lens and hence the remainder of the optical train.

Next, (see FIG. 54) the tri-state electrostatic actuator 5401 is placed on and joined to the lens turret 5402. A joining medium is depicted as 5403. For reasons that will become apparent, this assembly step to be done without high precision because the tri-state electrostatic actuator is not carrying an optical component.

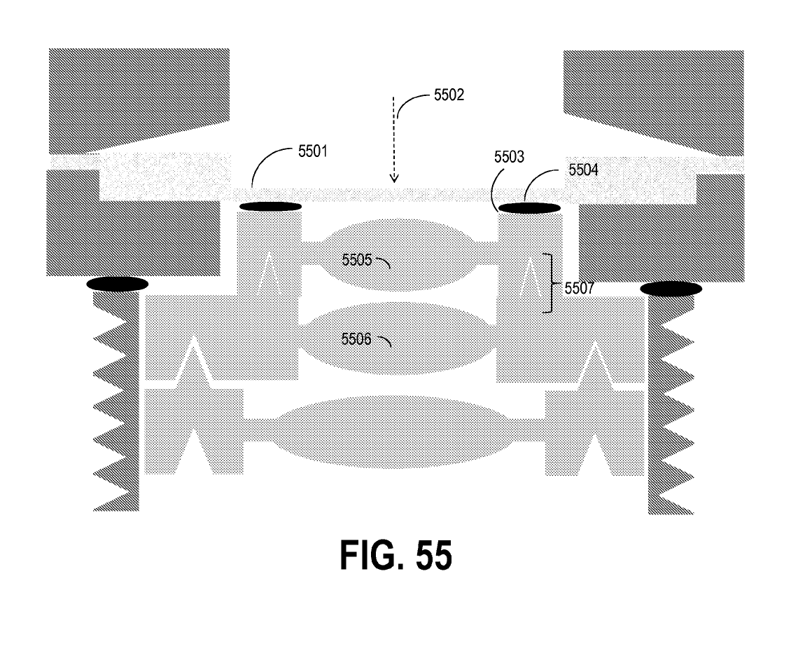

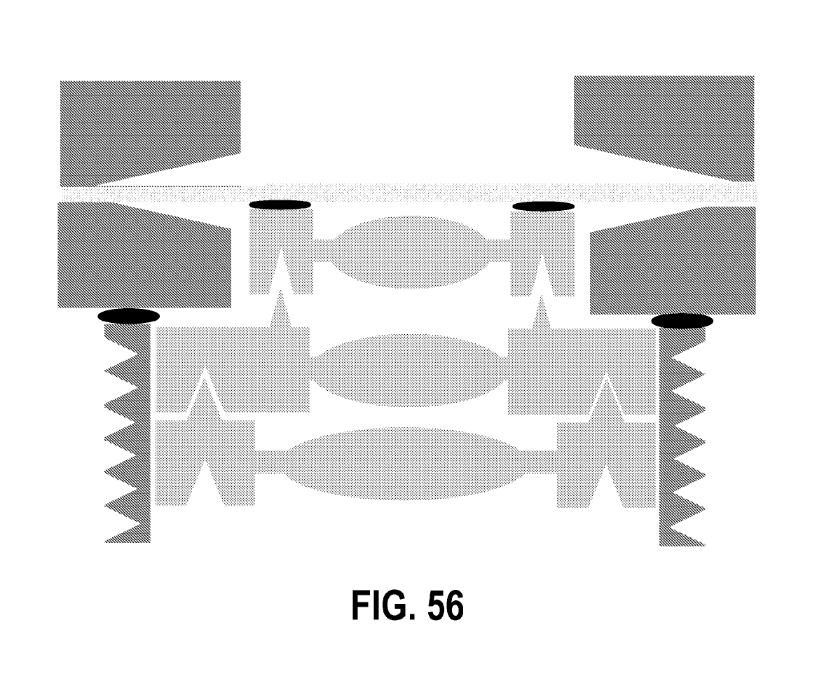

Finally, (see FIG. 55, left) the moving electrode of the tri-state electrostatic actuator 5501 is deformed downwards, as indicted by the dotted arrow 5502 and joined to the upper surface of the first lens 5503. The joining media is indicated by 5504. At the point of joining, the first lens 5505 is still aligned to the second lens 5506 by virtue of the physical alignment features 5507 so providing high precision of alignment through the entire optical train. When the deforming force on the moving electrode is removed, the moving electrode will spring back to its neutral mid-point position, causing the first lens to separate from the second lens. The structure then appears as shown in FIG. 56.

The methods of joining the tri-state electrostatic actuator to the lens turret and the moving electrode to the first lens may be based upon and/or dictated by a variety of factors that include the materials of the surfaces to be joined, the operating environment of the camera, the speed of assembly required and the cost budget. Suitable methods will be apparent to one skilled in the art that are not limited to adhesive bonding, mechanical interlocking and/or welding.

Likewise, a variety of methods can be conceived for deforming the moving electrode to permit joining to the first lens. They are not limited to a mechanical press tool, pneumatic pressure and/or electrostatic charge between the moving electrode and the lower static electrode.

Both of the example methods of assembly can be extended to include apertures in the optical system, including an aperture that moves in tandem with the first lens. As will be shown, an aperture can be located on the object side or the image side of the lens and optionally on both sides.

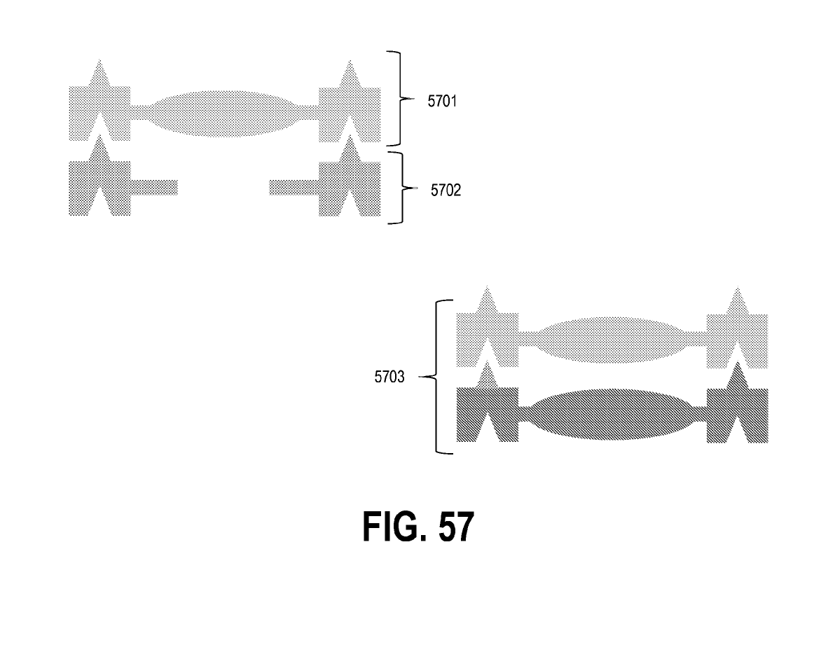

An aperture may include a plate made of an opaque material that contains and/or defines a transparent region. The transparent region may define a circular hole located on the optical axis. The aperture may be made in the form of a plate that contains physical registration features, so that it can be aligned and mated to a lens. For example, FIG. 57 shows, for ease of comparison a lens boasting physical alignment features 5701 and an aperture having mating physical alignment features 5702. Cups and cones again represent appropriate features in the interests of simplicity. It will be apparent that the lens and aperture may differ in their optical functionality, and may be otherwise the same or similar in certain embodiments. Thus it is possible to precisely align apertures on one or both sides of every lens, including the first lens. If an aperture is associated with the first lens then the aperture may be moved in certain embodiments in tandem with the lens. Provided the lenses are suitably light, the first lens could be a doublet 5703. These alternative optical configurations provide benefits for the optical design of auto focus cameras.

Before considering methods and structures for making electrical connection to the actuator that moves the first lens and optionally an aperture, it is instructive to consider the construction of the actuator so as to illustrate its mechanical and electrical configuration.

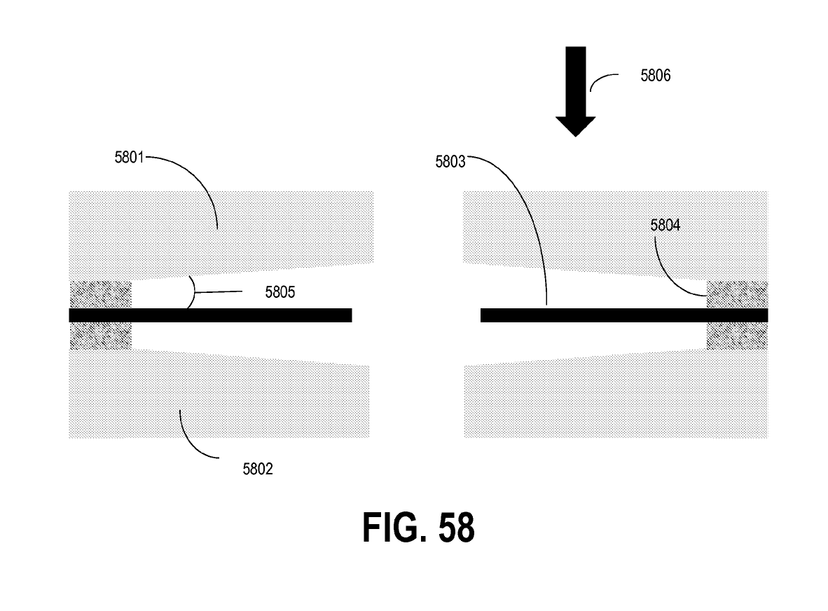

FIG. 58 is a cross-section of a radially symmetric tri-state electrostatic actuator in accordance with certain embodiments taken though its diameter that has an upper static electrode 5801, a lower static electrode 5802 and a moving electrode 5803. The moving electrode is joined to the static electrodes by a layer of adhesive 5804 at the periphery. There exists an acute angle 5805 between the static and moving electrodes because, when at rest, the moving electrode may be approximately flat while the static electrodes may have a taper so that there is close proximity between the two at the periphery of the device and a greater distance of separation towards the centre of the device. The normal viewing direction, when referring to plan views of this device is indicated by the arrow 5806, which is from the object side to the image side of the camera module.

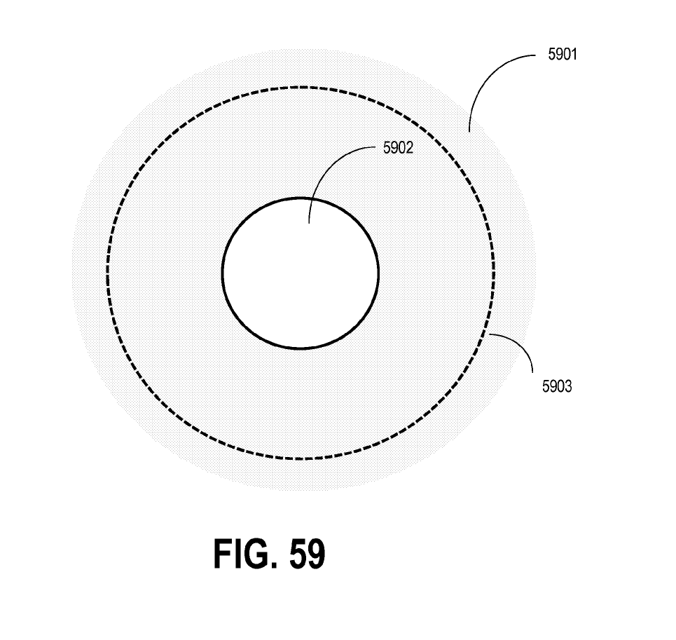

FIG. 59 is a plan view of the device shown in FIG. 58, as viewed from the object side. In this example the upper static electrode 5901 is shown to be a radially symmetric component with an aperture in its centre 5902 that transverses the full thickness of the part. In plan view 5900 it can be seen that the static and moving electrodes are co-centric. To aid understanding, also shown in FIG. 59 and denoted by a dotted circle 5903, is the start for the taper on the static electrodes.

The tri-state electrostatic actuator shown in FIGS. 51, 52, 54, 55, 56, 57 and 59, which is in accordance with certain embodiments that is configured to move a single lens and optional aperture, operates by electrostatic attraction and repulsion. In the particular implementation for miniature cameras it can be operated by application of relatively low voltage, typically 10-30 volts at negligible current, typically nano amperes. This means the electrical connections to the actuator can have high resistance and still perform satisfactory. This is a big advantage over current-based actuators, such as VCMs, where reliance on low resistance contacts can be problematic. Embodiments involving one or fewer than one connection for each electrode each provide significant advantages.

Electrical connections to the tri-state electrostatic actuator can be conceptually divided into three flavors. These are connections to an upper surface of the turret (the object side), connections to a lower surface of the turret (the image side) and connections to the edge of the turret. It will be apparent from the descriptions that follow many implementations of one flavor can be implemented in another flavor. To avoid undue repetition, not every embodiment will be described in every flavor possible. In general, characteristics, configurations and/or properties of one embodiment can be combined with those of another to form further embodiments, even though they may not be expressly described. Similarly, it will be evident that it is possible to combine the flavors so, for example, one contact may be made to the imaging side and two contacts made to the object side of a turret. Again, in the interests of clarity selected features may be described without detailing all features of each contact scheme that is being described. Permutations and combinations of the flavors are within the scope of additional embodiments.

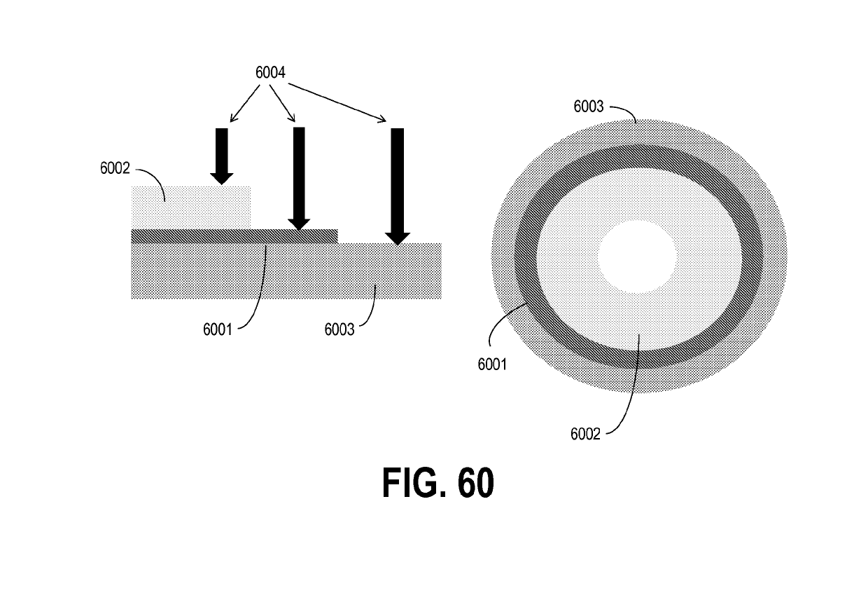

FIG. 60 shows a first embodiment in plan and section view. Because the tri-state electrostatic actuator is radially symmetric, in the interests of clarity only its periphery is shown in the section view in FIG. 60. The three components of the tri-state electrostatic electrode may be manufactured from parts of different diameters, where the moving electrode 6001 has a diameter intermediate between the upper static electrode 6002 and the lower static electrode 6003. This structure exposes an area of each of the three electrodes, permitting connections to be made. For example, connection can be made by sprung contacts 6004. In effect, the connection scheme may be analogous to slip rings and/or they may involve slip rings in certain embodiments. Because the slip rings are circumferential, they are insensitive to the angle of rotation of the turret. Provided the mating contact to the slip rings has compliance in the vertical direction, then electrical contact can be maintained as the vertical displacement of the turret changes.

The spring contacts can take a variety of forms including coiled springs, metal strips working in their elastic range, compressible conductive polymers and/or otherwise as may be understood by those skilled in the art.

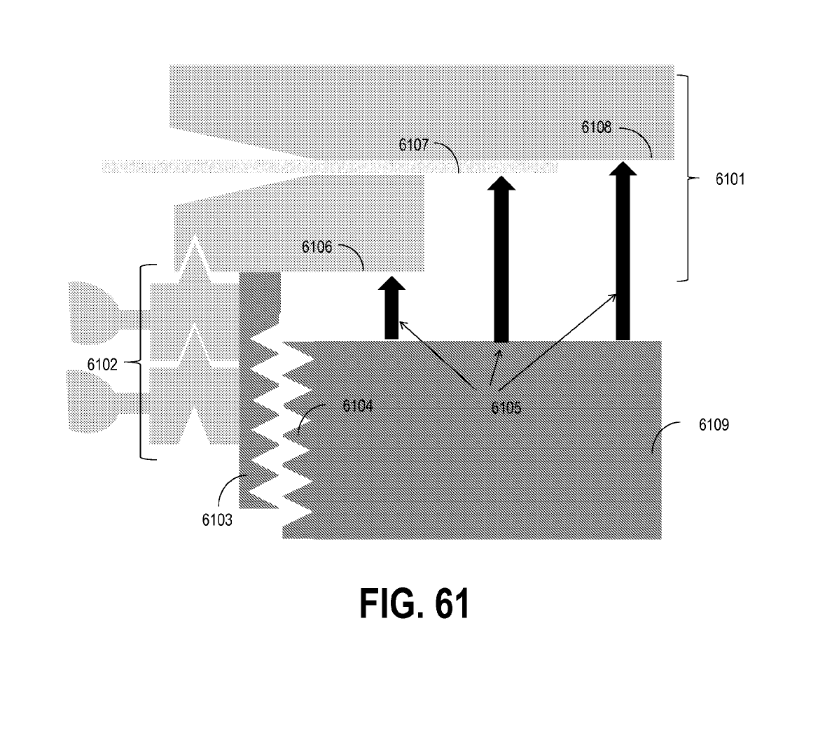

It will be apparent that the slip rings can be on either the object or image side of the turret. When present on the image side, a method of connection in accordance with certain embodiments involves vertically complaint spring contacts, as illustrated in FIG. 61, and this results in a simple and compact connection scheme. The tri-state-electrostatic electrode 6101, is shown aligned and attached to two fixed lenses 6102 and the screw thread of the lens turret 6103. The lens turret is inserted into the lens barrel by the matching screw thread 6104. The spring contacts 6105 form an electrical pathway between the three electrodes of the tri-state electrostatic actuator 6106, 6107, 6108 and the lens barrel 6109.

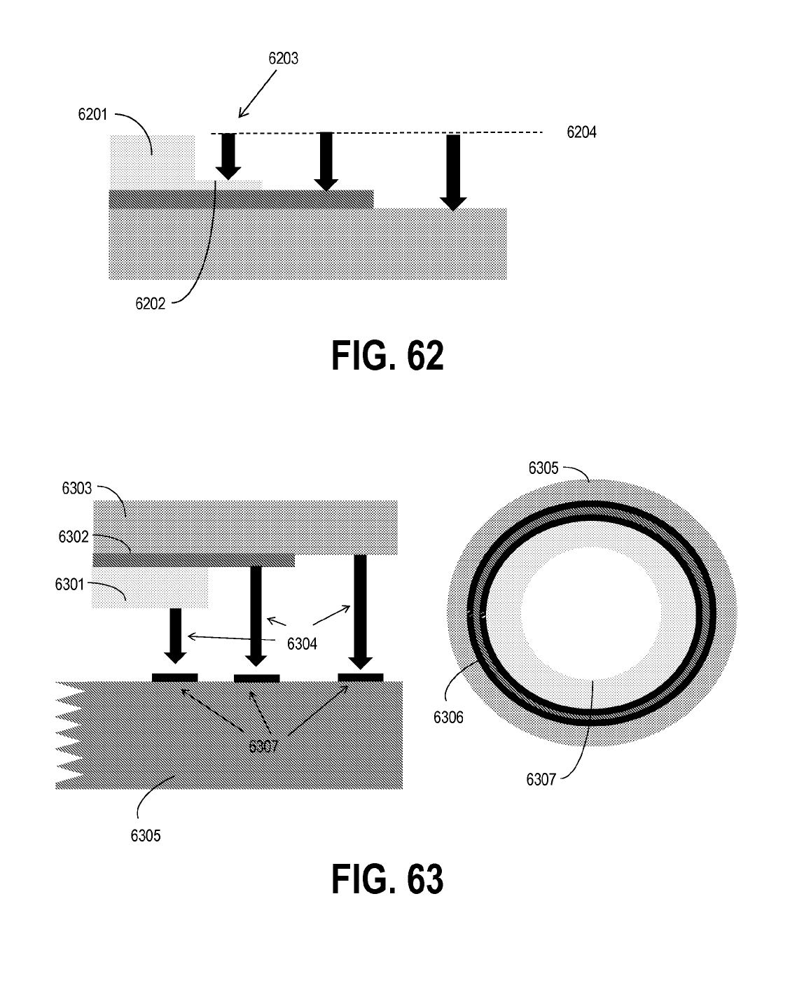

Electrical contact to the object side of the tri-state electrostatic electrode is provided in certain embodiments, wherein variations of the described connection schemes may be utilized with miniature electronic cameras, for example to keep the total height as low as possible. This means that structures that protrude above the surface of the lens turret may be undesirable in such embodiments. For this reason, an embodiment includes an upper electrode thickness that is stepped in order to provide a height in which to incorporate a spring contact. FIG. 62 illustrates an example of this structure. The upper static electrode 6201, contains a step 6202, that permits the mating contact 6203 to be contained below the image side of the tri-state electrostatic actuator, indicated by the dashed line 6204.

Another embodiment is illustrated in FIG. 63. In this arrangement, the lens turret is provided with structures that have a modicum of compliance in the vertical direction and the barrel has mating circular lands. In effect, the spring contacts are attached to the lens turret instead of the lens barrel, as in the preceding examples. The three electrodes of the tri-state electrostatic actuator 6301, 6302 and 6303 each has attached to it in an embodiment a spring contact 6304 that is compliant in the vertical direction. The lens barrel 6305 has slip rings 6306, one corresponding to each spring contact. The plan view in FIG. 63 is of the image side of the lens barrel, again illustrating the three slip rings 6306. The optical path through the lens barrel into which the lens turret will be screwed is indicated by the ring 6307.

The slip rings may encompass the entire circumference of the turret or barrel, as appropriate. However, the slip rings could be constrained to an arc, because a typical range of rotation of a lens barrel may be 90 degrees in certain embodiments. This applies to other embodiments and features described herein including structures that might otherwise be presumed to be continuous about the circumference.

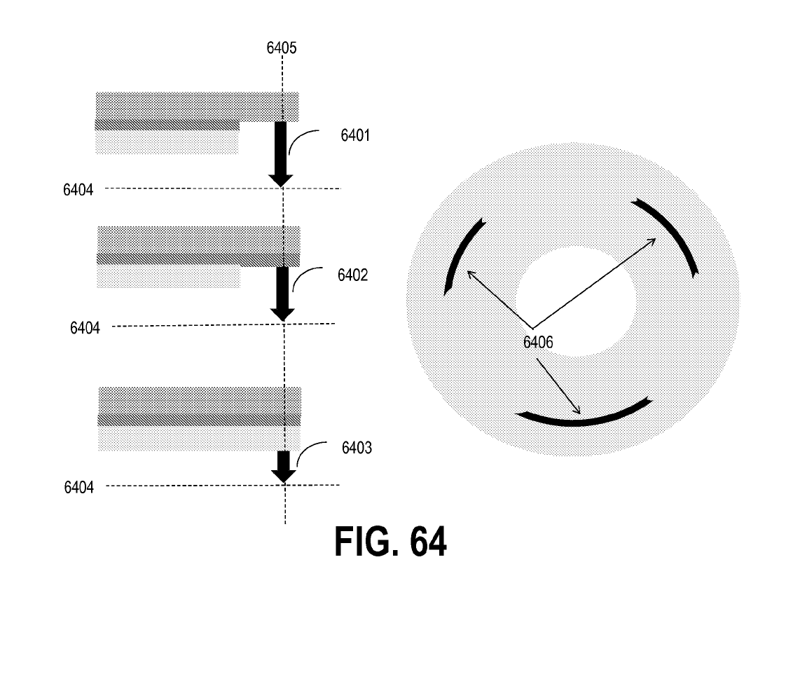

In another embodiment the slip rings are discontinuous around the circumference of the turret. This has the advantage that the spring contacts to each electrode on the tri-state electrostatic actuator can be at the same radius. In FIG. 64, the three section views show contacts with compliance in the vertical direction connected to the upper static electrode 6401, the moving electrode 6402 and the lower static electrode 6403. The contacts all lie on the same radius and terminate at the same height, as indicated by the dotted lines 6404 and 6405. Also shown in FIG. 64 is a plan view of the object side of the lens barrel. The slip rings 6406 to with which the spring contacts mate are seen to be three arcs at one radius.

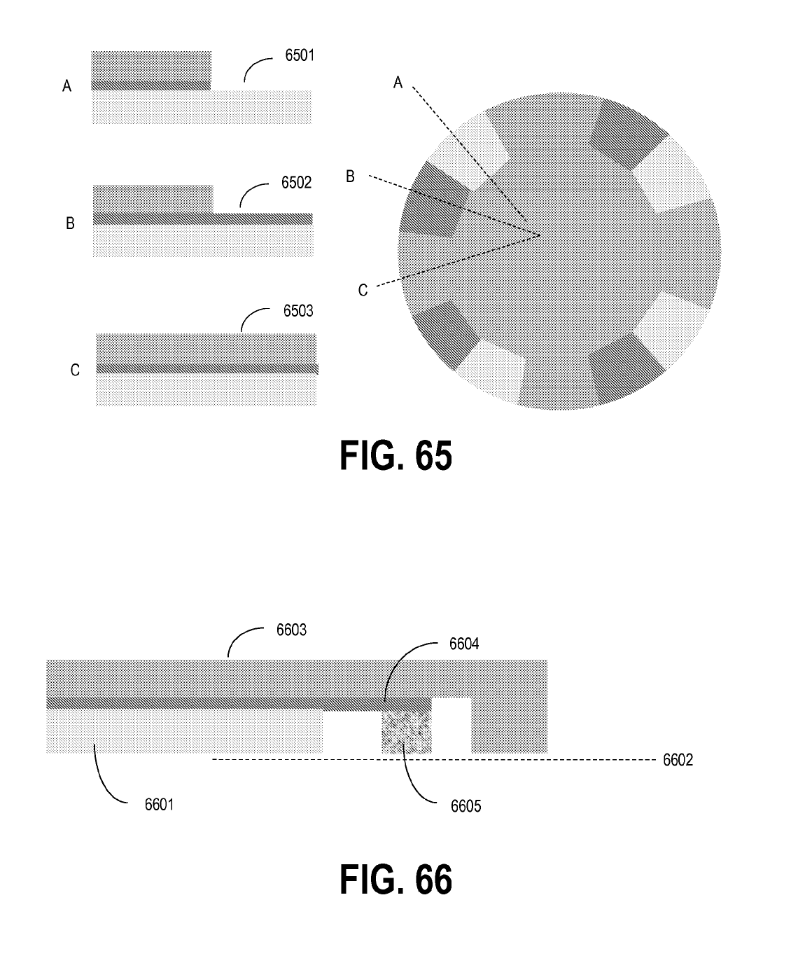

In yet another embodiment, holes are formed in the upper static electrode and optionally the moving electrode to provide areas of random access to the three electrodes. When the holes are solely at the periphery, the structure might appear as drawn in section and plan view in FIG. 65. Each of the section views A, B, C corresponds to the dotted line on the plan view. In section view A the lower static electrode 6501 is exposed. In section view B, the moving electrode 6502 is exposed. In section view C the upper static electrode 6503 is exposed.

One low cost method of making electrical connections between these unitary circumferential or distributed lands on the lens turret and the lands on the barrel is by wire bonding. Wire bonding is an interconnection method that is widely practiced in the semiconductor industry and is well known and understood. Alternatively, structures with vertical compliance could be used to make the connections between the turret and the land provided the contacts are made either after rotation of the turret is complete, or the areas cover a sufficiently large arc of radius to allow for the rotation of the turret. The contact structures could be associated with either the turret or the barrel. That is, the structure may be fixed to one and the moving land contacts the other.

In certain situations and/or embodiments, two or more or all of the connections between the lens turret and the lens barrel may be in the same plane. An embodiment that has this feature is illustrated in FIG. 66. In this example, the image side of the lower static electrode 6601 forms the reference plane, highlighted by the dotted line 6602. The upper static electrode 6603 is increased in thickness until it is at the same level as the reference plane. The moving electrode 6604 is preferably made of a thin flexible material and cannot be readily increased in thickness. One possibility is to bond a ring 6605 of certain thickness to the moving electrode so that a new surface is present that is at the desired plane.

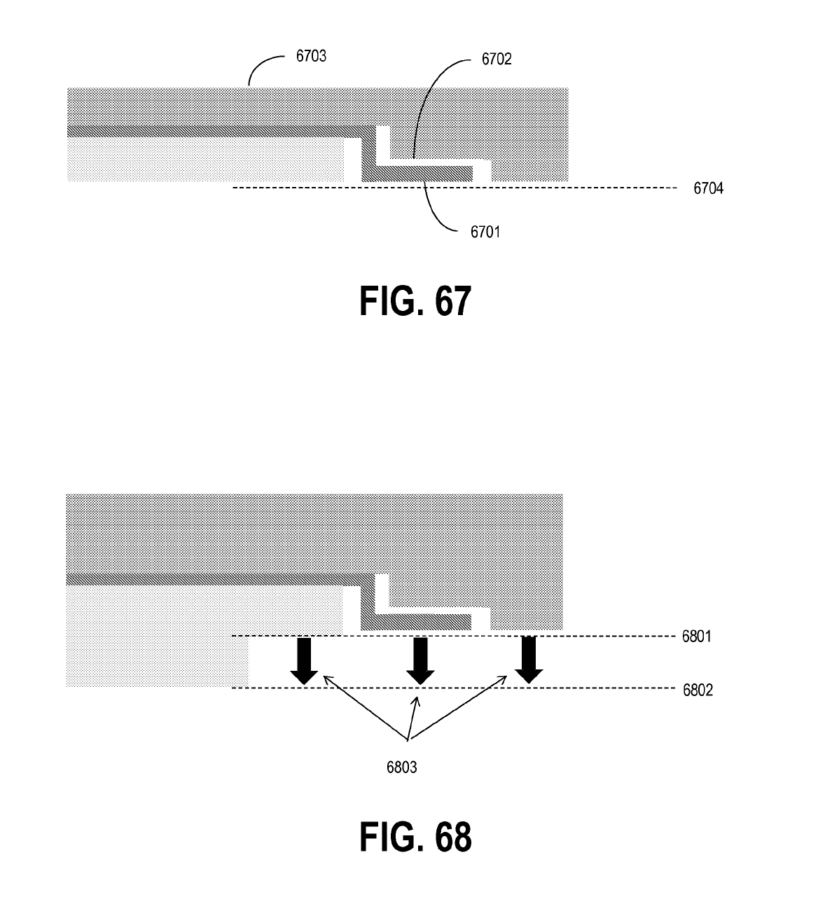

In another embodiment, the moving electrode is attached to a step in either of the static electrodes so that its surface is at the desired plane. FIG. 67 schematically illustrates the moving electrode 6701 extended over a step 6702 in the upper static electrode 6703. As in the embodiment illustrated at FIG. 66, the reference plane is indicated by the dashed line 6704.

FIGS. 63, 64, 66 and 67 depict embodiments wherein a connection on the image side of the lens turret, although in further embodiments, by mirroring the structure, that connection is on the object side. Where the structure is on the object side, as has been described previously, it may be desirable for the tri-step electrostatic actuator to be decreased in thickness in this region to provide a space for the mating connections without increasing the height of the camera module. By way of example, this alternative structure is also illustrated in FIG. 68. In FIG. 68, the contact line 6801 is below the image side of the lower static electrode 6802 and electrical spring contacts 6803 can be included in the height so created.

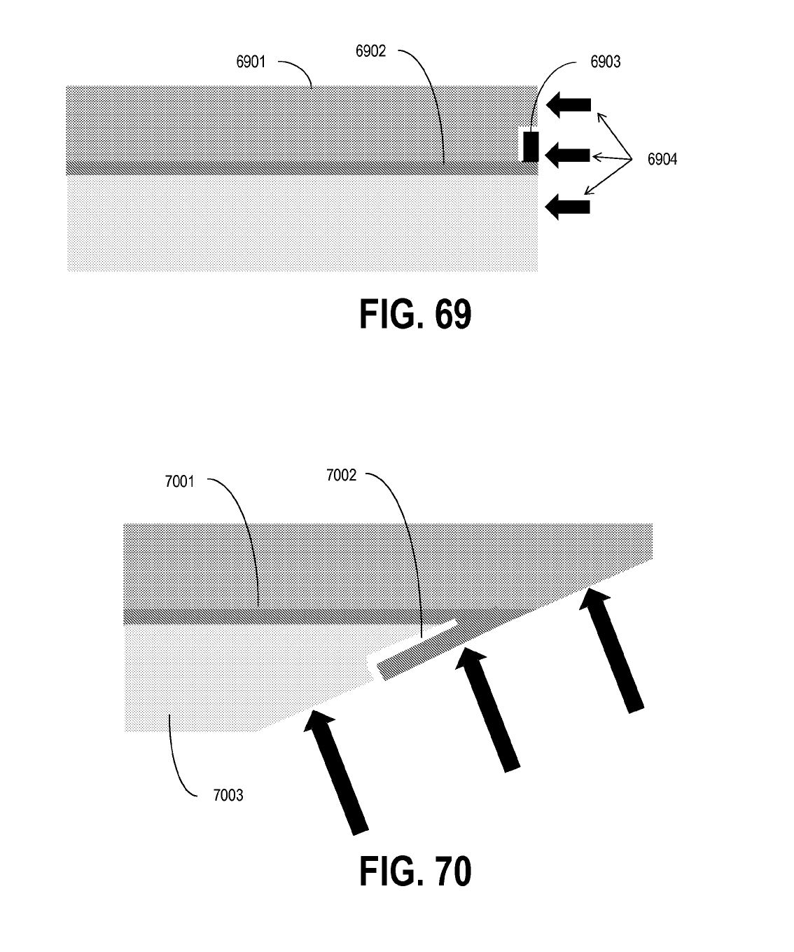

Yet another embodiment concerns making electrical connections to the tri-state electrostatic electrode at the periphery of the lens turret, for example, on its vertical edge. In a typical implementation, the moving electrode will be 10 um in thickness and often substantially less. As the vertical movement of the lens turret could be 75 um or larger, a slip-ring contact directly to the edge of the moving electrode is less advantageous than in other embodiments. One means of circumventing this issue is the structure drawn in FIG. 69. In this structure, the thickness of one of the static electrodes, as drawn the upper static electrode 6901, is decreased at is periphery with material being taken from the region closest to the moving electrode 6902. A ring 6903 is attached to this moving electrode and fitted into the space. The ring is slightly shorter in height than the removed material and preferably flush with the circumference of the two static electrodes. Spring contacts 6904 with a modicum of movement in the horizontal plane can be used to make electrical connection between the electrode edge and the lens barrel.

It will be apparent that many variations on this structure are possible. The contact to the moving electrode could be made symmetric by adding a ring either side, the slip rings formed on the circumference need not be concentric and could be arcs instead of complete circles. Likewise the contacts to the lens barrel could be attached to the either the lens barrel or the lens turret.

In a further embodiment, it is possible to conceive making electrical contacts to the lens turret at its periphery by providing the tri-state electrostatic actuator with a sloped edge. This structure is illustrated in FIG. 70. The moving electrode 7001 is continued along part of the sloped edge. Optionally this portion of the moving electrode may be contained within a recess of one of the static electrodes. Referring to FIG. 70, the recess 7002 is shown as being in the lower static electrode 7003. Connection to the slip rings thus formed can be by any of the methods described previously, but could include structures that have a modicum of movement that is perpendicular to the angle of slope.

A common aspect of the electrical connections of certain embodiments is that the lens barrel contains electrical pathways. These electrical pathways run from a connection on the object side to a connection on the imaging side. The connection on the object side can take a variety of forms, and may have a modicum of compliance in a direction that is appropriate to the embodiment. The termination on the imaging side is not shown. Typically they will be lands, for example those described in the specification for miniature cameras known as “SMIA” hereby incorporated by reference. In the interests of compatibility with this industry standard interface, certain embodiments include electrical connections through the lens barrel that utilize the same interconnect scheme on the image side of the lens barrel as the other contacts to the camera module.

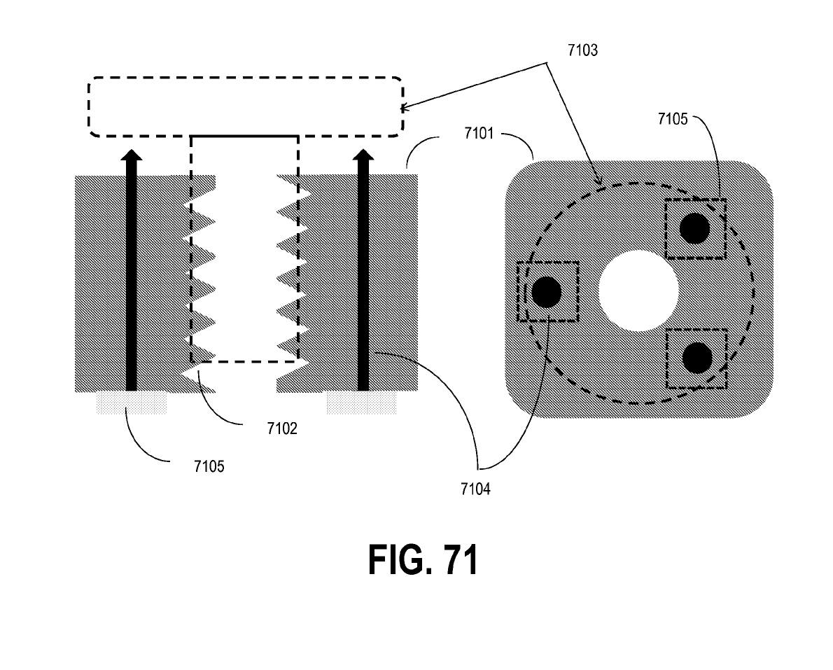

The electrical connections that run through the lens barrel between the lands on the object side and the spring contacts on the imaging side can take a variety of forms. An arrangement in accordance with an embodiment is in the form of wires, rods, beams or tubes. These can be either inserted into suitable holes that run through the lens barrel or the lens barrel can be formed around them. The latter is readily accomplished at low cost as in certain embodiments the lens barrels are manufactured by moulding techniques. Alternatively, the electrical connections can be attached to the exterior of the lens barrel or recessed within trenches on the exterior of the lens barrel. Irrespective of which approach is adopted, the resulting structure appears in certain embodiments as shown in FIG. 71. FIG. 71 shows plan and section views of a lens barrel 7101. The screw thread 7102 that lines the central through hole is threaded to accept the lens turret. The lens turret containing fixed lenses, a moving lens mounted in a tri-state electrostatic actuator and optionally a moving aperture, will in certain embodiments cover an area on the image side of the lens barrel. This is indicated by the dotted shape and line 7103. Conductive rods 7104 provide electrical pathways between the image and optics sides of the barrel. The arrows suggest that in this instance the rods have compliance in the vertical direction at the object and terminate at lands 7105 on the image side.

Although in FIG. 71 the lens turret is shown covering the conductive pathways through the lens barrel, the conductive pathways may in other embodiments lie outside of the lens turret, or there may be a mixture of both in still other embodiments.

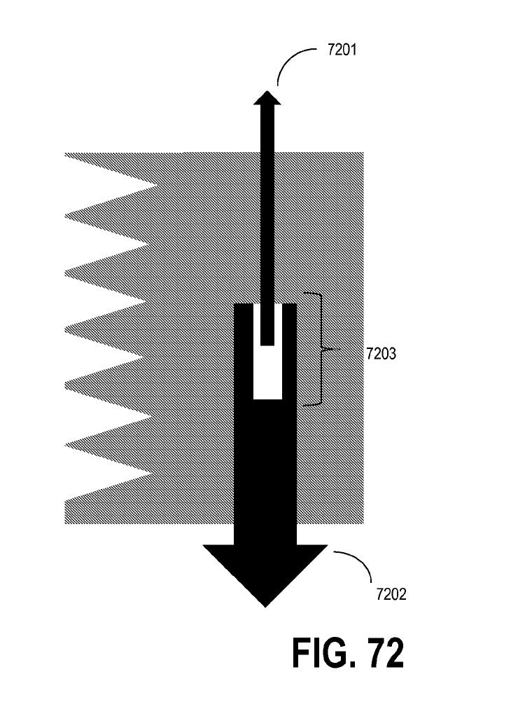

The wires, rods or tubes need not be unitary components. For example, they may be unitary components, or they may be composed of two or more pieces that join at some point in the assembly process. This structure and assembly method may have advantages where it is difficult or expensive to manufacture an entire pathway as a single entity. Suitable joining methods include but are not limited to push-fit, screw joint, adhesive bonding and soldering. For example, FIG. 72 illustrates a single electrical connection through a barrel that is formed from two parts. The electrical connection 7201 on the object side of the part terminates in a rod, while the land 7202 on the image side terminates in a tube. The diameters of the rod and the tube are engineered to be a friction push-fit 7203 so that a reliable joint results when they are mated.

In another embodiment, the electrical connection through the lens barrel takes the form of a conductive or filled via. Conductive and via filling technologies may be used in certain embodiments, that are adapted from, for example, the PCB industry and/or by practitioners of 3D packaging of semiconductor integrated circuits.

In another embodiment, the electrical connection through the lens barrel takes the form of an electrical track either on the exterior of the lens barrel or recessed, or embedded within it. Suitable structures for the tracks and methods of their manufacture may be adapted in certain embodiment from the printed circuit board industry.

In yet another embodiment, the electrical connection through the lens barrel takes the form of a rigid or flexible printed circuit board that is adhered to or detached from, the surface of the lens barrel. Alternatively, the circuit board could be recessed within a trench on the exterior of the lens barrel or entirely embedded within it.

The electrical interfaces described above between the tri-step electrostatic actuator and the camera module in which the lens train is mounted include, in certain embodiments, three connections, one for each of the electrodes. Other embodiments involve just two connections instead of three.

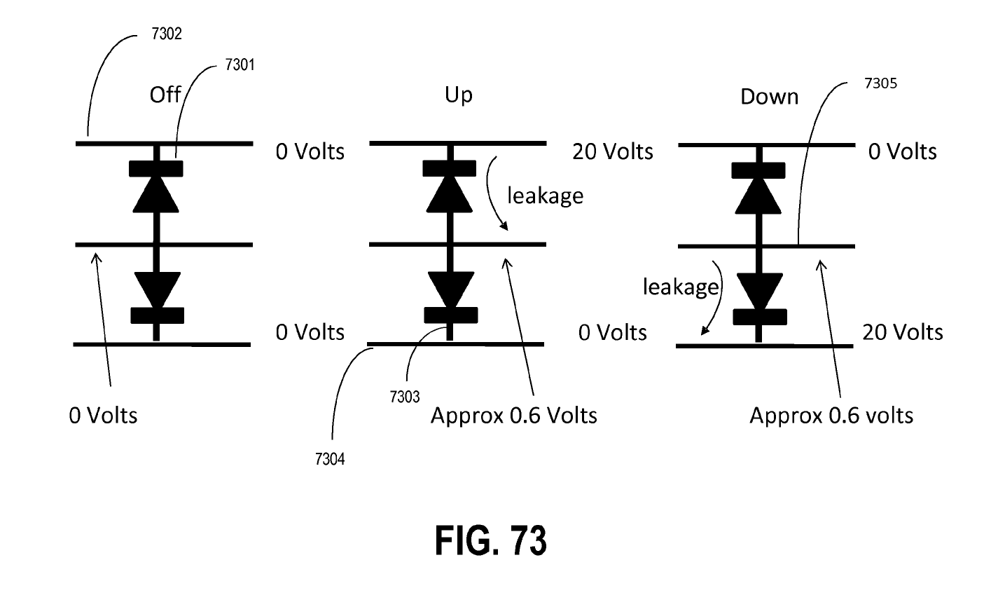

One method by which this is accomplished in accordance with an embodiment is to include within the optical train two diodes that are back-to-back. With reference to FIG. 73, the anode of one diode 7301 is connected to the upper static electrode 7302. The anode of a second diode 7303 is connected to the lower static electrode 7304 and the cathode of both diodes is connected to the moving electrode 7305. By applying a high voltage to just the two static electrodes in accordance with certain embodiments, the moving electrode will be at a low potential relative to one of the static electrodes because the forward voltage drop across a diode is substantially smaller than the reversed voltage drop. Hence by changing the polarity of the applied high voltage, electrostatic charge is generated in certain embodiments between the moving electrode and one static electrode at a time.

In certain embodiments, the polarities of the electrical control signals and the diodes are reversed to similar effect. Likewise in other embodiments, the diodes are replaced with a non-linear circuit element. In other embodiments, frequency dependent components are utilized so that the relative impedance of the electrical elements may be varied with the frequency of an applied pulse train.

With more complex circuitry, other methods of generating an electrostatic charge between the moving electrode and one of the static electrodes, in certain embodiment wherein two electrical connections are available instead of three, are devisable by those skilled in the art.

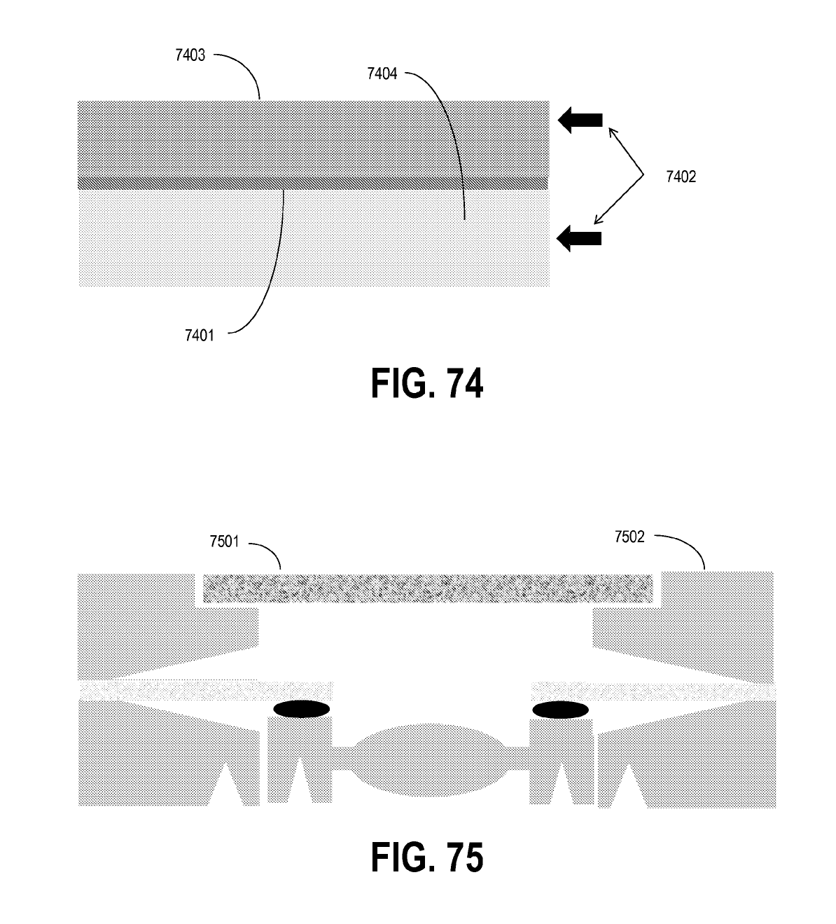

An advantageous of reducing the number of electrical connections to the tri-state electrostatic actuator from three to two is that it facilitates contacts to be made at the edge of the device. In certain embodiments, the moving electrode may be approximately 10 um in thickness and is substantially less in other embodiments. As the vertical movement of the lens turret could be approximately 75 um or more in certain embodiments, as the focus is set, it could be difficult in some embodiments to devise a slip-ring contact directly to the edge of the moving electrode. Eliminating this through the use of circuitry contained within the lens turret means that in certain embodiments, edge-slip ring contacts can be made solely to the upper and lower static electrodes. FIG. 74 is a variation on FIG. 69. Due to the presence of the circuitry described above, certain embodiments do not involve contact to the moving electrode 7401. Consequently, certain embodiments involve just two spring contacts 7402 at the periphery, one contacting the upper static electrode 7403 and the other contacting the lower static electrode 7404.

In other embodiments, the structures described above pertaining to three electrical contacts are applied to actuators where a fewer or greater number of contacts are involved.

In another embodiment, a protective and/or decorative cover is placed over the front face of the upper static electrode. As a protective element, the cover functions to prevent the ingress of dirt and liquid into the optical train. As a decorative element, the cover contains in certain embodiments a clear aperture of sufficient diameter to be compatible with the optical train, while the rest of the area is opaque. The opaque portion can be monochrome, colored or patterned in certain embodiments. As such this element can obscure many of the functional parts of the camera module from view and appear aesthetically appealing. The cover can be a rigid material, like a glass, or a flexible material like a polyester membrane.

In another embodiment, referring to FIG. 75, the cover 7501 can be smaller than the diameter of the upper electrode 7502 and recessed within it. This means the cover does not add to the total height of the camera module, which may be advantageous in certain applications.

In yet another embodiment, the cover can have an optical function. For example, it could be engineered as an aperture or an optical filter. Examples of filters include an infrared blocking filter, an ultra-violet blocking filter or a polarizing filter or another type of filter.

Disclosed is a solid state camera having focal length that can be changed by using a tri-state electrostatic actuator to move the first lens of the optical train. To improve the image quality and reduce the number of components and assembly steps in certain embodiments, the lower fixed electrode of the actuator is also the housing for the fixed elements of the optical train.

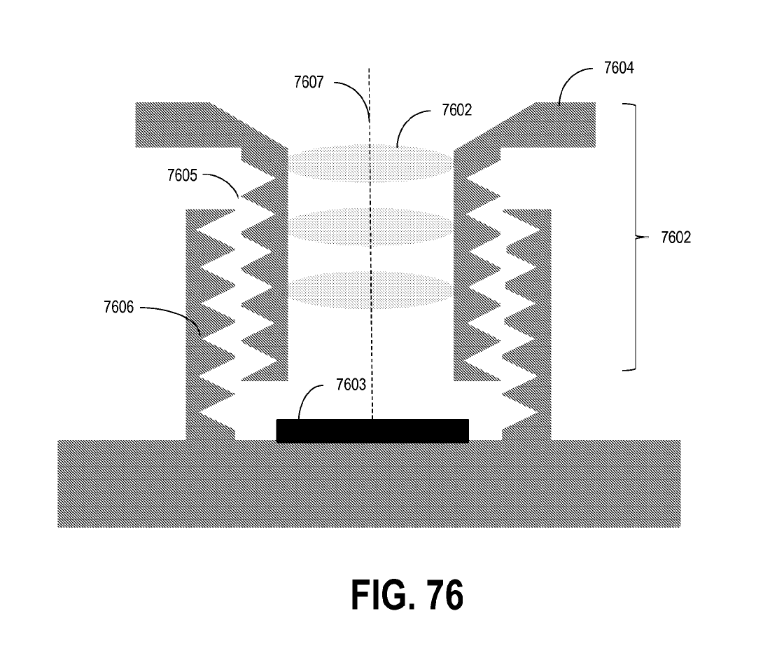

FIG. 76 is a sectional view indicating some of the components of a fixed focus solid state camera. Light from the scene to be captured typically passes through a series of lenses and apertures called the optical train 7601. Depending on the complexity and performance of the camera, there may be as few as a single lens and aperture up to about seven lenses, with four lenses and two apertures being one example of a relatively common configuration. The lens 7602 nearest the scene is called the first lens, the next lens the second lens et. seq. and similarly for the apertures. After passing though the optical train, the light falls on the optically sensitive area of the image sensor 7603. This component converts the optical scene into electronic format, including computer-type files.

The individual components of the optical train are fixed in relative location in certain embodiments by mounting in a housing called a lens turret 7604. To accommodate manufacturing tolerances, the lens turret 7604 may be provided with a screw thread 7605. By rotating the lens turret inside the lens barrel 7606, which has a matching screw thread and is referenced to the image sensor, the optical train may be moved along the optical axis of the camera 7607, permitting the focus of the camera module to be set as desired.

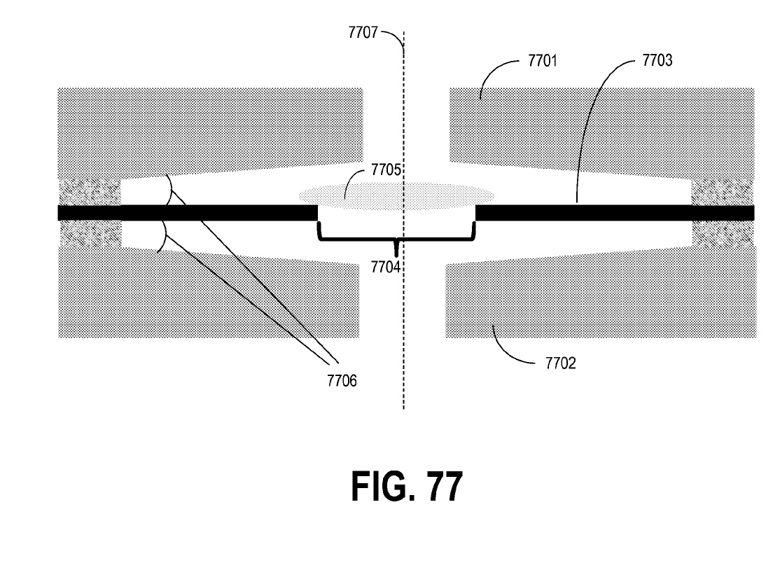

One method for changing the focus of an automatic focus camera is to use an actuator to move the first lens along the optical axis. FIG. 77 schematically shows a tri-state electrostatic actuator that can provide the desired function, and includes upper 7701 and lower 7702 fixed electrodes and a moving electrode 7703. There is an aperture 7704 in the centre of the moving electrode over which the first lens 7705 is mounted (detail of the lens mounting is not shown in FIG. 77). Acute angle tapers 7706 between the fixed and moving electrodes provide space for the moving electrode and hence the first lens, to be moved along the optical axis 7707 of the camera.

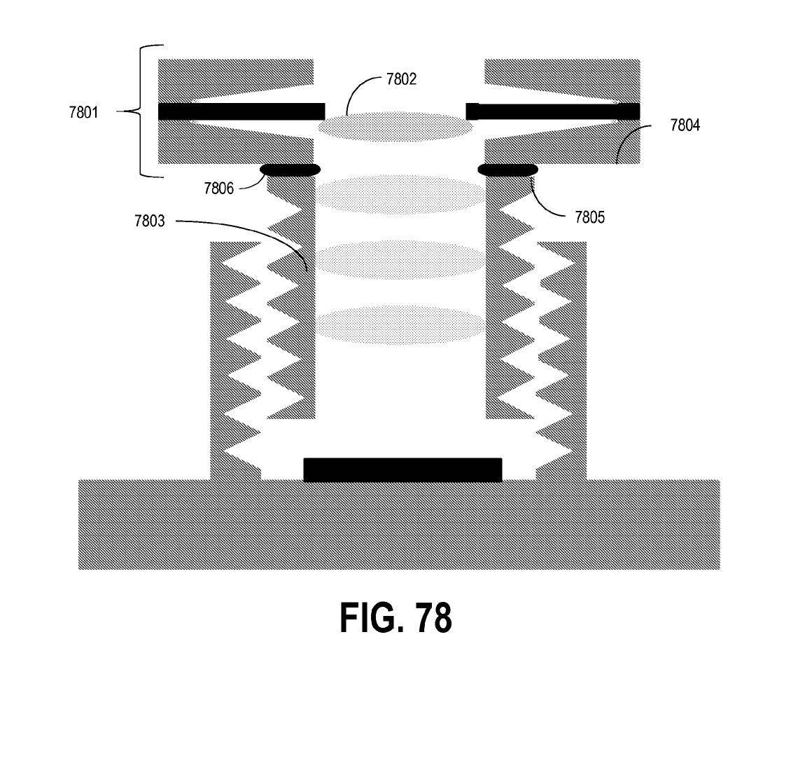

Referring to FIG. 78, an autofocus camera in accordance with certain embodiments includes a tri-state electrostatic actuator 7801, which is carrying the first lens 7802, and is coupled with the remainder of the optical train inside the lens turret 7803. As shown in FIG. 78, this can be accomplished in an embodiment by bonding the lower surface 7804 of the lower fixed electrode to the upper surface of the lens turret 7805. A variety of bonding methods may be used including adhesive joining, mechanical latching and welding, the choice being determined by factors such as the materials involved, the strength and stability of the joint required and the budget available for the process. In FIG. 78, the bond is illustrated by medium 7806.

The manufacture of the structure depicted in FIG. 78 involves a number of components and processes that will have a bearing on the quality of the final product. In certain embodiments, the tri-state electrostatic actuator is fabricated with the first lens as one unitary component, the lens turret is manufactured and populated with the remaining optical elements as a second unitary component and these two sub-assemblies are then combined to complete the entire optical train of the camera module.

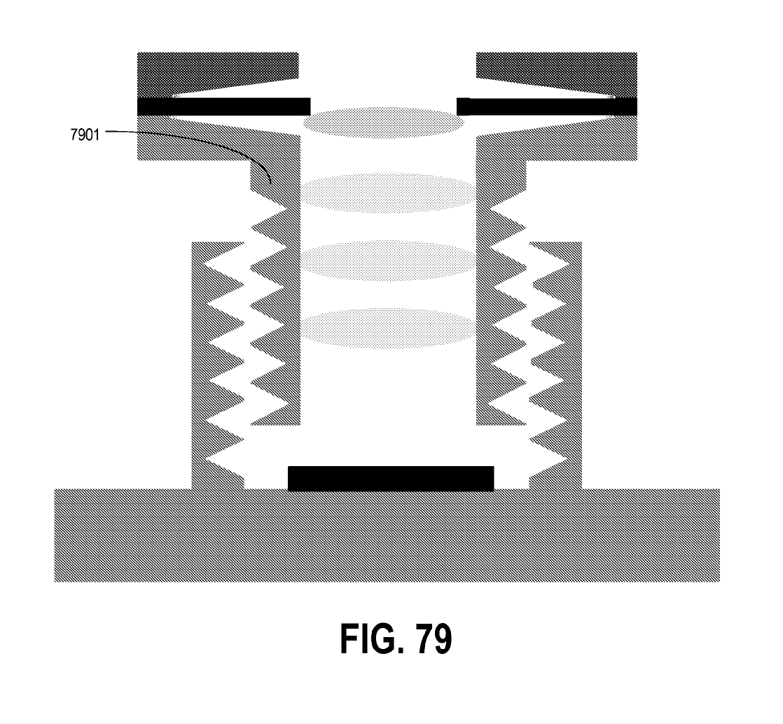

Another embodiment is illustrated in FIG. 79. In this structure, the lower fixed electrode of the tri-state electrostatic actuator and the lens turret are fabricated as a single component 7901. The optical elements are inserted in the lens turret without change and the moving electrode and upper fixed electrode are attached to the lower fixed electrode without change. Compared to the structure in FIG. 78, this embodiment removes one component and one joining operation from the manufacturing flow, without changing the product functionality.

The removal of one component and one joining operation has the desirable benefit of a reduction in direct cost, because fewer parts are procured in the process and there is one fewer joining operation. It decreases, in certain embodiments, the total cost through increasing product yield, because there is a yield loss associated with every manufacturing step. Product reliability and performance are also advantageously increased in accordance with certain embodiments. Joining processes are a notorious source of weakness in structures fabricated from discrete components, and so the elimination of a joining step by making the lower static electrode and the lens turret a single part advantageously boosts the reliability of the camera module.

Reducing the number of joining steps also helps ensure the automatic focus camera delivers the best possible image quality. The elimination, in the embodiment illustrated at FIG. 79, of the joining of the lower fixed electrode and the lens turret into a single component 7901 advantageously removes a potential source of misalignment in tilt and centering between the first lens and the optical axis of the camera. As misalignment can be highly detrimental to the resulting image quality, eliminating this joining step advantageously removes this source of optical impairment.

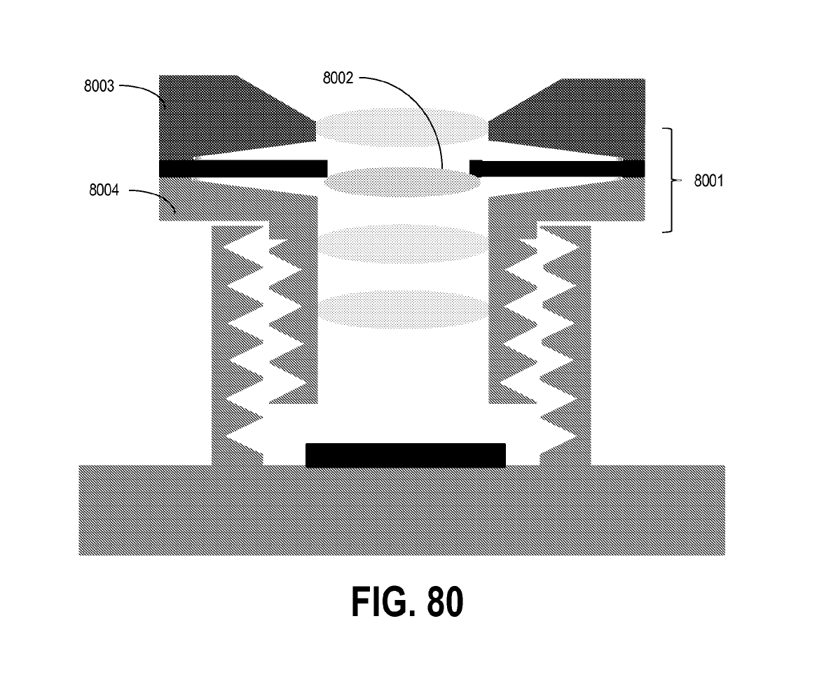

In the preceding description the tri-state electrostatic actuator has been associated with the first lens in the optical train. In other embodiments, however, this is not necessarily always the case. FIG. 80 depicts an embodiment where the tri-state electrostatic actuator 8001 is associated with the second lens 8002. This structure permits both the upper 8003 and lower 8004 fixed electrodes to form part of the lens turret, with attendant advantages over inserting a discrete tri-state electrostatic actuator carrying the second lens at the appropriate place in the lens turret. These include the elimination of two components, two joining steps and associated cost and performance penalties.

In certain embodiments, miniature camera modules are provided at low cost by foregoing some precision of the mechanical assembly that holds the lenses and other components of the camera in place. As a result, to avoid the focus of the camera module being in accurate, the reduced precision in mechanical assembly is compensated in certain embodiments by attaching one or more lenses, which can include the tri-state electrostatic actuator, to a structure that includes a screw thread. By rotation of the screw thread, the distance between those optical components and the remainder of the camera can be altered and thus the focus set. While this works, there is still some unpredictability of the exact final vertical position of the tri-state electrostatic actuator.

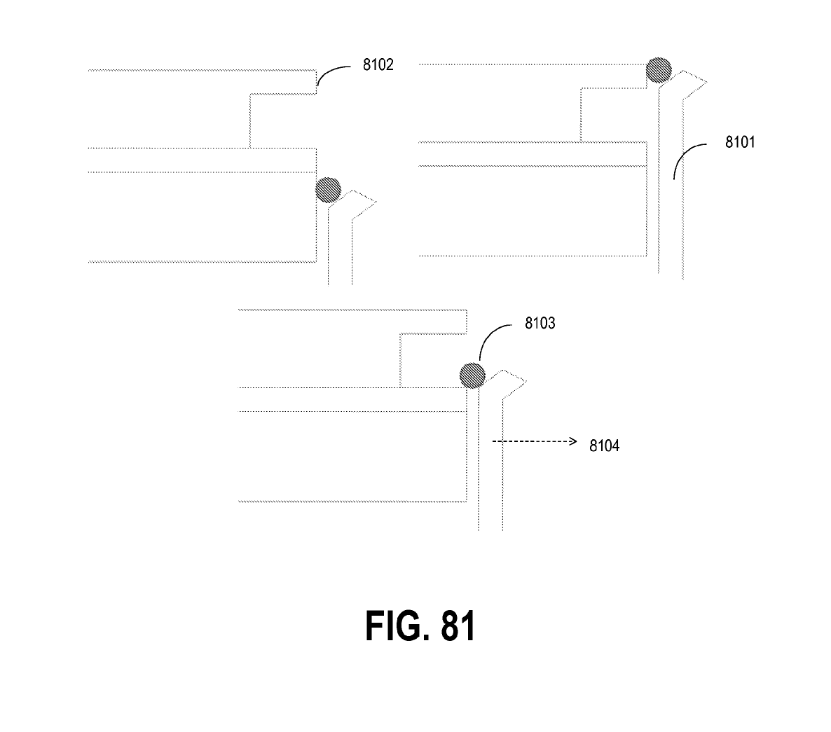

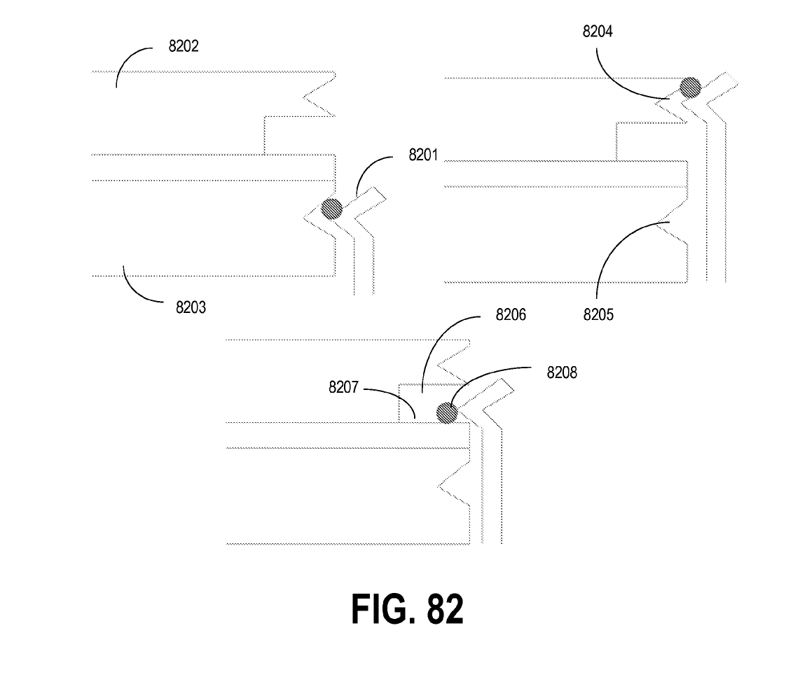

To facilitate automation of making electrical contacts to the tri-state electrostatic actuator, it is desirable for the connections to be closely similar. In yet another embodiment, the electrical connections to the tri-state electrostatic actuator can be made by a structure that overlaps the lands of the electrodes and has compliance in the lateral direction. Permanent electrical and mechanical connection between the land and the structure is accomplished in certain embodiments by a conductive adhesive. Three examples of this type of connection are illustrated in FIGS. 81-83.

In FIG. 81 the compliant structure 8101 is a conductive rod or strip, the end of which is turned away from the edge of the tri-state electrostatic electrode 8102. The resulting half cone formed provides a convenient pocket that can be filled with conductive adhesive 8103. In certain embodiments, the lateral compliance 8104 is included in the design to allow for variations in the size and centricity of the tri-state electrostatic electrode.

FIG. 82 is an embodiment that addresses the case where the land of the flexible electrode may be thin and has not been increased in thickness at the edge of the device. Because of this, contact to the edge of this land may be difficult, in which case electrical contact to the face of the land would be desirable. In FIG. 82, the compliant structure is provided with a horizontal protrusion 8201 at its end that extends towards the centre of the tri-state electrostatic electrode. The protrusion can be pointed, as drawn in the example of FIG. 82, or rounded. The upper 8202 and lower 8203 static electrodes have recesses 8204 and 8205 on the periphery that match approximately the dimensions of the protrusions on the compliant structure. The upper static electrode is provided with an additional recess 8206 so that a portion of the horizontal protrusion of the middle compliant structure can overlap the flexible electrode land 8207. Electrical connections to the three electrodes may be completed by conductive adhesive 8208.

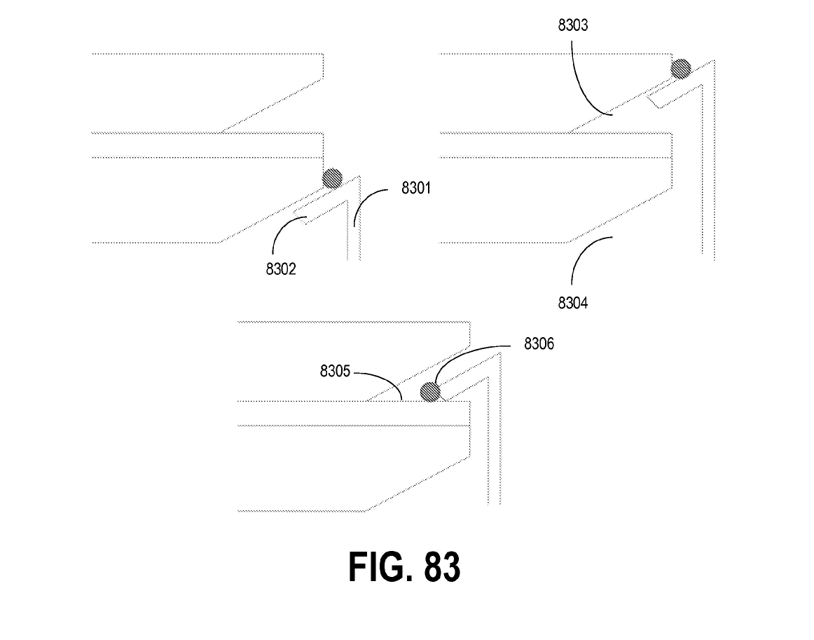

In a further embodiment, FIG. 83 depicts an arrangement where the compliant structure 8301 has a protrusion 8302, which may be in certain embodiments a single protrusion, formed by bending the end of the compliant structure towards a tri-state electrostatic electrode and through an angle exceeding 90 degrees. The complementary recesses (8303 and 8304) in the upper and lower static electrodes may be provided by a partial taper that reduces the thickness of the static electrodes at that juncture. In accordance with the example embodiment illustrated at FIG. 83, the recess in the upper static electrode exposes the land 8305 of flexible electrode facilitating ready connection to that surface by a compliant structure in conjunction with conductive adhesive 8306.

The preceding discussion on methods and structures to align the first lens to the second lens of the optical train have referred to examples wherein the first lens is on the image side of the flexible electrode. Another embodiment includes the first lens being on the object side of the flexible electrode and the passive alignment features of the lens being on the image side.

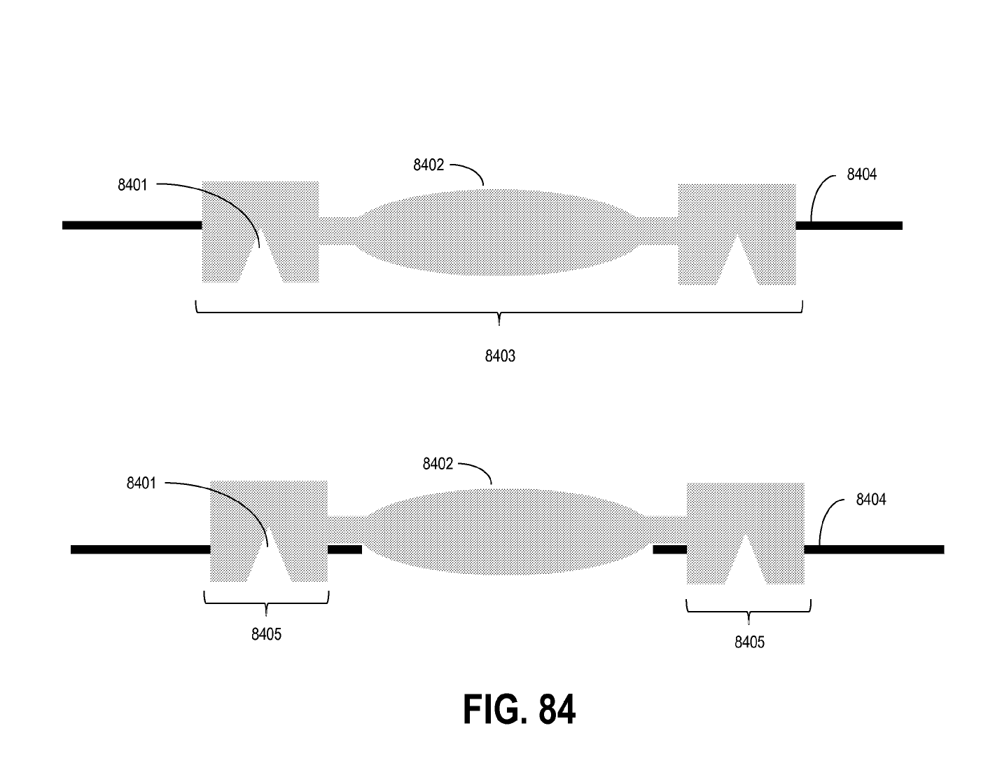

Two structures that accomplish this in accordance with embodiments are depicted schematically in FIG. 84. In the upper drawing, the passive alignment features 8401 of the first lens 8402 are positioned and sized so that they extend through the aperture 8403 in the flexible electrode 8404. In the lower drawing the passive alignment features of the first lens penetrate additional apertures 8405 in the flexible electrode to extend below it. The passive alignment features are then advantageously available to engage with mating features on other lenses, or assembly jigs as described previously.

Several embodiments involve a tri-state electrostatic actuator being used to move the first lens in an autofocus camera. To work well, embodiments have been described that provide this optical arrangement with good alignment, especially in plane, between the first and second lens. Because the first lens is moved by the tri-state electrostatic actuator, the travel of the actuator is configured to be very accurate along the optical axis of the camera.

Another embodiment includes a tri-state electrostatic actuator that moves both the first and second lens in the optical train. In certain embodiments, the actuator is particularly configured for use with a miniature electronic camera module in a volumetrically efficient arrangement wherein the first lens is on the object side of the flexible electrode and the second lens is on the image side of the flexible electrode.

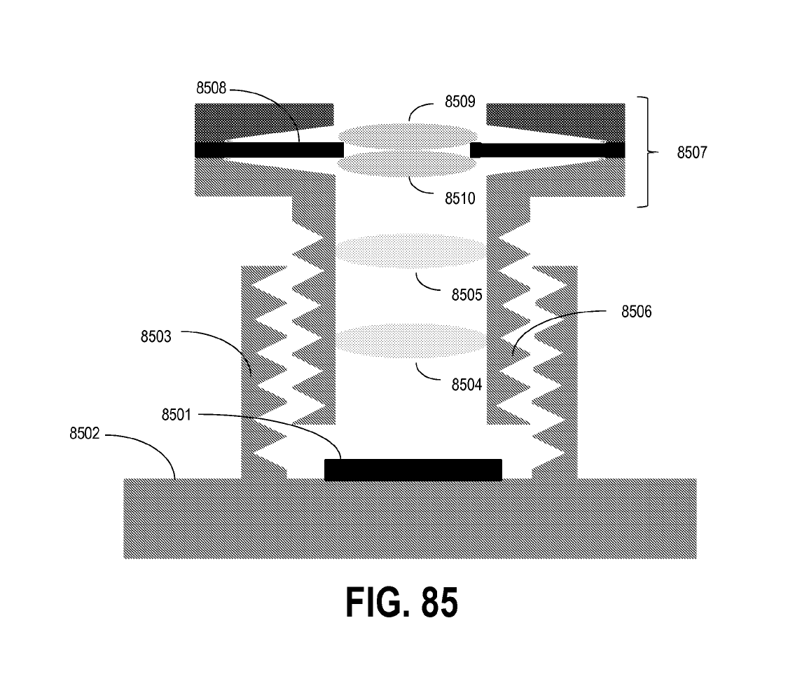

FIG. 85. depicts an example embodiment in a simplified cross-section through a miniature camera module. The image sensor 8501 is mounted on a substrate 8502. Attached to the substrate is a housing 8503 that carries a screw thread. The fixed lenses of the optical system, 8504 and 8505, are mounted in the lens turret 8506. The lens turret has a screw thread that mates to the one in the housing. The lens turret is topped by the tri-state electrostatic actuator 8507. The flexible electrode 8508 of the tri-state electrostatic actuator carries the first 8509 and second 8510 lenses of the optical train, one lens on each side. As disclosed previously, the aperture in the flexible electrode could be sized to provide the additional function of an optical stop and therefore also moves at the same time as the lens pair.

All references cited herein, as well as the background, abstract and brief description of the drawings, are incorporated by reference into the detailed description of the embodiments as disclosing alternative embodiments.

While the techniques and implementations have been described with reference to exemplary embodiments, it will be understood by those skilled in the art that various changes may be made and equivalents may be substituted for elements thereof without departing from the scope of the present invention. In addition, many modifications may be made to adapt a particular situation or material to the teachings without departing from the essential scope thereof.

1-145. (canceled)

146. An electrostatic actuator, comprising:
a rigid electrode and a flexible electrode having opposing surfaces forming an acute angle and defining overlapping apertures; and
a dielectric coupled between the opposing surfaces electrically isolating the rigid and flexible electrodes and defining a movable area of the opposing surface of the flexible electrode that is configured to be movable toward or away from the opposing surface of the rigid electrode upon respective application of attractive or repulsive electrostatic charge to the opposing surfaces.

147. The electrostatic actuator of claim 146, wherein one or both of the rigid and flexible electrodes comprises a radially symmetric shape.

148. The electrostatic actuator of claim 146, wherein the rigid and flexible electrodes each have at least a modicum of in-plane electrical conductivity, sufficient to carry uniform electrostatic charge.

149. The electrostatic actuator of claim 146, wherein the flexible electrode is deformable by stretching in the in-plane direction.

150. The electrostatic actuator of claim 146, wherein the flexible electrode is configured to deform upon application of attractive charges to the opposing surfaces causing formation of a moving contact line where ahead of the line the flexible and rigid electrodes are apart and behind it they abut.

151. The electrostatic actuator of claim 146, wherein the flexible electrode comprises a segmented structure in curves so that stretching in the in-plane causes rotation of a central portion including the aperture.

152. The electrostatic actuator of claim 146, wherein the flexible electrode comprises multiple regions each of which is independently chargeable of the others causing asymmetric deformation and out of plane translation of a central portion including the aperture.

153. The electrostatic actuator of claim 146, wherein the rigid electrode comprises a segmented structure so that asymmetric charging of the segments causes asymmetric deformation of the flexible electrode and out of plane translation of a central portion including the aperture.

154. The electrostatic actuator of claim 146, further comprising one or more mechanical stops that restrict movement of the flexible electrode.

155. The electrostatic actuator of claim 146, wherein the rigid electrode comprises a material that has moderate rigidity and sufficient in-plane electrical conductivity to set up a uniform electric charge on its surface.

156. The electrostatic actuator of claim 146, wherein the rigid electrode comprises aluminium.

157. The electrostatic actuator of claim 146, wherein the rigid electrode comprises a conductive polymer.

158. The electrostatic actuator of claim 157, wherein the conductive polymer comprises a doped liquid crystal polymer.

159. The electrostatic actuator of claim 157, wherein the conductive polymer comprises a metal-filled polymer, including a dielectric material that is filled with conductive particles, spheres, flakes or needles, or combinations thereof.

160. The electrostatic actuator of claim 146, wherein the rigid electrode comprises a dielectric polymer that has a surface coating of a conductive material.

161. The electrostatic actuator of claim 146, wherein one or both of the opposing surfaces of the rigid and flexible electrodes comprises a textured surface.

162. The electrostatic actuator of claim 161, wherein the textured surface comprises multiple through holes.

163. The electrostatic actuator of claim 146, wherein the flexible electrode comprises a material that has low modulus and large elastic range and sufficient in-plane electrical conductivity to set up a uniform electric charge on its surface.

164. The electrostatic actuator of claim 146, wherein the flexible electrode comprises a thin foil of metal.

165. The electrostatic actuator of claim 164, wherein the metal comprises aluminium.

166. The electrostatic actuator of claim 146, wherein the flexible electrode comprises a conductive polymer.

167. The electrostatic actuator of claim 166, wherein the conductive polymer comprises carbon-loaded rubber.

168. The electrostatic actuator of claim 146, wherein the flexible electrode comprises a thin film of dielectric polymer.

169. The electrostatic actuator of claim 168, wherein the dielectric polymer comprises 3-15 um thick PET, kapton or polyimide, or combinations thereof, coated on one or both surfaces with a thin layer of a conductive material.

170. The electrostatic actuator of claim 169, wherein the thin layer of conductive material comprises approximately 0.1 um of aluminium.

171. The electrostatic actuator of claim 146, wherein the flexible electrode comprises a thin foil of a conductive material encapsulated in a thin layer of dielectric material.

172. The electrostatic actuator of claim 171, wherein the conductive material comprises aluminium and the dielectric material comprises polyimide.

173. The electrostatic actuator of claim 146, wherein the flexible electrode comprises a polymer coated with metal, wherein the metal has a thickness no greater than one tenth of a thickness of the polymer.

174. The electrostatic actuator of claim 146, further comprising a dielectric film between opposing conducting surfaces of the rigid and flexible electrodes.

175. A camera, comprising:
a housing;
one or more lenses and an image sensor within the housing; and
an electrostatic actuator configured in accordance with claim 146 and disposed within the housing and having at least one lens coupled to the flexible electrode and overlapping the aperture.

176. A camera, comprising:
a housing;
one or more lenses and an image sensor within the housing; and
an electrostatic actuator configured in accordance with claim 163 and disposed within the housing and having at least one lens coupled to the flexible electrode and overlapping the aperture.

177. A camera, comprising:
a housing;
one or more lenses and an image sensor within the housing; and
an electrostatic actuator configured in accordance with claim 164 and disposed within the housing and having at least one lens coupled to the flexible electrode and overlapping the aperture.

178. A camera, comprising
a housing;
a lens barrel within the housing containing one or more lenses;
an image sensor within the housing; and
an electrostatic actuator configured in accordance with claim 146 and disposed within the housing and having at least one lens coupled to the flexible electrode and overlapping the aperture.

179. The camera of claim 178, wherein the lens barrel comprises electrical connections that run from object side to image side.

180. The camera of claim 179, wherein the electrical connections comprise unitary or multi-piece wires, rods, bars or tubes, or combinations thereof, each being disposed on a surface of the lens barrel, recessed within the surface or embedded within the lens barrel.

181. The camera of claim 179, further comprising multi-piece electrical connections joined by push-fitting, screw threading, adhesive bonding or soldering, or combinations thereof.

182. The camera of claim 179, wherein the electrical connections comprise one or more conductive tracks each being disposed on a surface of the lens barrel, recessed within the surface or embedded within the lens barrel.

183. The camera of claim 179, wherein the electrical connections comprise one or more flexible or rigid printed circuit boards each being disposed on a surface of the lens barrel, recessed within the surface or embedded within the lens barrel, or combinations thereof.

184. The camera of claim 178, wherein the one or more lenses comprise a focusing system or a zoom system, or both, and the camera further comprises an opto-algorithmic focus system.

185. The camera of claim 184, wherein the opto-algorithmic focus system comprises an extended depth of field (EDoF) focus system.
